(19) United States
(12) Patent Application Publication
(10) Pub. No.: US 2025/0028102 A1
(43) Pub. Date: Jan. 23, 2025

(54) OPTICAL LENS ASSEMBLY, IMAGING APPARATUS AND ELECTRONIC DEVICE

(71) Applicant: LARGAN PRECISION CO., LTD., Taichung City (TW)

(72) Inventors: Wen-Yu TSAI, Taichung City (TW); Pei-Chi CHANG, Taichung City (TW); Yu Jie HONG, Taichung City (TW); Chun-Hung TENG, Taichung City (TW)

(21) Appl. No.: 18/752,945

(22) Filed: Jun. 25, 2024

(30) Foreign Application Priority Data
Jul. 21, 2023 (TW) 112127444

(51) Int. Cl. G02B 5/28; G02B 13/18

(52) U.S. Cl. CPC G02B 5/281; G02B 13/18

(57) ABSTRACT

An optical lens assembly includes at least four optical lens elements being, in order from an object side of the optical lens assembly to an image side thereof, a first optical lens element, a second optical lens element, a third optical lens element and a fourth optical lens element. At least one of the at least four optical lens elements is a filter lens element, the filter lens element includes a near-infrared light filter coating membrane, the filter lens element is made of a glass material, and the filter lens element has at least one aspheric surface. The near-infrared light filter coating membrane includes at least one low refractive index layer and at least one high refractive index layer, and the near-infrared light filter coating membrane is formed by alternately stacking the at least one high refractive index layer and the at least one low refractive index layer.

### RELATED APPLICATIONS

This application claims priority to Taiwan Application Serial Number 112127444, filed Jul. 21, 2023, which is herein incorporated by reference.

### BACKGROUND

### Technical Field

The present disclosure relates to an optical lens assembly, an imaging apparatus and an electronic device. More particularly, the present disclosure relates to an optical lens assembly, an imaging apparatus and an electronic device including a filter lens element, and the filter lens element includes a near-infrared light filter coating membrane.

### Description of Related Art

In the traditional near-infrared light filtering technology, a reflecting filter and an absorbing filter are disposed between the last optical lens element and the imaging surface. However, the reflecting filter has huge transmittance differences of incident light at various angles and cannot effectively filter out the near-infrared light incident at large angles, and the absorbing filter easily absorbs together with the red light of the visible light so as to cause the color shift of imaging. Further, when the filters are disposed between the last optical lens element and the imaging surface, the back focus length will be increased, and thus the size of the optical lens assembly is increased, so that it is not favorable for the miniaturization of the optical lens assembly.

Therefore, in view of the aforementioned shortcomings of the traditional near-infrared light filtering technology and the increased cost caused by the large number of optical elements, it is necessary to actively develop a new near-infrared light filtering technology that includes fewer filters and has low transmittance differences at all angles, low color shift and low cost.

### SUMMARY

According to one aspect of the present disclosure, an optical lens assembly includes at least four optical lens elements, and the at least four optical lens elements are, in order from an object side of the optical lens assembly to an image side thereof, a first optical lens element, a second optical lens element, a third optical lens element and a fourth optical lens element. At least one of the at least four optical lens elements is a filter lens element, the filter lens element includes a near-infrared light filter coating membrane, the filter lens element is made of a glass material, and the filter lens element has at least one aspheric surface. The near-infrared light filter coating membrane includes at least one low refractive index layer and at least one high refractive index layer, and the near-infrared light filter coating membrane is formed by alternately stacking the at least one high refractive index layer and the at least one low refractive index layer.

When a wavelength of the filter lens element at 50% transmittance of long-wavelength visible light is Wt50v, a wavelength difference between an incidence at 0 degrees and an incidence at 30 degrees of the filter lens element at 50% transmittance of long-wavelength visible light is dWt50v3, an average transmittance in a wavelength range of 600 nm-650 nm of the filter lens element is T6065, and an average transmittance in a wavelength range of 700 nm-1050 nm of the filter lens element is T70105, the following conditions are satisfied: 650 nm≤Wt50v; |dWt50v3|≤20 nm; 90%≤T6065; and T70105≤5%.

According to another aspect of the present disclosure, an imaging apparatus includes the optical lens assembly according to the aforementioned aspect and an image sensor disposed on an image surface of the optical lens assembly.

According to another aspect of the present disclosure, an electronic device includes the imaging apparatus according to the aforementioned aspect.

According to another aspect of the present disclosure, an optical lens assembly includes at least four optical lens elements, and the at least four optical lens elements are, in order from an object side of the optical lens assembly to an image side thereof, a first optical lens element, a second optical lens element, a third optical lens element and a fourth optical lens element. At least one of the at least four optical lens elements is a filter lens element, the filter lens element includes a near-infrared light filter coating membrane, and at least one of the at least four optical lens elements includes a blue glass material. The near-infrared light filter coating membrane includes at least one low refractive index layer and at least one high refractive index layer, and the near-infrared light filter coating membrane is formed by alternately stacking the at least one high refractive index layer and the at least one low refractive index layer. When a wavelength of the filter lens element at 50% transmittance of long-wavelength visible light is Wt50v, a wavelength difference between an incidence at 0 degrees and an incidence at 30 degrees of the filter lens element at 50% transmittance of long-wavelength visible light is dWt50v3, an average transmittance in a wavelength range of 450 nm-630 nm of the filter lens element is T4563, and an average transmittance in a wavelength range of 700 nm-1050 nm of the filter lens element is T70105, the following conditions are satisfied: 650 nm≤Wt50v; |dWt50v3|≤20 nm; 85% T4563; and T70105≤3%.

According to another aspect of the present disclosure, an imaging apparatus includes the optical lens assembly according to the aforementioned aspect and an image sensor disposed on an image surface of the optical lens assembly.

According to another aspect of the present disclosure, an electronic device includes the imaging apparatus according to the aforementioned aspect.

### BRIEF DESCRIPTION OF THE DRAWINGS

The present disclosure can be more fully understood by reading the following detailed description of the embodiment, with reference made to the

FIG. 1 is a relationship diagram between transmittances and wavelengths of a filter lens element of an optical lens assembly according to Example 1.

FIG. 2 is a relationship diagram between transmittances and wavelengths of a filter lens element of an optical lens assembly according to Example 2.

FIG. 3 is a relationship diagram between transmittances and wavelengths of a filter lens element of an optical lens assembly according to Example 3.

FIG. 4 is a relationship diagram between transmittances and wavelengths of a filter lens element of an optical lens assembly according to Example 4.

FIG. 5 is a relationship diagram between transmittances and wavelengths of a filter lens element of an optical lens assembly according to Example 5.

FIG. 6 is a relationship diagram between transmittances and wavelengths of a filter lens element of an optical lens assembly according to Example 6.

FIG. 7 is a relationship diagram between transmittances and wavelengths of a filter lens element of an optical lens assembly according to Example 7.

FIG. 8 is a relationship diagram between transmittances and wavelengths of a filter lens element of an optical lens assembly according to Example 8.

FIG. 9 is a relationship diagram between transmittances and wavelengths of a filter lens element of an optical lens assembly according to Example 9.

FIG. 10 is a relationship diagram between transmittances and wavelengths of a filter lens element of an optical lens assembly according to Example 10.

FIG. 11 is a relationship diagram between transmittances and wavelengths of an optical lens assembly according to Example 11.

FIG. 12 is a relationship diagram between transmittances and wavelengths of an optical lens assembly according to Example 12.

### DETAILED DESCRIPTION

According to one embodiment of one aspect of the present disclosure, an optical lens assembly includes at least four optical lens elements, and the at least four optical lens elements are, in order from an object side of the optical lens assembly to an image side thereof, a first optical lens element, a second optical lens element, a third optical lens element and a fourth optical lens element. At least one of the at least four optical lens elements is a filter lens element, the filter lens element includes a near-infrared light filter coating membrane, the filter lens element is made of a glass material, and the filter lens element has at least one aspheric surface. The near-infrared light filter coating membrane includes at least one low refractive index layer and at least one high refractive index layer, and the near-infrared light filter coating membrane is formed by alternately stacking the at least one high refractive index layer and the at least one low refractive index layer. Therefore, by arranging the near-infrared light filter coating membrane on the lens element made of the glass material, it is favorable for reducing the number of the optical elements and effectively filtering the near-infrared light, so that the transmittance differences at various angles and the color shift can be reduced, and the lens deformation also can be reduced.

According to another embodiment of the present disclosure, an optical lens assembly includes at least four optical lens elements, and the at least four optical lens elements are, in order from an object side of the optical lens assembly to an image side thereof, a first optical lens element, a second optical lens element, a third optical lens element and a fourth optical lens element. At least one of the at least four optical lens elements is a filter lens element, the filter lens element includes a near-infrared light filter coating membrane, and at least one of the at least four optical lens elements includes a blue glass material. The near-infrared light filter coating membrane includes at least one low refractive index layer and at least one high refractive index layer, and the near-infrared light filter coating membrane is formed by alternately stacking the at least one high refractive index layer and the at least one low refractive index layer. Therefore, by the combined use of the near-infrared light filter coating membrane and the blue glass material in the optical lens element, it is favorable for reducing the number of the optical elements and effectively filtering the near-infrared light, and the transmittance differences at various angles can be reduced.

When a wavelength of the filter lens element at 50% transmittance of long-wavelength visible light is Wt50v, the following condition can be satisfied: 650 nm≤Wt50v. Therefore, by limiting the wavelength of the filter lens element at 50% transmittance of long-wavelength visible light, the red light can be prevented from being excessively filtered out, and the saturation of the red color of the image can be enhanced. Further, the following condition can be satisfied: 655 nm≤Wt50v≤700 nm. Further, the following condition can be satisfied: 660 nm≤Wt50v≤695 nm. Further, the following condition can be satisfied: 665 nm s Wt50v≤690 nm. Further, the following condition can be satisfied: 675 nm s Wt50v≤685 nm. Further, the following condition can be satisfied: 677.5 nm s Wt50v≤682.5 nm.

When a wavelength difference between an incidence at 0 degrees and an incidence at 30 degrees of the filter lens element at 50% transmittance of long-wavelength visible light is dWt50v3, the following condition can be satisfied: |dWt50v3|≤20 nm. Therefore, by limiting the wavelength difference between the incidence at 0 degrees and the incidence at 30 degrees of the filter lens element at 50% transmittance of long-wavelength visible light, the transmittance differences at various angles can be reduced, and it is favorable for reducing the stray light. Further, the following condition can be satisfied: |dWt50v3|≤18 nm. Further, the following condition can be satisfied: |dWt50v3|≤15 nm. Further, the following condition can be satisfied: 0 nm≤|dWt50v3|≤12 nm. Further, the following condition can be satisfied: 0 nm≤|dWt50v3|≤15 nm.

When an average transmittance in a wavelength range of 600 nm-650 nm of the filter lens element is T6065, the following condition can be satisfied: 90%≤T6065. Therefore, by controlling the average transmittance in the wavelength range of 600 nm-650 nm of the filter lens element, a good penetration of the red light can be ensured, and it is favorable for avoiding the color shift of imaging caused by the insufficient of the red light. Further, the following condition can be satisfied: 70%≤T6065. Further, the following condition can be satisfied: 75%≤T6065. Further, the following condition can be satisfied: 80%≤T6065. Further, the following condition can be satisfied: 85% s T6065. Further, the following condition can be satisfied: 95%≤T6065≤100%.

When an average transmittance in a wavelength range of 700 nm-1050 nm of the filter lens element is T70105, the following condition can be satisfied: T70105≤5%. Therefore, by limiting the average transmittance in the wavelength range of 700 nm-1050 nm of the filter lens element, it is favorable for reducing the interference of the near-infrared light band on the imaging. Further, the following condition can be satisfied: T70105≤4%. Further, the following condition can be satisfied: T70105≤3%. Further, the following condition can be satisfied: T70105≤2%. Further, the following condition can be satisfied: T70105≤1%. Further, the following condition can be satisfied: 0%≤T70105≤0.5%. Further, the following condition can be satisfied: 0%≤T70105≤1%.

When an average transmittance in a wavelength range of 450 nm-630 nm of the filter lens element is T4563, the following condition can be satisfied: 85%≤T4563. Therefore, by satisfying the average transmittance in the wavelength range of 450 nm-630 nm of the filter lens element, a high transmittance of the visible light can be ensured, and it is favorable for enhancing the imaging quality. Further, the following condition can be satisfied: 70% s T4563. Further, the following condition can be satisfied: 75%≤T4563. Further, the following condition can be satisfied: 80%≤T4563. Further, the following condition can be satisfied: 90%≤T4563. Further, the following condition can be satisfied: 95%≤T4563≤100%.

When a total number of layers of the near-infrared light filter coating membrane is tLs, the following condition can be satisfied: 40≤tLs≤200. By controlling the total number of layers of the near-infrared light filter coating membrane, it is favorable for enhancing the transmitting effect of the visible light, and the excessive lens deformation caused by the huge number of the coating layers can be avoided. Further, the following condition can be satisfied: 50≤tLs≤180. Further, the following condition can be satisfied: 55≤tLs≤160. Further, the following condition can be satisfied: 60≤tLs≤120. Further, the following condition can be satisfied: 65≤tLs≤100. Further, the following condition can be satisfied: 70≤tLs≤90. Further, the following condition can be satisfied: 75≤tLs≤80. Further, the following condition can be satisfied: 65≤tLs.

When a total thickness of the near-infrared light filter coating membrane is tTk, the following condition can be satisfied: 4000 nm≤tTk≤10000 nm. By controlling the total thickness of the near-infrared light filter coating membrane, it is favorable for maintaining the integrity of the coating membrane as a whole, and the best filtering effect to the near-infrared light can be achieved. Further, the following condition can be satisfied: 4500 nm≤tTk≤9000 nm. Further, the following condition can be satisfied: 5000 nm≤tTk≤8000 nm. Further, the following condition can be satisfied: 5500 nm≤tTk≤7000 nm. Further, the following condition can be satisfied: 6000 nm≤tTk≤6500 nm. Further, the following condition can be satisfied: 6000 nm≤tTk≤6200 nm. Further, the following condition can be satisfied: tTk≤6500 nm.

When a total thickness of the low refractive index layer is LtTk, and a total thickness of the high refractive index layer is HtTk, the following condition can be satisfied: 1.0≤LtTk/HtTk≤2.0. By controlling the ratio between the thickness of the low refractive index layer and the thickness of the high refractive index layer, it is favorable for reducing the transmitting difference among the wavelengths at 50% transmittance of the visible at various angles. Further, the following condition can be satisfied: 1.1≤LtTk/HtTk≤1.9. Further, the following condition can be satisfied: 1.2≤LtTk/HtTk≤1.8. Further, the following condition can be satisfied: 1.3≤LtTk/HtTk≤1.7. Further, the following condition can be satisfied: 1.4≤LtTk/HtTk≤1.6. Further, the following condition can be satisfied: 1.45≤LtTk/HtTk≤1.55. Further, the following condition can be satisfied: 1.4≤LtTk/HtTk.

The near-infrared light filter coating membrane can be disposed on an object-side surface and an image-side surface of the filter lens element, and when a total number of layers of the near-infrared light filter coating membrane on the object-side surface of the filter lens element is otLs, the following condition can be satisfied: otLs≤40. By limiting the total number of layers of the near-infrared light filter coating membrane on the object-side surface of the filter lens element, it is favorable for reducing the deformation of the object-side surface of the filter lens element. Further, the following condition can be satisfied: otLs≤39. Further, the following condition can be satisfied: otLs≤37.

The near-infrared light filter coating membrane can be disposed on the object-side surface and the image-side surface of the filter lens element, and when a total number of layers of the near-infrared light filter coating membrane on the image-side surface of the filter lens element is itLs, the following condition can be satisfied: itLs≤40. By limiting the total number of layers of the near-infrared light filter coating membrane on the image-side surface of the filter lens element, it is favorable for reducing the deformation of the image-side surface of the filter lens element. Further, the following condition can be satisfied: itLs≤39. Further, the following condition can be satisfied: itLs≤38. Further, the following condition can be satisfied: itLs≤37.

When a total thickness of the near-infrared light filter coating membrane on the object-side surface of the filter lens element is otTk, and a total thickness of the near-infrared light filter coating membrane on the image-side surface of the filter lens element is itTk, the following condition can be satisfied: 0.1≤otTk/itTk s 10. By controlling the ratio between the total thickness of the near-infrared light filter coating membrane on the object-side surface of the filter lens element and the total thickness of the near-infrared light filter coating membrane on the image-side surface of the filter lens element, the lens deformation caused by excessive coating times on single surface can be reduced. Further, the following condition can be satisfied: 0.2≤otTk/itTk≤5. Further, the following condition can be satisfied: 0.3≤otTk/itTk≤3.5. Further, the following condition can be satisfied: 0.4≤otTk/itTk≤2.5. Further, the following condition can be satisfied: 0.5≤otTk/itTk≤2. Further, the following condition can be satisfied: 0.6≤otTk/itTk≤1.67. Further, the following condition can be satisfied: 0.70≤otTk/itTk ≤1.43.

When a refractive index of the high refractive index layer is NH, and a refractive index of the low refractive index layer is NL, the following condition can be satisfied: 0.5≤NH−NL. By satisfying a specific difference in the refractive indexes of the membrane layers, it is favorable for enhancing the filtering effect to the near-infrared light. Further, the following condition can be satisfied: 0.6≤NH−NL. Further, the following condition can be satisfied: 0.7≤NH−NL. Further, the following condition can be satisfied: 0.8≤NH−NL. Further, the following condition can be satisfied: 0.85≤NH−NL.

When a wavelength difference between the incidence at 0 degrees and an incidence at 40 degrees of the filter lens element at 50% transmittance of long-wavelength visible light is dWt50v4, the following condition can be satisfied: |dWt50v4|≤40 nm. By limiting the wavelength difference between the incidence at 0 degrees and the incidence at 40 degrees of the filter lens element at 50% transmittance of long-wavelength visible light, the transmittance differences at various angles can be further reduced, and thus the stray light can be further reduced. Further, the following condition can be satisfied: |dWt50v4|≤45 nm. Further, the following condition can be satisfied: |dWt50v4|≤35 nm. Further, the following condition can be satisfied: 0 nm≤|dWt50v4|≤30 nm. Further, the following condition can be satisfied: 0 nm≤|dWt50v4|≤35 nm.

When an average transmittance in a wavelength range of 350 nm-400 nm of the filter lens element is T3540, the following condition can be satisfied: T3540≤3%. By limiting the average transmittance in the wavelength range of 350 nm-400 nm of the filter lens element, the low transmittance of the UV light can be ensured, and it is favorable for reducing the interference to imaging caused by the UV light. Further, the following condition can be satisfied: T3540≤10%. Further, the following condition can be satisfied: T3540≤8%. Further, the following condition can be satisfied: T3540≤5%. Further, the following condition can be satisfied: T3540≤1%. Further, the following condition can be satisfied: 0%≤T3540≤0.5%.

When a transmittance at a wavelength of 850 nm of the filter lens element is T85, the following condition can be satisfied: T85≤3%. By limiting the transmittance at the wavelength of 850 nm of the filter lens element, the near-infrared light with common wavelengths can be reduced, and it is favorable for reducing the red color interference of the imaging caused by the near-infrared light. Further, the following condition can be satisfied: T85≤10%. Further, the following condition can be satisfied: T85≤8%. Further, the following condition can be satisfied: T85≤5%. Further, the following condition can be satisfied: T85≤1%. Further, the following condition can be satisfied: 0%≤T85≤0.5%.

When a transmittance at a wavelength of 940 nm of the filter lens element is T94, the following condition can be satisfied: T94≤3%. By limiting the transmittance at the wavelength of 940 nm of the filter lens element, the near-infrared light with common wavelengths can be reduced, and it is favorable for reducing the black color interference of the imaging caused by the near-infrared light. Further, the following condition can be satisfied: T94≤10%. Further, the following condition can be satisfied: T94≤8%. Further, the following condition can be satisfied: T94≤5%. Further, the following condition can be satisfied: T94≤1%. Further, the following condition can be satisfied: 0%≤T94≤0.5%.

When a transmittance at a wavelength of 450 nm of the filter lens element is T45, the following condition can be satisfied: 80%≤T45. By satisfying the transmittance at the wavelength of 450 nm of the filter lens element, an excellent transmitting effect of the blue light can be ensured, and it is favorable for enhancing the imaging effect of the blue light. Further, the following condition can be satisfied: 70%≤T45. Further, the following condition can be satisfied: 85%≤T45. Further, the following condition can be satisfied: 90%≤T45. Further, the following condition can be satisfied: 95%≤T45≤100%.

When a transmittance at a wavelength of 500 nm of the filter lens element is T50, the following condition can be satisfied: 80%≤T50. By satisfying the transmittance at the wavelength of 500 nm of the filter lens element, an excellent transmitting effect of the green light can be ensured, and it is favorable for enhancing the imaging effect of the green light. Further, the following condition can be satisfied: 70%≤T50. Further, the following condition can be satisfied: 85%≤T50. Further, the following condition can be satisfied: 90%≤T50. Further, the following condition can be satisfied: 95%≤T50≤100%.

When a transmittance at a wavelength of 630 nm of the filter lens element is T63, the following condition can be satisfied: 80%≤T63. By satisfying the transmittance at the wavelength of 630 nm of the filter lens element, an excellent transmitting effect of the red light can be ensured, and it is favorable for enhancing the imaging effect of the red light. Further, the following condition can be satisfied: 70%≤T63. Further, the following condition can be satisfied: 85%≤T63. Further, the following condition can be satisfied: 90%≤T63. Further, the following condition can be satisfied: 95%≤T63≤100%.

According to the optical lens assembly of the present disclosure, the near-infrared light filter coating membrane can be disposed on the image-side surface of the filter lens element. By the arrangement that the near-infrared light filter coating membrane is disposed on the image-side surface of the filter lens element, it is favorable for ensuring that the light passes through the near-infrared light filter coating membrane at a small angle, and the filtering effect of the near-infrared light can be further enhanced.

According to the optical lens assembly of the present disclosure, the filter lens element can be the first optical lens element. By arranging the filter lens element made of a glass material as the first optical lens element, it is favorable for reducing the wear of the lens caused during the assembling process of the optical lens assembly.

According to the optical lens assembly of the present disclosure, the near-infrared light filter coating membrane can be disposed on the image-side surface of the filter lens element, and the filter lens element can include the blue glass material. By arranging the near-infrared light filter coating membrane on the image-side surface of the filter lens element, it is favorable for ensuring that the light passes through the near-infrared light filter coating membrane at a small angle, and the filtering effect of the near-infrared light can be further enhanced. Further, by arranging the near-infrared light filter coating membrane and the blue glass material on the same optical lens element, it is favorable for filtering the near-infrared light and the optimizing the transmittance differences at various angles.

According to the optical lens assembly of the present disclosure, when a horizontal displacement of the filter lens element at a position of a maximum effective diameter is SAG, and a central thickness of the filter lens element is CT, the following condition can be satisfied: |SAG/CT|≤0.7. By limiting the ratio between the horizontal displacement of the filter lens element at the position of the maximum effective diameter and the central thickness thereof, the overall surface shape of the filter lens element can be ensured to be flat, and it is favorable for enhancing the coating uniformity. Further, the following condition can be satisfied: |SAG/CT|≤0.5. Further, the following condition can be satisfied: |SAG/CT|≤0.4. Further, the following condition can be satisfied: |SAG/CT|≤0.3. Further, the following condition can be satisfied: |SAG/CT|≤0.2. Further, the following condition can be satisfied: 0≤|SAG/CT|≤0.1.

According to the optical lens assembly of the present disclosure, when the horizontal displacement of the filter lens element at the position of the maximum effective diameter is SAG, and a radius of curvature at a center of the filter lens element is Rc, the following condition can be satisfied: SAG/Rc|≤0.1. By limiting the ratio between the horizontal displacement of the filter lens element at the position of the maximum effective diameter and the radius of curvature at the center thereof, the change of the surface of the filter lens element can be ensured to be small, and it is favorable for further enhancing the coating uniformity. Further, the following condition can be satisfied: |SAG/Rc|≤0.08. Further, the following condition can be satisfied: |SAG/Rc|≤0.06. Further, the following condition can be satisfied: |SAG/Rc|≤0.04. Further, the following condition can be satisfied: |SAG/Rc|≤0.02. Further, the following condition can be satisfied: 0≤|SAG/Rc|≤0.01.

The coating material of the near-infrared light filter coating membrane of the present disclosure can include (values in parentheses are refractive indices at wavelength=587.6 nm): MgF₂ (1.3777), SiO₂ (1.4585), ThF₄ (1.5125), SiO (1.55), CeF₃ (1.63), Al₂O₃ (1.7682), Y₂O₃ (1.79), HfO₂ (1.8935), ZnO (1.9269), Sc₂O₃ (1.9872), AlN (2.0294), Si₃N₄ (2.0381), Ta₂O₅ (2.1306), ZrO₂ (2.1588), ZnS (2.2719), Nb₂O₅ (2.3403), TiO₂ (2.6142) and/or TiN (3.1307). Furthermore, the coating material of the near-infrared light filter coating membrane can be a MgF₂—SiO₂ Mixture, and the content ratio is [SiO₂]>[MgF₂].

According to the arranging position of the near-infrared light filter coating membrane of the present disclosure, the near-infrared light filter coating membrane can be disposed on at least one surface of an object-side surface and an image-side of any one of the optical lens elements in the optical lens assembly. In particular, the near-infrared light filter coating membrane can be disposed on an object-side surface and an image-side surface of the first optical lens element, an object-side surface and an image-side surface of the second optical lens element, an object-side surface and an image-side surface of the third optical lens element, an object-side surface and an image-side surface of the fourth optical lens element, an object-side surface and an image-side surface of the fifth optical lens element, an object-side surface and an image-side surface of the sixth optical lens element, an object-side surface and an image-side surface of the seventh optical lens element, an object-side surface and an image-side surface of the eighth optical lens element, an object-side surface and an image-side surface of the ninth optical lens element, and an object-side surface and an image-side surface of the tenth optical lens element. The near-infrared light filter coating membrane can be simultaneously disposed on an object-side surface and an image-side surface of an optical lens element, the near-infrared light filter coating membrane also can be disposed on an object-side surface and an image-side surface of different optical lens element, and the numbers of layers and the thicknesses of the near-infrared light filter coating membrane on the object-side surface and on the image-side surface can be exchanged. Compared with the optical lens element including the near-infrared light filter coating membrane disposed on the same surface, the optical lens element including the near-infrared light filter coating membrane disposed on different surfaces can have less deformation. For example, the near-infrared light filter coating membrane can be disposed on the image-side surface of the first optical lens element and the object-side surface of the second optical lens element, the near-infrared light filter coating membrane can be disposed on the object-side surface of the second optical lens element and the image-side surface of the second optical lens element, or the near-infrared light filter coating membrane can be disposed on the object-side surface of the third optical lens element and the image-side surface of the fourth optical lens element. A number of the optical lens element including the near-infrared light filter coating membrane can be one, two, three, four, five, six, seven, eight, night, or ten. The condition that the near-infrared light filter coating membrane is disposed on the object-side surface and the image-side surface of the optical lens element means the near-infrared light filter coating membrane is directly or indirectly disposed on the object-side surface and the image-side surface of the optical lens element. The term “indirectly disposed” means there is another type of coating membrane (such as anti-reflecting coating membrane) or another type of arrangement (such as coating or other materials) disposed between the near-infrared light filter coating membrane and the surface of the optical lens element. The near-infrared light filter coating membrane also can be disposed on an object-side surface and an image-side surface of other optical elements, and the optical element which can be disposed on can be a cover glass, a protective glass, a plastic board, a glass board, a reflective element, etc. The integral filtering effect can be obtained by the filtering coating membrane disposed on the surfaces of other elements so as to complete the insufficient wavelength range. Therefore, the coating membrane disposed on the surfaces of the optical lens elements can be used to filter out the light with a specific wavelength range, so that the number of coating layers and the thickness thereof can be reduced.

In the design of the near-infrared light filter coating membrane of the present disclosure, the near-infrared light filter coating membrane can include at least one membrane layer. The first membrane layer of the near-infrared light filter coating membrane can be the side close to the surface of the optical lens element, or the first membrane layer of the near-infrared light filter coating membrane can be the side away from the surface of the optical lens element.

The near-infrared light filter coating membrane is formed by alternately stacking the high refractive index layers and the low refractive index layers. The high refractive index layer means that the membrane layer has a refractive index higher than that of the previous membrane layer, the low refractive index layer means that the membrane layer has a refractive index lower than that of the previous membrane layer, and the first membrane layer is defined as a high refractive index layer or a low refractive index layer based on the second membrane layer as a comparing standard. For example, if the refractive index of the first membrane layer is larger than that of the second membrane layer, the first membrane layer is a high refractive index layer; and if the refractive index of the first membrane layer is smaller that of the second membrane layer, the first membrane layer is a low refractive index layer. The total number of layers of the near-infrared light filter coating membrane can be the sum of the membrane layers of the near-infrared light filter coating membrane on the object-side surface and the image-side surface of each of the optical lens elements. The total thickness of the near-infrared light filter coating membrane can be the sum of the thicknesses of the near-infrared light filter coating membrane on the object-side surface and on the image-side surface of each of the optical lens elements.

Because the near-infrared light filter coating membrane of the present disclosure can be disposed on the object-side surface and the image-side surface of different optical lens elements, the total number of layers and the total thickness of the near-infrared light filter coating membrane should be calculated for all of the membrane layers that substantially have the filtering effects of near-infrared light of the optical lens elements.

The manufacturing technology of the near-infrared light filter coating membrane of the present disclosure can be a liquid phase coating method or a vapor phase coating method. The liquid phase coating method can be the acid etching method, the solution deposition method, the electroplating method, the anodizing method, the sol-gel method, Langmuir-Blodgett (LB) film or liquid phase epitaxy, etc. The vapor phase coating method can be the chemical vapor coating method or the physical vapor coating method. Furthermore, if the curvature of the coated lens element has a greater change, the atomic layer deposition (ALD) should be used so as to achieve the best uniformity of the membrane, so that the integral efficacy of the multi-layer coating membrane can be ensured.

In the arranging position and the membrane composition of the anti-reflective coating membrane the present disclosure, the anti-reflective coating membrane can be disposed on the object-side surface or the image-side surface of the optical lens element. Therefore, an excellent anti-reflection effect can be obtained, the serious reflection problems in the peripheral region of the lens element caused by the large angle of light incident on the surface thereof can be reduced, and thus the light transmittance of the optical lens assembly can be improved effectively so as to achieve the best anti-reflection effect. The anti-reflective coating membrane can include at least one membrane layer, which can be formed by alternately stacking high refractive index layers and low refractive index layers, formed by subwavelength structures, formed by the combination of the high refractive index layers and the subwavelength structures, formed by the combination of the low refractive index layers and the subwavelength structures, or formed by the combination of the high refractive index layers, the low refractive index layers and the subwavelength structures.

The anti-reflective coating membrane can include a near-infrared light filter coating membrane on the inside (adjacent to the substrate). The anti-reflective coating membrane can include the subwavelength structures disposed on the outer side (adjacent to the air), and the material of the subwavelength structures can be metal oxide such as aluminum oxide (Al₂O₃). The subwavelength structures of the anti-reflective coating membrane can include a plurality of holes, and the sizes of the holes adjacent to the outside of the anti-reflective coating membrane are larger than that of the holes adjacent to the inside of the anti-reflective coating membrane.

In the material of the optical lens element of the present disclosure, when the optical lens element is made of a glass material, the optical lens element can be made into a lens element with at least one aspheric surface by the molding glass technology. The blue glass material can be further added to the material of the optical lens element, and the optical lens element including the blue glass material can be the first optical lens element, the second optical lens element, the third optical lens element, the fourth optical lens element, the fifth optical lens element, the sixth optical lens element, the seventh optical lens element, the eighth optical lens element, the ninth optical lens element and/or the tenth optical lens element of the optical lens assembly. The ingredient of the blue glass material can include phosphorus ions (P⁵⁺ or P³⁺), aluminum ion (Al³⁺), antimony ions (Sb⁵⁺ or Sb³⁺), copper ion (Cu²⁺), magnesium ion (Mg²⁺), calcium ion (Ca²⁺), strontium ion (Sr²⁺), barium ions (Ba²⁺), zinc ion (Zn²⁺), lithium ion (Li⁺), sodium ion (Na⁺), potassium ion (K⁺), phosphate (PO₄³⁻), fluoride ion (F⁻), etc. Further, the ingredient of the blue glass material can include the inorganic compound consisting of the aforementioned ions. When the optical lens element is made of a plastic material, the plastic material can include polyacrylic acid (polymethyl methacrylate; PMMA), polystyrene (PS), polycarbonate (PC), cyclic olefin polymer (COP), cyclic olefin copolymer (COC), polyetherimide (PEI) and polyesters resin (OKP-4 or OKP-4HT), and a long-wavelength absorbing material can be further added to the material of the optical lens element.

In the best coating surface shape of the optical lens element of the present disclosure, the best coating surface shape is determined based on the horizontal displacement of the filter lens element at the position of the maximum effective diameter, the central thickness of the filter lens element and the radius of curvature at the center of the filter lens element. The maximum effective diameter means the optical effective diameter of the optical lens element. The 1.0 F (1.0 field) is divided in to 20 equal parts to get 21 fields namely 0 F, 0.05 F, 0.1 F, 0.15 F, 0.2 F, 0.25 F, 0.3 F, 0.35 F, 0.4 F, 0.45 F, 0.5 F, 0.55 F, 0.6 F, 0.65 F, 0.7 F, 0.75 F, 0.8 F, 0.85 F, 0.9 F, 0.95 F, 1.0 F, and a maximum of the effective diameters that the light passes through on each of the 21 fields of the optical lens element is the optical effective diameter. The direction of the horizontal displacement means the direction that the optical axis passes through the optical lens element. The horizontal displacement at the position of the maximum effective diameter is a horizontal displacement from the canter of the optical lens element to the position of the maximum effective diameter. The radius of curvature of the optical lens element is calculated based on the target point of the optical lens element and two points that are 1 E-10 mm upper and lower away from the target point in the direction perpendicular to the optical axis.

In the coating arrangement of the optical lens element of the present disclosure, when the object-side surface or the image-side surface of the optical lens element include the near-infrared light filter coating membrane, the optical lens element is a filter lens element. The filter lens element means that the lens element has the filtering effect of the near-infrared light, and the filtering effect of the near-infrared light is mainly to reduce the transmittance of the light with the wavelength ranging from 700 nm to 1050 nm.

In the transmittance of the optical lens element of the present disclosure, when the lights of various wavelengths are incident on the optical lens element at various angles, the wavelengths of the transmittance at various angles are different, and the wavelengths at 50% transmittance of long-wavelength visible light at various angles are also different. The transmittance at a wavelength of the present disclosure is divided into intervals of 5 nm, and the wavelength at 50% transmittance of long-wavelength visible light at each of the angles is calculated by the interpolation method. The angle at which the light is incident on the optical lens element can be 0 degrees, 5 degrees, 10 degrees, 15 degrees, 20 degrees, 25 degrees, 30 degrees, 35 degrees, 40 degrees, 45 degrees, 50 degrees, or other angles smaller than 90 degrees. When the angle is not clearly specified in the description of the present disclosure, the angle of 0 degrees is used as the default standard, and the data of non-0-degree angle is separately specified and noted. The wavelength difference between the incidence at 0 degrees and the incidence at 30 degrees at 50% transmittance of long-wavelength visible light is a value obtained by the wavelength on the incidence at 0 degrees at 50% transmittance of long-wavelength visible light minus the wavelength on the incidence at 30 degrees at 50% transmittance of long-wavelength visible light. The wavelength difference between the incidence at 0 degrees and the incidence at 40 degrees at 50% transmittance of long-wavelength visible light is a value obtained by the wavelength on the incidence at 0 degrees at 50% transmittance of long-wavelength visible light minus the wavelength on the incidence at 40 degrees at 50% transmittance of long-wavelength visible light. There can be a plurality of wavelengths at 50% transmittance of long-wavelength visible light. In the present disclosure, the region of long-wavelength is defined as a region with a wavelength larger than 500 nm, the region of short-wavelength is defined as a region with a wavelength smaller than 500 nm, and the position at 50% transmittance of long-wavelength visible light means the longest wavelength at 50% transmittance in the range of 500 nm-750 nm.

In the compensating technology of the optical lens element of the present disclosure, when the optical lens element is made of the plastic material, the surface shape change error thereof will be too large due to high temperature, especially when the thickness of the lens element is too small. Thus, by the lens compensating technology, the problem of temperature effect while coating on the plastic surface can be effectively solved, so that it is favorable for maintaining the integrity of the coating on the lens element and the high precision of the plastic lens element, and it is the key technology for achieving the high quality of the optical lens assembly. The lens compensating technology can be the moldflow analysis method, the curve fitting method or the wavefront error method, but the present disclosure is not limited thereto. The moldflow analysis method is to find the three-dimensional contour nodes of the lens surface shrinking in the Z-axis through mold flow analysis, and then the three-dimensional contour nodes are converted into an aspherical curve so as to compare with the original curve to find the difference there between. At the same time, the material shrinkage rate and the surface deformation trend are considered so as to calculate and obtain the compensation value. The curve fitting method is to measure the surface contour error of the element, then the curve fitting is performed based on a function, and then an optimization algorithm method is used to approximate the fitted curve to the measurement point so as to obtain the compensation value. The function can be exponential or polynomial, and the algorithm method can be Gauss Newton method, the simplex algorithm method, the steepest descent method, etc. The wavefront error method is to measure the wavefront error (imaging error) data by the interferometer, the wavefront error generated by the manufacturing and the assembly is comprehensively analyzed by the original design value of the wavefront error and then is optimized by an optical software so as to obtain the compensation value.

In the definition of the object side and the image side of the optical lens assembly of the present disclosure, the image side is a side close to an image surface along the optical axis, and object side is a side away from the image surface along the optical axis.

In the optical element of the optical lens assembly of the present disclosure, the optical lens assembly can include the optical element with the property of the visible light passing, such as the optical lens element, the cover glass, the blue glass, the micro lens, and filtering element (filter, color filter). In the optical lens assembly, the aforementioned optical element can be disposed on a surface of the image sensor (the imaging surface of the optical lens assembly). By the arrangement that the near-infrared light filter coating membrane is arranged on the surface of the optical lens element, it is favorable for reducing the angle at which the chief ray at the maximum image height field is incident on the image sensor in the optical lens assembly, so that the back focus length and total length can be reduced. In order to make the refractive index of the optical element and the refractive index of the surface of the image sensor close to each other or the same, a polymer with high molecular weight can be disposed between the optical element and the image sensor. Thus, the light can pass directly through the interface between the cover glass and the image sensor without refraction, and the angle of incidence becoming larger caused by the re-refraction can be avoided.

The cover glass of the optical lens assembly of the present disclosure can be disposed on the object side of the image sensor, and at least one or both of the object-side surface and the image-side surface of the cover glass can include the anti-reflective coating membrane. There can be or without an air layer between the cover glass and the image sensor. When the optical lens assembly of the present disclosure is designed as an optical system with the air layer between the cover glass and the image sensor, the anti-reflective coating membrane can be manufactured on at least one or both of the object-side surface and the image-side surface of the cover glass. When the optical lens assembly of the present disclosure is designed as an optical system without the air layer between the cover glass and the image sensor, the anti-reflective coating membrane can be manufactured on the object-side surface of the cover glass. At least one or both of the object-side surface and the image-side surface of the cover glass can include the long-wavelength absorbing material. By the arrangement that the long-wavelength absorbing material is mixed with the polymer with high molecular weight, the polymer with high molecular weight can be disposed on the surface of the cover glass. Further, when the optical lens assembly of the present disclosure is designed as an optical system with the air layer between the cover glass and the image sensor, at least one or both of the object-side surface and the image-side surface of the cover glass can be designed to include the membrane including long-wavelength absorbing material; and when the optical lens assembly of the present disclosure is designed as an optical system without the air layer between the cover glass and the image sensor, the object-side surface of the cover glass can be designed to include the membrane including long-wavelength absorbing material. Further, the material of the cover glass can be further designed to include the long-wavelength absorbing material.

The blue glass of the optical lens assembly of the present disclosure can be disposed on the object side of the image sensor, and at least one or both of the object-side surface and the image-side surface of the blue glass can include the anti-reflective coating membrane. There can be or without an air layer between the blue glass and the image sensor. When the optical lens assembly of the present disclosure is designed as an optical system with the air layer between the blue glass and the image sensor, the anti-reflective coating membrane can be manufactured on at least one or both of the object-side surface and the image-side surface of the blue glass. When the optical lens assembly of the present disclosure is designed as an optical system without the air layer between the blue glass and the image sensor, the anti-reflective coating membrane can be manufactured on the object-side surface of the blue glass. At least one or both of the object-side surface and the image-side surface of the blue glass can include the long-wavelength absorbing material. By the arrangement that the long-wavelength absorbing material is mixed with the polymer with high molecular weight, the polymer with high molecular weight can be disposed on the surface of the blue glass. Further, when the optical lens assembly of the present disclosure is designed as an optical system with the air layer between the blue glass and the image sensor, at least one or both of the object-side surface and the image-side surface of the blue glass can be designed to include the membrane including long-wavelength absorbing material; and when the optical lens assembly of the present disclosure is designed as an optical system without the air layer between the blue glass and the image sensor, the object-side surface of the blue glass can be designed to include the membrane including long-wavelength absorbing material. Further, the material of the blue glass can be further designed to include the long-wavelength absorbing material.

The micro lens of the optical lens assembly of the present disclosure can be disposed on the object side of the image sensor, and the object-side surface and the image-side surface of the micro lens can include the long-wavelength absorbing material. The long-wavelength absorbing material can be mixed with the polymer with high molecular weight, the polymer with high molecular weight can be disposed on the surface of the micro lens, the polymer with high molecular weight can be disposed between the micro lens and the color filter as a connecting layer, or the long-wavelength absorbing material can be mixed in the color filter. Further, the long-wavelength absorbing material can be disposed in the red filter, the green filter and blue filter.

In the near-infrared light filter coating membrane of the optical lens assembly of the present disclosure, the long-wavelength absorbing material and the blue glass material can be utilized in numerous combinations by surface arrangement and material addition, and the long-wavelength absorbing material and the blue glass material can be applied on the same optical lens element or different optical lens elements.

Each of the aforementioned features of the optical lens assembly of the present disclosure can be utilized in numerous combinations, so as to achieve the corresponding functionality.

According to further another embodiment of the present disclosure, an imaging apparatus includes the aforementioned optical lens assembly and an image sensor, and the image sensor is disposed on an image surface of the optical lens assembly. Preferably, the imaging apparatus can further include a barrel member, a holder member, or a combination thereof.

According to still another embodiment of the present disclosure, an electronic device includes the aforementioned imaging apparatus. Therefore, the imaging quality can be effectively enhanced. Preferably, the electronic device can further include but not be limited to a control unit, a display, a storage unit, a random-access memory (RAM), a read-only memory (ROM), or the combination thereof. Furthermore, the electronic device of the present disclosure can be a camera, a cell phone, a portable computer, a handheld game console, a home game console, a head-mounted device, a car device or a vehicle device, but the present disclosure is not limited thereto.

According to the above descriptions, the specific embodiments and reference drawings thereof are given below so as to describe the present disclosure in detail.

### Example 1

The optical lens assembly of Example 1 includes at least four optical lens elements, and at least one of the at least four optical lens elements is a filter lens element. The filter lens element includes a near-infrared light filter coating membrane, the near-infrared light filter coating membrane includes at least one low refractive index layer and at least one high refractive index layer, and the near-infrared light filter coating membrane is formed by alternately stacking the at least one high refractive index layer and the at least one low refractive index layer. Further, at least one of the at least four optical lens elements can include a blue glass material, the filter lens element can be made of a glass material, and the filter lens element can have at least one aspheric surface.

Table 1A shows the details of the near-infrared light filter coating membrane of the filter lens element of Example 1, wherein tLs is a total number of layers of the near-infrared light filter coating membrane, otLs is a total number of layers of the near-infrared light filter coating membrane on the object-side surface of the filter lens element, itLs is a total number of layers of the near-infrared light filter coating membrane on the image-side surface of the filter lens element, tTk is a total thickness of the near-infrared light filter coating membrane, LtTk is a total thickness of the low refractive index layer, HtTk is and a total thickness of the high refractive index layer, otTk is a total thickness of the near-infrared light filter coating membrane on the object-side surface of the filter lens element, itTk is a total thickness of the near-infrared light filter coating membrane on the image-side surface of the filter lens element, NL is a refractive index of the low refractive index layer, and NH is a refractive index of the high refractive index layer. The near-infrared light filter coating membrane can be disposed on the object-side surface or the image-side surface of the filter lens element, and the total number of layers of the near-infrared light filter coating membrane of the filter lens element in Example 1 is tLs=72.

TABLE 1A

| | | | |
|---|---|---|---|
| tLs | 72 | otTk (nm) | — |
| otLs | — | itTk (nm) | — |
| itLs | — | otTk/itTk | — |
| tTk (nm) | 6088 | NL | 1.46 |
| LtTk (nm) | 3620 | NH | 2.33 |
| HtTk (nm) | 2468 | NH - NL | 0.87 |
| LtTk/HtTk | 1.47 | | |

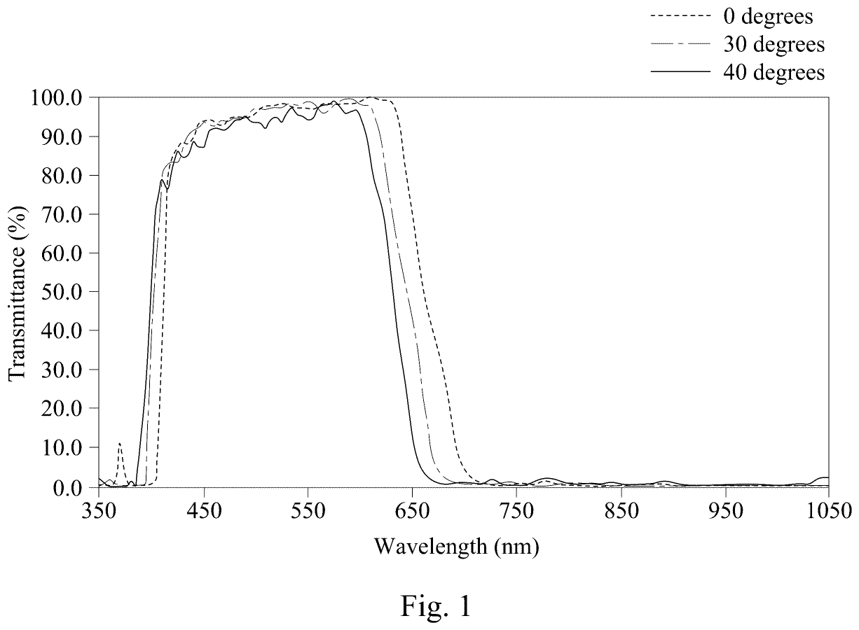

FIG. 1 is a relationship diagram between transmittances and wavelengths of a filter lens element of an optical lens assembly according to Example 1, and Table 1B shows the values of transmittance in a wavelength range of 350 nm-1050 nm of the filter lens element of Example 1, wherein the incidence angles of the light entering the filter lens element of Example 1 are respectively 0 degrees, 30 degrees and 40 degrees.

TABLE 1B

| Wavelength (nm) | 0 degrees | 30 degrees | 40 degrees |
|---|---|---|---|
| 350 | 0.33 | 0.56 | 2.03 |
| 355 | 0.19 | 1.35 | 1.15 |
| 360 | 0.38 | 1.84 | 0.24 |
| 365 | 0.92 | 1.04 | 0.05 |
| 370 | 11.55 | 0.13 | 0.04 |
| 375 | 1.61 | 0.01 | 0.02 |
| 380 | 0.06 | 0.06 | 1.41 |
| 385 | 0.00 | 0.02 | 0.23 |
| 390 | 0.46 | 0.13 | 12.57 |
| 395 | 0.01 | 0.90 | 25.79 |
| 400 | 1.10 | 40.79 | 53.33 |
| 405 | 0.29 | 54.32 | 72.20 |
| 410 | 35.93 | 80.25 | 78.83 |
| 415 | 79.66 | 82.99 | 76.42 |
| 420 | 84.86 | 83.57 | 81.95 |
| 425 | 87.15 | 83.41 | 86.37 |
| 430 | 88.73 | 87.27 | 84.47 |
| 435 | 87.65 | 90.46 | 85.18 |
| 440 | 89.76 | 91.55 | 88.59 |
| 445 | 93.22 | 92.53 | 87.13 |
| 450 | 93.59 | 93.85 | 87.20 |
| 455 | 94.10 | 92.95 | 91.32 |
| 460 | 94.09 | 92.50 | 92.09 |
| 465 | 92.56 | 93.80 | 91.99 |
| 470 | 93.22 | 93.80 | 91.77 |
| 475 | 94.54 | 94.01 | 92.60 |
| 480 | 94.66 | 94.58 | 94.10 |
| 485 | 94.74 | 94.70 | 94.37 |
| 490 | 94.29 | 95.14 | 94.98 |
| 495 | 94.75 | 96.30 | 93.60 |
| 500 | 96.07 | 96.89 | 93.47 |
| 505 | 97.30 | 97.13 | 93.06 |
| 510 | 97.41 | 96.93 | 92.31 |
| 515 | 97.64 | 97.35 | 94.46 |
| 520 | 97.76 | 97.46 | 94.74 |
| 525 | 98.04 | 97.63 | 93.67 |
| 530 | 97.78 | 98.16 | 96.39 |
| 535 | 97.21 | 98.20 | 97.51 |
| 540 | 97.35 | 98.08 | 95.36 |
| 545 | 97.42 | 98.69 | 95.21 |
| 550 | 97.26 | 98.80 | 94.16 |
| 555 | 97.63 | 98.14 | 94.67 |
| 560 | 98.12 | 97.31 | 97.56 |
| 565 | 98.18 | 96.04 | 97.90 |
| 570 | 98.31 | 96.45 | 98.16 |
| 575 | 98.54 | 98.28 | 99.13 |
| 580 | 98.51 | 99.09 | 97.71 |
| 585 | 98.30 | 99.53 | 96.05 |
| 590 | 98.37 | 99.78 | 96.34 |
| 595 | 98.77 | 99.02 | 96.95 |
| 600 | 99.29 | 98.27 | 95.68 |
| 605 | 99.78 | 98.10 | 91.18 |
| 610 | 99.87 | 97.61 | 83.82 |
| 615 | 99.50 | 94.93 | 76.77 |
| 620 | 99.35 | 89.21 | 72.00 |
| 625 | 99.31 | 80.97 | 64.98 |
| 630 | 98.85 | 71.57 | 53.97 |
| 635 | 96.35 | 63.62 | 41.43 |
| 640 | 89.26 | 57.84 | 31.58 |
| 645 | 79.47 | 51.43 | 23.44 |
| 650 | 70.83 | 43.08 | 13.38 |
| 655 | 62.52 | 33.81 | 7.18 |
| 660 | 53.13 | 23.78 | 4.27 |
| 665 | 45.11 | 13.96 | 2.67 |
| 670 | 40.08 | 7.37 | 1.66 |
| 675 | 36.08 | 4.13 | 1.09 |
| 680 | 30.27 | 2.52 | 0.83 |
| 685 | 21.95 | 1.58 | 0.78 |
| 90 | 13.53 | 1.02 | 0.88 |
| 695 | 7.63 | 0.71 | 1.05 |
| 700 | 4.35 | 0.58 | 1.14 |
| 705 | 2.61 | 0.56 | 1.03 |
| 710 | 1.62 | 0.66 | 0.95 |
| 715 | 1.03 | 0.82 | 1.00 |
| 720 | 0.70 | 0.88 | 1.25 |
| 725 | 0.52 | 0.79 | 1.95 |
| 730 | 0.45 | 0.71 | 1.65 |
| 735 | 0.45 | 0.79 | 0.79 |
| 740 | 0.53 | 1.04 | 0.45 |
| 745 | 0.68 | 1.33 | 0.34 |
| 750 | 0.77 | 1.10 | 0.32 |
| 755 | 0.70 | 0.50 | 0.39 |
| 760 | 0.61 | 0.27 | 0.59 |
| 765 | 0.63 | 0.19 | 1.03 |
| 770 | 0.85 | 0.17 | 1.79 |
| 775 | 1.33 | 0.20 | 2.17 |
| 780 | 1.05 | 0.27 | 2.01 |
| 785 | 0.46 | 0.46 | 1.92 |
| 790 | 0.23 | 0.78 | 1.81 |
| 795 | 0.15 | 1.06 | 1.40 |
| 800 | 0.13 | 1.00 | 0.91 |
| 805 | 0.13 | 0.89 | 0.65 |
| 810 | 0.16 | 0.92 | 0.63 |
| 815 | 0.23 | 1.02 | 0.84 |
| 820 | 0.40 | 0.94 | 0.97 |
| 825 | 0.66 | 0.72 | 0.98 |
| 830 | 0.71 | 0.63 | 0.86 |
| 835 | 0.57 | 0.55 | 1.08 |
| 840 | 0.50 | 0.47 | 1.32 |
| 845 | 0.53 | 0.48 | 1.15 |
| 850 | 0.67 | 0.60 | 0.86 |
| 855 | 0.87 | 0.77 | 0.67 |
| 860 | 0.81 | 0.83 | 0.59 |
| 865 | 0.55 | 0.83 | 0.60 |
| 870 | 0.38 | 0.62 | 0.67 |
| 875 | 0.30 | 0.41 | 0.82 |
| 880 | 0.29 | 0.30 | 1.03 |
| 885 | 0.33 | 0.25 | 1.24 |
| 890 | 0.46 | 0.24 | 1.30 |
| 895 | 0.70 | 0.26 | 1.18 |
| 900 | 0.80 | 0.32 | 0.99 |
| 905 | 0.53 | 0.41 | 0.81 |
| 910 | 0.31 | 0.56 | 0.67 |
| 915 | 0.20 | 0.73 | 0.54 |
| 920 | 0.15 | 0.82 | 0.43 |
| 925 | 0.13 | 0.78 | 0.36 |
| 930 | 0.13 | 0.68 | 0.31 |
| 935 | 0.14 | 0.54 | 0.29 |
| 940 | 0.17 | 0.39 | 0.29 |
| 945 | 0.22 | 0.29 | 0.30 |
| 950 | 0.31 | 0.22 | 0.35 |
| 955 | 0.45 | 0.17 | 0.42 |
| 960 | 0.61 | 0.14 | 0.54 |
| 965 | 0.68 | 0.13 | 0.71 |
| 970 | 0.59 | 0.12 | 0.85 |
| 975 | 0.44 | 0.13 | 0.86 |
| 980 | 0.31 | 0.14 | 0.74 |
| 985 | 0.22 | 0.16 | 0.60 |
| 990 | 0.16 | 0.20 | 0.50 |
| 995 | 0.12 | 0.27 | 0.45 |
| 1000 | 0.10 | 0.38 | 0.44 |
| 1005 | 0.08 | 0.49 | 0.43 |
| 1010 | 0.07 | 0.52 | 0.44 |
| 1015 | 0.07 | 0.47 | 0.49 |
| 1020 | 0.07 | 0.41 | 0.58 |
| 1025 | 0.07 | 0.37 | 0.76 |
| 1030 | 0.08 | 0.31 | 1.07 |
| 1035 | 0.10 | 0.27 | 1.55 |
| 1040 | 0.13 | 0.24 | 2.14 |
| 1045 | 0.18 | 0.24 | 2.48 |
| 1050 | 0.26 | 0.26 | 2.31 |

Table 1C shows the values of the parameters of the filter lens element of the optical lens assembly of Example 1 at the incidence angles of 0 degrees, 30 degrees and 40 degrees, wherein Wt50v is a wavelength of the filter lens element at 50% transmittance of long-wavelength visible light, dWt50v3 is a wavelength difference between an incidence at 0 degrees and an incidence at 30 degrees of the filter lens element at 50% transmittance of long-wavelength visible light, dWt50v4 is a wavelength difference between the incidence at 0 degrees and an incidence at 40 degrees of the filter lens element at 50% transmittance of long-wavelength visible light, T3540 is an average transmittance in a wavelength range of 350 nm-400 nm of the filter lens element, T4563 is an average transmittance in a wavelength range of 450 nm-630 nm of the filter lens element, T6065 is an average transmittance in a wavelength range of 600 nm-650 nm of the filter lens element, T70105 is an average transmittance in a wavelength range of 700 nm-1050 nm of the filter lens element, T45 is a transmittance at a wavelength of 450 nm of the filter lens element, T50 is a transmittance at a wavelength of 500 nm of the filter lens element, T63 is a transmittance at a wavelength of 630 nm of the filter lens element, T85 is a transmittance at a wavelength of 850 nm of the filter lens element, and T94 is a transmittance at a wavelength of 940 nm of the filter lens element.

TABLE 1C

| | 0 degrees | 30 degrees | 40 degrees |
|---|---|---|---|
| Wt50v (nm) | 661.95 | 645.86 | 631.58 |
| \|dWt50v3\| (nm) | 16.10 | | |
| \|dWt50v4\| (nm) | 30.37 | | |
| T3540 (%) | 1.51 | 4.26 | 8.81 |
| T4563 (%) | 97.09 | 95.44 | 91.28 |
| T6065 (%) | 93.81 | 76.97 | 58.93 |
| T70105 (%) | 0.52 | 0.52 | 0.93 |
| T45 (%) | 93.59 | 93.85 | 87.20 |
| T50 (%) | 96.07 | 98.80 | 94.16 |
| T63 (%) | 98.85 | 71.57 | 53.97 |
| T85 (%) | 0.67 | 0.60 | 0.86 |
| T94 (%) | 0.17 | 0.39 | 0.29 |

If the definitions of parameters shown in tables of the following examples are the same as those shown in Table 1A to Table 1C, those will not be described again.

### Example 2

The optical lens assembly of Example 2 includes at least four optical lens elements, and at least one of the at least four optical lens elements is a filter lens element. The filter lens element includes a near-infrared light filter coating membrane, the near-infrared light filter coating membrane includes at least one low refractive index layer and at least one high refractive index layer, and the near-infrared light filter coating membrane is formed by alternately stacking the at least one high refractive index layer and the at least one low refractive index layer. Further, at least one of the at least four optical lens elements can include a blue glass material, the filter lens element can be made of a glass material, and the filter lens element can have at least one aspheric surface.

Table 2A shows the values of tLs, otLs, itLs, tTk, LtTk, HtTk, LtTk/HtTk, otTk, itTk, otTk/itTk, NL, NH and NH−NL of the near-infrared light filter coating membrane of the filter lens element of Example 2, wherein the near-infrared light filter coating membrane can be disposed on the object-side surface or the image-side surface of the filter lens element, and the total number of layers of the near-infrared light filter coating membrane of the filter lens element in Example 2 is tLs=72.

TABLE 2A

| | | | |
|---|---|---|---|
| tLs | 72 | otTk (nm) | — |
| otLs | — | itTk (nm) | — |
| itLs | — | otTk/itTk | — |
| tTk (nm) | 6112 | NL | 1.46 |
| LtTk (nm) | 3614 | NH | 2.33 |
| HtTk (nm) | 2498 | NH - NL | 0.87 |
| LtTk/HtTk | 1.45 | | |

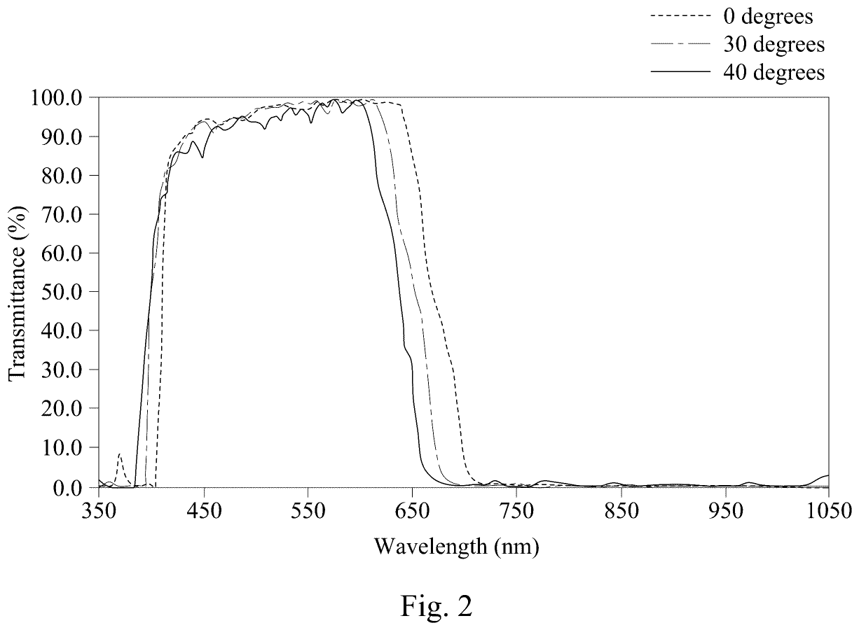

FIG. 2 is a relationship diagram between transmittances and wavelengths of a filter lens element of an optical lens assembly according to Example 2, and Table 2B shows the values of transmittance in a wavelength range of 350 nm-1050 nm of the filter lens element of Example 2, wherein the incidence angles of the light entering the filter lens element of Example 2 are respectively 0 degrees, 30 degrees and 40 degrees.

TABLE 2B

| Wavelength (nm) | 0 degrees | 30 degrees | 40 degrees |
|---|---|---|---|
| 350 | 0.19 | 0.27 | 2.00 |
| 355 | 0.23 | 0.94 | 1.09 |
| 360 | 0.24 | 1.73 | 0.50 |
| 365 | 0.89 | 1.21 | 0.07 |
| 370 | 9.01 | 0.16 | 0.03 |
| 375 | 4.77 | 0.02 | 0.05 |
| 380 | 0.44 | 0.23 | 0.33 |
| 385 | 0.01 | 0.02 | 0.38 |
| 390 | 0.03 | 0.63 | 17.79 |
| 395 | 0.02 | 1.07 | 36.02 |
| 400 | 1.08 | 49.45 | 50.31 |
| 405 | 0.32 | 56.44 | 65.16 |
| 410 | 33.88 | 76.82 | 74.14 |
| 415 | 79.95 | 81.07 | 75.38 |
| 420 | 85.43 | 82.00 | 83.36 |
| 425 | 87.20 | 83.52 | 85.95 |
| 430 | 88.62 | 88.08 | 85.95 |
| 435 | 90.14 | 90.03 | 85.75 |
| 440 | 90.86 | 91.74 | 88.93 |
| 445 | 93.37 | 92.79 | 87.59 |
| 450 | 93.71 | 93.93 | 84.89 |
| 455 | 93.66 | 92.97 | 89.60 |
| 460 | 93.98 | 90.94 | 91.92 |
| 465 | 92.97 | 92.99 | 92.43 |
| 470 | 93.12 | 93.59 | 91.66 |
| 475 | 94.22 | 94.24 | 91.95 |
| 480 | 94.82 | 94.63 | 93.31 |
| 485 | 94.00 | 94.67 | 94.41 |
| 490 | 93.98 | 94.82 | 94.98 |
| 495 | 94.89 | 96.03 | 93.69 |
| 500 | 95.92 | 96.90 | 93.73 |
| 505 | 97.19 | 97.08 | 93.21 |
| 510 | 97.46 | 96.84 | 91.71 |
| 515 | 97.69 | 97.49 | 94.66 |
| 520 | 97.76 | 97.54 | 95.20 |
| 525 | 98.16 | 97.67 | 94.07 |
| 530 | 97.82 | 98.29 | 96.22 |
| 535 | 96.82 | 98.23 | 97.45 |
| 540 | 96.99 | 98.09 | 95.57 |
| 545 | 96.93 | 98.68 | 96.95 |
| 550 | 96.97 | 98.72 | 95.75 |
| 555 | 97.85 | 98.34 | 93.60 |
| 560 | 98.20 | 98.92 | 97.17 |
| 565 | 98.15 | 97.28 | 98.45 |
| 570 | 98.88 | 95.90 | 97.55 |
| 575 | 99.57 | 98.03 | 99.14 |
| 580 | 99.55 | 99.20 | 98.11 |
| 585 | 99.03 | 98.92 | 96.01 |
| 590 | 98.48 | 99.38 | 97.14 |
| 595 | 98.58 | 98.78 | 98.98 |
| 600 | 99.17 | 97.77 | 98.79 |
| 605 | 99.65 | 98.01 | 97.63 |
| 610 | 99.46 | 99.06 | 94.61 |
| 615 | 98.46 | 99.13 | 85.87 |
| 620 | 98.29 | 96.96 | 76.33 |
| 625 | 98.78 | 93.56 | 72.53 |
| 630 | 98.37 | 87.24 | 68.38 |
| 635 | 98.33 | 75.88 | 61.17 |
| 640 | 98.02 | 66.34 | 51.16 |
| 645 | 93.42 | 62.08 | 36.34 |
| 650 | 86.92 | 56.61 | 32.71 |
| 655 | 81.09 | 49.09 | 17.45 |
| 660 | 70.90 | 43.92 | 7.80 |
| 665 | 58.08 | 33.85 | 4.30 |
| 670 | 50.18 | 19.65 | 2.69 |
| 675 | 46.44 | 8.25 | 1.72 |
| 680 | 41.66 | 4.00 | 1.14 |
| 685 | 36.43 | 2.37 | 0.85 |
| 690 | 32.23 | 1.55 | 0.77 |
| 695 | 21.30 | 1.04 | 0.83 |
| 700 | 9.38 | 0.74 | 0.98 |
| 705 | 4.21 | 0.59 | 1.06 |
| 710 | 2.28 | 0.55 | 1.02 |
| 715 | 1.44 | 0.61 | 0.98 |
| 720 | 0.99 | 0.73 | 1.04 |
| 725 | 0.72 | 0.80 | 1.34 |
| 730 | 0.55 | 0.76 | 1.89 |
| 735 | 0.46 | 0.74 | 1.41 |
| 740 | 0.44 | 0.84 | 0.72 |
| 745 | 0.49 | 1.05 | 0.44 |
| 750 | 0.58 | 1.28 | 0.35 |
| 755 | 0.66 | 0.94 | 0.36 |
| 760 | 0.65 | 0.46 | 0.46 |
| 765 | 0.62 | 0.27 | 0.71 |
| 770 | 0.67 | 0.20 | 1.23 |
| 775 | 0.91 | 0.19 | 1.80 |
| 780 | 1.26 | 0.23 | 1.77 |
| 785 | 0.91 | 0.33 | 1.54 |
| 790 | 0.43 | 0.55 | 1.43 |
| 795 | 0.23 | 0.86 | 1.29 |
| 800 | 0.16 | 0.93 | 0.96 |
| 805 | 0.14 | 0.78 | 0.66 |
| 810 | 0.15 | 0.70 | 0.52 |
| 815 | 0.19 | 0.73 | 0.58 |
| 820 | 0.28 | 0.76 | 0.79 |
| 825 | 0.48 | 0.67 | 1.01 |
| 830 | 0.66 | 0.53 | 0.78 |
| 835 | 0.57 | 0.48 | 0.85 |
| 840 | 0.45 | 0.42 | 1.27 |
| 845 | 0.41 | 0.39 | 1.32 |
| 850 | 0.45 | 0.46 | 0.88 |
| 855 | 0.57 | 0.67 | 0.57 |
| 860 | 0.67 | 0.75 | 0.43 |
| 865 | 0.55 | 0.87 | 0.38 |
| 870 | 0.38 | 0.71 | 0.38 |
| 875 | 0.28 | 0.41 | 0.42 |
| 880 | 0.24 | 0.25 | 0.52 |
| 885 | 0.25 | 0.18 | 0.67 |
| 890 | 0.33 | 0.15 | 0.81 |
| 895 | 0.53 | 0.14 | 0.88 |
| 900 | 0.83 | 0.16 | 0.84 |
| 905 | 0.64 | 0.19 | 0.76 |
| 910 | 0.31 | 0.25 | 0.70 |
| 915 | 0.17 | 0.34 | 0.66 |
| 920 | 0.11 | 0.46 | 0.62 |
| 925 | 0.08 | 0.55 | 0.56 |
| 930 | 0.07 | 0.57 | 0.51 |
| 935 | 0.07 | 0.55 | 0.49 |
| 940 | 0.08 | 0.51 | 0.48 |
| 945 | 0.09 | 0.44 | 0.50 |
| 950 | 0.12 | 0.37 | 0.54 |
| 955 | 0.18 | 0.31 | 0.63 |
| 960 | 0.26 | 0.27 | 0.77 |
| 965 | 0.38 | 0.24 | 0.96 |
| 970 | 0.47 | 0.23 | 1.14 |
| 975 | 0.47 | 0.22 | 1.18 |
| 980 | 0.40 | 0.23 | 1.04 |
| 985 | 0.33 | 0.26 | 0.83 |
| 990 | 0.27 | 0.31 | 0.67 |
| 995 | 0.23 | 0.39 | 0.57 |
| 1000 | 0.19 | 0.51 | 0.54 |
| 1005 | 0.16 | 0.65 | 0.51 |
| 1010 | 0.14 | 0.71 | 0.49 |
| 1015 | 0.13 | 0.65 | 0.52 |
| 1020 | 0.13 | 0.55 | 0.59 |
| 1025 | 0.13 | 0.48 | 0.73 |
| 1030 | 0.14 | 0.40 | 0.98 |
| 1035 | 0.15 | 0.33 | 1.42 |
| 1040 | 0.19 | 0.29 | 2.09 |
| 1045 | 0.25 | 0.27 | 2.84 |
| 1050 | 0.35 | 0.28 | 3.09 |

Table 2C shows the values of Wt50v, |dWt50v3|, |dWt50v4|, T3540, T4563, T6065, T70105, T45, T50, T63, T85 and T94 of the filter lens element of the optical lens assembly of Example 2 at the incidence angles of 0 degrees, 30 degrees and 40 degrees.

TABLE 2C

| | 0 degrees | 30 degrees | 40 degrees |
|---|---|---|---|
| Wt50v (nm) | 670.24 | 654.40 | 640.39 |
| \|dWt50v3\| (nm) | 15.84 | | |
| \|dWt50v4\| (nm) | 29.85 | | |
| T3540 (%) | 1.54 | 5.07 | 9.87 |
| T4563 (%) | 97.01 | 96.51 | 92.80 |
| T6065 (%) | 97.17 | 84.78 | 70.50 |
| T70105 (%) | 0.61 | 0.50 | 0.91 |
| T45 (%) | 93.71 | 93.93 | 84.89 |
| T50 (%) | 96.97 | 98.72 | 95.75 |
| T63 (%) | 98.37 | 87.24 | 68.38 |
| T85 (%) | 0.45 | 0.46 | 0.88 |
| T94 (%) | 0.08 | 0.51 | 0.48 |

### Example 3

The optical lens assembly of Example 3 includes at least four optical lens elements, and at least one of the at least four optical lens elements is a filter lens element. The filter lens element includes a near-infrared light filter coating membrane, the near-infrared light filter coating membrane includes at least one low refractive index layer and at least one high refractive index layer, and the near-infrared light filter coating membrane is formed by alternately stacking the at least one high refractive index layer and the at least one low refractive index layer. Further, at least one of the at least four optical lens elements can include a blue glass material, the filter lens element can be made of a glass material, and the filter lens element can have at least one aspheric surface.

Table 3A shows the values of tLs, otLs, itLs, tTk, LtTk, HtTk, LtTk/HtTk, otTk, itTk, otTk/itTk, NL, NH and NH−NL of the near-infrared light filter coating membrane of the filter lens element of Example 3, wherein the near-infrared light filter coating membrane can be disposed on the object-side surface or the image-side surface of the filter lens element, and the total number of layers of the near-infrared light filter coating membrane of the filter lens element in Example 3 is tLs=78.

TABLE 3A

| | | | |
|---|---|---|---|
| tLs | 78 | otTk (nm) | — |
| otLs | — | itTk (nm) | — |
| itLs | — | otTk/itTk | — |
| tTk (nm) | 6028 | NL | 1.46 |
| LtTk (nm) | 3565 | NH | 2.33 |
| HtTk (nm) | 2463 | NH - NL | 0.87 |
| LtTk/HtTk | 1.45 | | |

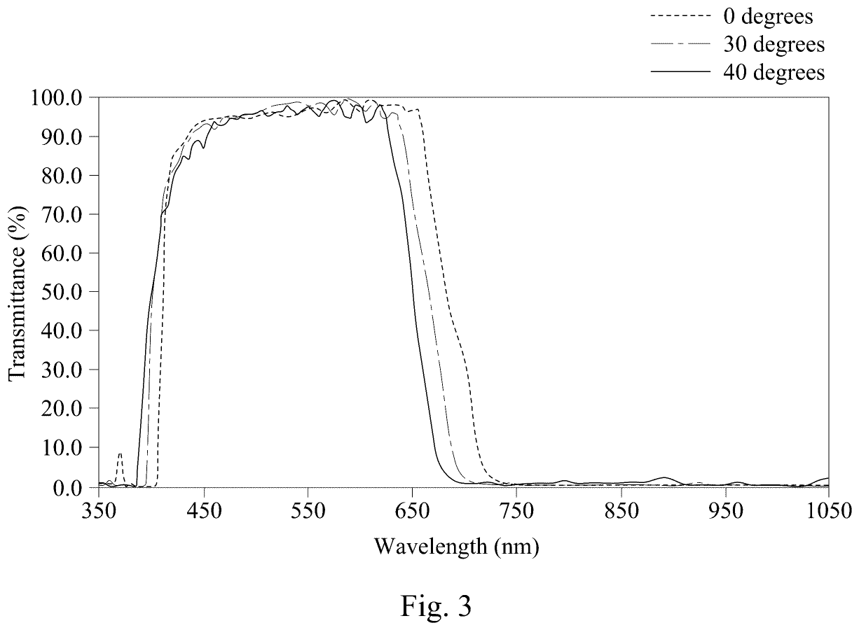

FIG. 3 is a relationship diagram between transmittances and wavelengths of a filter lens element of an optical lens assembly according to Example 3, and Table 3B shows the values of transmittance in a wavelength range of 350 nm-1050 nm of the filter lens element of Example 3, wherein the incidence angles of the light entering the filter lens element of Example 3 are respectively 0 degrees, 30 degrees and 40 degrees.

TABLE 3B

| Wavelength (nm) | 0 degrees | 30 degrees | 40 degrees |
|---|---|---|---|
| 350 | 0.23 | 0.78 | 1.36 |
| 355 | 0.28 | 0.72 | 1.01 |
| 360 | 0.43 | 1.53 | 0.37 |
| 365 | 1.10 | 0.44 | 0.22 |
| 370 | 9.33 | 0.65 | 0.25 |
| 375 | 0.70 | 0.19 | 0.04 |
| 380 | 1.47 | 0.03 | 0.67 |
| 385 | 0.11 | 0.05 | 0.23 |
| 390 | 0.02 | 0.07 | 14.56 |
| 395 | 0.01 | 0.80 | 35.17 |
| 400 | 0.14 | 47.05 | 50.69 |
| 405 | 0.17 | 57.07 | 59.28 |
| 410 | 44.70 | 73.46 | 70.22 |
| 415 | 78.45 | 78.71 | 71.96 |
| 420 | 85.60 | 81.35 | 79.32 |
| 425 | 86.61 | 83.09 | 82.03 |
| 430 | 88.20 | 87.36 | 84.74 |
| 435 | 90.55 | 88.68 | 84.00 |
| 440 | 92.52 | 90.96 | 87.86 |
| 445 | 93.66 | 91.76 | 88.87 |
| 450 | 93.56 | 92.86 | 86.77 |
| 455 | 94.32 | 92.94 | 91.21 |
| 460 | 94.31 | 91.99 | 93.49 |
| 465 | 94.58 | 93.39 | 92.70 |
| 470 | 94.17 | 94.57 | 92.93 |
| 475 | 94.44 | 94.71 | 94.35 |
| 480 | 94.78 | 94.72 | 94.35 |
| 485 | 94.63 | 95.14 | 94.69 |
| 490 | 94.45 | 95.30 | 95.27 |
| 495 | 95.03 | 95.59 | 95.78 |
| 500 | 95.40 | 95.97 | 96.06 |
| 505 | 95.37 | 96.33 | 96.20 |
| 510 | 95.70 | 97.06 | 95.24 |
| 515 | 96.02 | 97.57 | 95.39 |
| 520 | 95.72 | 97.98 | 96.07 |
| 525 | 95.11 | 98.17 | 96.22 |
| 530 | 94.93 | 98.31 | 97.81 |
| 535 | 95.10 | 98.50 | 96.90 |
| 540 | 95.87 | 98.69 | 95.45 |
| 545 | 96.69 | 98.45 | 96.50 |
| 550 | 96.93 | 97.73 | 97.33 |
| 555 | 97.02 | 97.99 | 96.24 |
| 560 | 96.60 | 98.60 | 95.28 |
| 565 | 95.92 | 98.37 | 96.96 |
| 570 | 96.28 | 96.74 | 98.91 |
| 575 | 97.56 | 95.44 | 99.26 |
| 580 | 98.59 | 97.30 | 98.11 |
| 585 | 99.31 | 99.71 | 94.93 |
| 590 | 98.82 | 99.45 | 94.53 |
| 595 | 96.53 | 98.48 | 97.95 |
| 600 | 96.22 | 97.34 | 97.40 |
| 605 | 98.86 | 96.56 | 93.59 |
| 610 | 99.66 | 98.06 | 94.10 |
| 615 | 97.95 | 98.40 | 97.12 |
| 620 | 97.63 | 95.55 | 97.93 |
| 625 | 98.06 | 94.39 | 94.83 |
| 630 | 97.83 | 96.03 | 87.39 |
| 635 | 97.95 | 95.66 | 80.24 |
| 640 | 97.50 | 91.40 | 75.04 |
| 645 | 96.14 | 83.58 | 64.90 |
| 650 | 96.61 | 73.30 | 51.08 |
| 655 | 96.77 | 64.78 | 37.71 |
| 660 | 89.99 | 58.80 | 28.87 |
| 665 | 79.03 | 51.29 | 20.82 |
| 670 | 69.96 | 41.73 | 11.53 |
| 675 | 61.66 | 31.99 | 6.27 |
| 680 | 52.61 | 22.20 | 3.92 |
| 685 | 45.02 | 12.85 | 2.66 |
| 690 | 40.22 | 6.74 | 1.80 |
| 695 | 36.51 | 3.86 | 1.20 |
| 700 | 31.21 | 2.49 | 0.86 |
| 705 | 22.94 | 1.71 | 0.72 |
| 710 | 13.81 | 1.17 | 0.72 |
| 715 | 7.49 | 0.80 | 0.81 |
| 720 | 4.26 | 0.60 | 0.95 |
| 725 | 2.66 | 0.51 | 1.00 |
| 730 | 1.81 | 0.52 | 0.76 |
| 735 | 1.27 | 0.61 | 0.52 |
| 740 | 0.89 | 0.71 | 0.39 |
| 745 | 0.63 | 0.71 | 0.34 |
| 750 | 0.49 | 0.53 | 0.35 |
| 755 | 0.42 | 0.35 | 0.41 |
| 760 | 0.42 | 0.25 | 0.50 |
| 765 | 0.48 | 0.21 | 0.62 |
| 770 | 0.61 | 0.21 | 0.73 |
| 775 | 0.66 | 0.23 | 0.82 |
| 780 | 0.50 | 0.28 | 0.95 |
| 785 | 0.32 | 0.34 | 1.18 |
| 790 | 0.22 | 0.40 | 1.50 |
| 795 | 0.18 | 0.44 | 1.69 |
| 800 | 0.16 | 0.48 | 1.47 |
| 805 | 0.17 | 0.56 | 1.14 |
| 810 | 0.20 | 0.72 | 1.00 |
| 815 | 0.24 | 0.97 | 1.06 |
| 820 | 0.28 | 1.18 | 0.94 |
| 825 | 0.32 | 1.13 | 0.80 |
| 830 | 0.34 | 1.02 | 0.74 |
| 835 | 0.36 | 0.88 | 0.72 |
| 840 | 0.42 | 0.68 | 0.74 |
| 845 | 0.55 | 0.56 | 0.79 |
| 850 | 0.79 | 0.50 | 0.86 |
| 855 | 1.13 | 0.49 | 0.96 |
| 860 | 1.17 | 0.49 | 1.08 |
| 865 | 0.86 | 0.49 | 1.22 |
| 870 | 0.59 | 0.50 | 1.39 |
| 875 | 0.45 | 0.51 | 1.59 |
| 880 | 0.37 | 0.52 | 1.83 |
| 885 | 0.35 | 0.54 | 2.10 |
| 890 | 0.34 | 0.56 | 2.28 |
| 895 | 0.35 | 0.58 | 2.15 |
| 900 | 0.37 | 0.62 | 1.69 |
| 905 | 0.38 | 0.67 | 1.20 |
| 910 | 0.38 | 0.76 | 0.84 |
| 915 | 0.37 | 0.89 | 0.63 |
| 920 | 0.36 | 1.01 | 0.51 |
| 925 | 0.34 | 1.02 | 0.43 |
| 930 | 0.33 | 0.85 | 0.39 |
| 935 | 0.32 | 0.64 | 0.39 |
| 940 | 0.32 | 0.47 | 0.42 |
| 945 | 0.33 | 0.35 | 0.49 |
| 950 | 0.36 | 0.26 | 0.61 |
| 955 | 0.42 | 0.21 | 0.80 |
| 960 | 0.50 | 0.19 | 1.00 |
| 965 | 0.60 | 0.18 | 1.04 |
| 970 | 0.62 | 0.19 | 0.87 |
| 975 | 0.52 | 0.21 | 0.67 |
| 980 | 0.37 | 0.26 | 0.53 |
| 985 | 0.26 | 0.35 | 0.47 |
| 990 | 0.18 | 0.50 | 0.46 |
| 995 | 0.14 | 0.66 | 0.40 |
| 1000 | 0.12 | 0.70 | 0.36 |
| 1005 | 0.11 | 0.60 | 0.35 |
| 1010 | 0.10 | 0.52 | 0.37 |
| 1015 | 0.11 | 0.46 | 0.43 |
| 1020 | 0.12 | 0.35 | 0.52 |
| 1025 | 0.14 | 0.27 | 0.69 |
| 1030 | 0.19 | 0.22 | 0.95 |
| 1035 | 0.27 | 0.21 | 1.34 |
| 1040 | 0.42 | 0.20 | 1.84 |
| 1045 | 0.62 | 0.22 | 2.27 |
| 1050 | 0.70 | 0.25 | 2.38 |

Table 30 shows the values of Wt50v, |dWt50v3|, |dWt50v4|, T3540, T4563, T6065, T70105, T45, T50, T63, T85 and T94 of the filter lens element of the optical lens assembly of Example 3 at the incidence angles of 0 degrees, 30 degrees and 40 degrees.

TABLE 3C

| | 0 degrees | 30 degrees | 40 degrees |
|---|---|---|---|
| Wt50v (nm) | 681.72 | 665.67 | 650.40 |
| \|dWt50v3\| (nm) | 16.05 | | |
| \|dWt50v4\| (nm) | 31.32 | | |
| T3540 (%) | 1.26 | 4.76 | 9.51 |
| T4563 (%) | 96.22 | 96.61 | 95.28 |
| T6065 (%) | 97.68 | 92.75 | 84.87 |
| T70105 (%) | 1.56 | 0.57 | 0.93 |
| T45 (%) | 93.56 | 92.86 | 86.77 |
| T50 (%) | 96.93 | 97.73 | 97.33 |
| T63 (%) | 97.83 | 96.03 | 87.39 |
| T85 (%) | 0.79 | 0.50 | 0.86 |
| T94 (%) | 0.32 | 0.47 | 0.42 |

### Example 4

The optical lens assembly of Example 4 includes at least four optical lens elements, and at least one of the at least four optical lens elements is a filter lens element. The filter lens element includes a near-infrared light filter coating membrane, the near-infrared light filter coating membrane includes at least one low refractive index layer and at least one high refractive index layer, and the near-infrared light filter coating membrane is formed by alternately stacking the at least one high refractive index layer and the at least one low refractive index layer. Further, at least one of the at least four optical lens elements can include a blue glass material, the filter lens element can be made of a glass material, and the filter lens element can have at least one aspheric surface.

Table 4A shows the values of tLs, otLs, itLs, tTk, LtTk, HtTk, LtTk/HtTk, otTk, itTk, otTk/itTk, NL, NH and NH−NL of the near-infrared light filter coating membrane of the filter lens element of Example 4, wherein the near-infrared light filter coating membrane can be disposed on the object-side surface or the image-side surface of the filter lens element, and the total number of layers of the near-infrared light filter coating membrane of the filter lens element in Example 4 is tLs=84.

TABLE 4A

| | | | |
|---|---|---|---|
| tLs | 84 | otTk (nm) | — |
| otLs | — | itTk (nm) | — |
| itLs | — | otTk/itTk | — |
| tTk (nm) | 5972 | NL | 1.46 |
| LtTk (nm) | 3201 | NH | 2.33 |
| HtTk (nm) | 2771 | NH - NL | 0.87 |
| LtTk/HtTk | 1.16 | | |

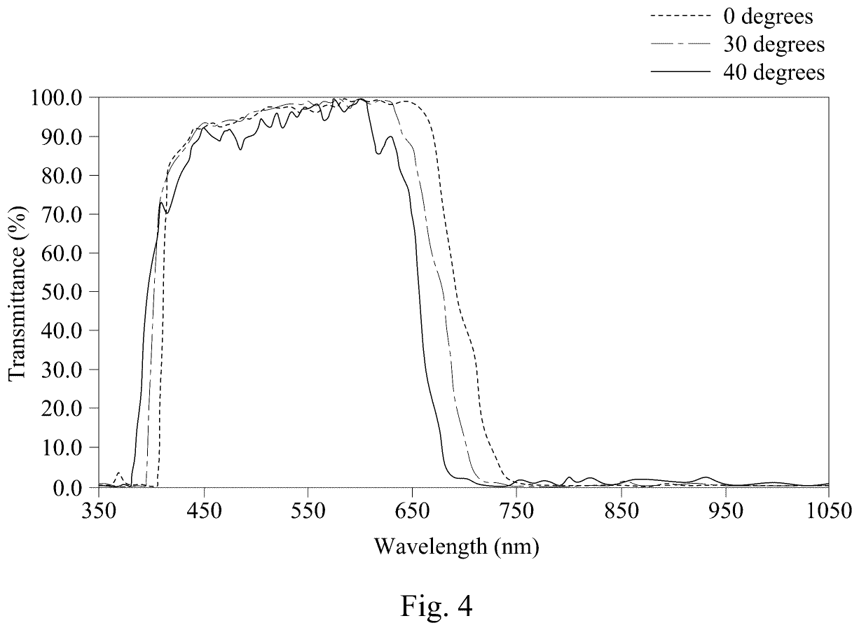

FIG. 4 is a relationship diagram between transmittances an wavelengths of a filter lens element of an optical lens assembly according to Example 4, and Table 4B shows the values of transmittance in a wavelength range of 350 nm-1050 nm of the filter lens element of Example 4, wherein the incidence angles of the light entering the filter lens element of Example 4 are respectively 0 degrees, 30 degrees and 40 degrees.

TABLE 4B

| Wavelength (nm) | 0 degrees | 30 degrees | 40 degrees |
|---|---|---|---|
| 350 | 1.32 | 0.81 | 0.50 |
| 355 | 0.88 | 0.92 | 0.21 |
| 360 | 0.76 | 0.87 | 0.12 |
| 365 | 1.60 | 0.30 | 0.29 |
| 370 | 4.44 | 0.22 | 0.23 |
| 375 | 0.66 | 0.35 | 1.02 |
| 380 | 0.26 | 0.39 | 0.54 |
| 385 | 0.33 | 0.20 | 9.05 |
| 390 | 0.89 | 0.20 | 23.48 |
| 395 | 0.06 | 0.71 | 46.85 |
| 400 | 0.40 | 38.04 | 56.73 |
| 405 | 0.21 | 64.63 | 64.04 |
| 410 | 31.90 | 75.43 | 72.78 |
| 415 | 79.67 | 79.87 | 70.36 |
| 420 | 84.50 | 82.91 | 72.97 |
| 425 | 85.92 | 84.96 | 77.94 |
| 430 | 87.15 | 86.29 | 81.26 |
| 435 | 89.17 | 88.56 | 83.39 |
| 440 | 91.81 | 90.29 | 87.77 |
| 445 | 92.46 | 92.35 | 89.30 |
| 450 | 92.72 | 93.32 | 92.30 |
| 455 | 93.20 | 93.02 | 90.88 |
| 460 | 93.07 | 92.41 | 89.74 |
| 465 | 92.33 | 93.48 | 88.83 |
| 470 | 92.84 | 93.83 | 91.25 |
| 475 | 93.06 | 94.05 | 91.73 |
| 480 | 93.58 | 93.90 | 89.98 |
| 485 | 94.69 | 93.89 | 86.74 |
| 490 | 94.89 | 95.12 | 89.35 |
| 495 | 94.20 | 95.89 | 89.87 |
| 500 | 95.78 | 96.20 | 90.89 |
| 505 | 96.92 | 96.53 | 94.37 |
| 510 | 97.30 | 96.95 | 92.68 |
| 515 | 97.42 | 96.97 | 92.62 |
| 520 | 97.32 | 97.52 | 96.07 |
| 525 | 97.01 | 97.85 | 92.30 |
| 530 | 97.37 | 98.11 | 94.11 |
| 535 | 97.60 | 98.14 | 96.16 |
| 540 | 96.36 | 98.28 | 94.94 |
| 545 | 96.17 | 98.12 | 97.48 |
| 550 | 97.17 | 98.71 | 96.97 |
| 555 | 96.63 | 98.35 | 97.67 |
| 560 | 96.24 | 97.81 | 98.27 |
| 565 | 97.66 | 98.71 | 94.12 |
| 570 | 97.83 | 98.58 | 95.14 |
| 575 | 97.05 | 98.81 | 99.30 |
| 580 | 98.61 | 99.61 | 97.69 |
| 585 | 99.84 | 98.14 | 96.18 |
| 590 | 98.80 | 97.22 | 98.04 |
| 595 | 98.98 | 99.03 | 98.65 |
| 600 | 99.97 | 99.90 | 99.33 |
| 605 | 99.09 | 98.42 | 99.05 |
| 610 | 98.35 | 98.16 | 92.30 |
| 615 | 99.10 | 99.19 | 85.51 |
| 620 | 99.62 | 99.30 | 85.54 |
| 625 | 98.82 | 99.04 | 89.28 |
| 630 | 97.96 | 98.41 | 89.81 |
| 635 | 98.22 | 95.00 | 85.41 |
| 640 | 98.77 | 90.71 | 80.00 |
| 645 | 98.52 | 88.68 | 77.13 |
| 650 | 98.17 | 86.60 | 69.73 |
| 655 | 97.86 | 81.26 | 54.71 |
| 660 | 96.41 | 73.69 | 38.92 |
| 665 | 93.98 | 65.27 | 26.44 |
| 670 | 89.83 | 58.35 | 21.24 |
| 675 | 81.02 | 55.12 | 14.96 |
| 680 | 69.84 | 49.47 | 7.33 |
| 685 | 60.64 | 36.26 | 3.78 |
| 690 | 53.07 | 24.37 | 2.56 |
| 695 | 45.80 | 17.57 | 2.20 |
| 700 | 40.98 | 12.50 | 2.37 |
| 705 | 39.02 | 7.21 | 2.11 |
| 710 | 32.92 | 3.38 | 1.11 |
| 715 | 21.40 | 1.80 | 0.55 |
| 720 | 13.91 | 1.27 | 0.35 |
| 725 | 10.61 | 1.19 | 0.27 |
| 730 | 8.20 | 1.27 | 0.27 |
| 735 | 4.70 | 1.17 | 0.34 |
| 740 | 2.27 | 0.68 | 0.51 |
| 745 | 1.25 | 0.33 | 0.92 |
| 750 | 0.88 | 0.19 | 1.64 |
| 755 | 0.81 | 0.13 | 1.72 |
| 760 | 0.94 | 0.12 | 1.38 |
| 765 | 1.05 | 0.13 | 1.27 |
| 770 | 0.66 | 0.17 | 1.44 |
| 775 | 0.31 | 0.30 | 1.69 |
| 780 | 0.17 | 0.56 | 1.51 |
| 785 | 0.11 | 0.87 | 1.07 |
| 790 | 0.09 | 0.77 | 0.83 |
| 795 | 0.09 | 0.58 | 1.14 |
| 800 | 0.11 | 0.55 | 2.86 |
| 805 | 0.17 | 0.65 | 1.61 |
| 810 | 0.32 | 0.89 | 1.36 |
| 815 | 0.67 | 0.96 | 2.08 |
| 820 | 0.85 | 0.79 | 2.70 |
| 825 | 0.59 | 0.72 | 2.19 |
| 830 | 0.45 | 0.55 | 1.55 |
| 835 | 0.45 | 0.48 | 1.24 |
| 840 | 0.58 | 0.56 | 1.15 |
| 845 | 0.89 | 0.86 | 1.24 |
| 850 | 1.03 | 1.15 | 1.46 |
| 855 | 0.67 | 1.34 | 1.78 |
| 860 | 0.40 | 1.16 | 2.05 |
| 865 | 0.29 | 0.71 | 2.11 |
| 870 | 0.26 | 0.48 | 2.03 |
| 875 | 0.29 | 0.38 | 1.95 |
| 880 | 0.41 | 0.37 | 1.91 |
| 885 | 0.72 | 0.41 | 1.86 |
| 890 | 1.27 | 0.51 | 1.76 |
| 895 | 1.11 | 0.69 | 1.64 |
| 900 | 0.60 | 0.92 | 1.53 |
| 905 | 0.36 | 1.10 | 1.46 |
| 910 | 0.27 | 1.19 | 1.48 |
| 915 | 0.24 | 1.19 | 1.62 |
| 920 | 0.25 | 1.08 | 1.91 |
| 925 | 0.30 | 0.90 | 2.34 |
| 930 | 0.40 | 0.73 | 2.68 |
| 935 | 0.57 | 0.60 | 2.47 |
| 940 | 0.80 | 0.48 | 1.85 |
| 945 | 0.95 | 0.41 | 1.30 |
| 950 | 0.93 | 0.36 | 0.96 |
| 955 | 0.82 | 0.34 | 0.78 |
| 960 | 0.70 | 0.35 | 0.70 |
| 965 | 0.59 | 0.40 | 0.70 |
| 970 | 0.48 | 0.50 | 0.70 |
| 975 | 0.38 | 0.69 | 0.74 |
| 980 | 0.30 | 0.92 | 0.84 |
| 985 | 0.23 | 0.99 | 0.98 |
| 990 | 0.19 | 0.81 | 1.13 |
| 995 | 0.17 | 0.64 | 1.19 |
| 1000 | 0.17 | 0.53 | 1.12 |
| 1005 | 0.17 | 0.42 | 0.98 |
| 1010 | 0.20 | 0.33 | 0.85 |
| 1015 | 0.25 | 0.29 | 0.77 |
| 1020 | 0.35 | 0.29 | 0.75 |
| 1025 | 0.51 | 0.31 | 0.75 |
| 1030 | 0.70 | 0.36 | 0.73 |
| 1035 | 0.71 | 0.45 | 0.74 |
| 1040 | 0.54 | 0.57 | 0.80 |
| 1045 | 0.38 | 0.69 | 0.94 |
| 1050 | 0.28 | 0.74 | 1.17 |

Table 4C shows the values of Wt50v, |dWt50v3|, |dWt50v4|, T3540, T4563, T6065, T70105, T45, T50, T63, T85 and T94 of the filter lens element of the optical lens assembly of Example 4 at the incidence angles of 0 degrees, 30 degrees and 40 degrees.

TABLE 4C

| | 0 degrees | 30 degrees | 40 degrees |
|---|---|---|---|
| Wt50v (nm) | 692.11 | 679.53 | 656.49 |
| \|dWt50v3\| (nm) | 12.58 | | |
| \|dWt50v4\| (nm) | 35.62 | | |
| T3540 (%) | 1.05 | 3.91 | 12.64 |
| T4563 (%) | 96.64 | 97.05 | 93.38 |
| T6065 (%) | 98.78 | 95.76 | 86.64 |
| T70105 (%) | 2.90 | 0.96 | 1.35 |
| T45 (%) | 92.72 | 93.32 | 92.30 |
| T50 (%) | 97.17 | 98.71 | 96.97 |
| T63 (%) | 97.96 | 98.41 | 89.81 |
| T85 (%) | 1.03 | 1.15 | 1.46 |
| T94 (%) | 0.80 | 0.48 | 1.85 |

The optical lens assembly of Example 5 includes at least four optical lens elements, and at least one of the at least four optical lens elements is a filter lens element. The filter lens element includes a near-infrared light filter coating membrane, the near-infrared light filter coating membrane includes at least one low refractive index layer and at least one high refractive index layer, and the near-infrared light filter coating membrane is formed by alternately stacking the at least one high refractive index layer and the at least one low refractive index layer. Further, at least one of the at least four optical lens elements can include a blue glass material, the filter lens element can be made of a glass material, and the filter lens element can have at least one aspheric surface.

Table 5A shows the values of tLs, otLs, itLs, tTk, LtTk, HtTk, LtTk/HtTk, otTk, itTk, otTk/itTk, NL, NH and NH−NL of the near-infrared light filter coating membrane of the filter lens element of Example 5, wherein the near-infrared light filter coating membrane can be disposed on the object-side surface or the image-side surface of the filter lens element, and the total number of layers of the near-infrared light filter coating membrane of the filter lens element in Example 5 is tLs=70.

TABLE 5A

| | | | |
|---|---|---|---|
| tLs | 70 | otTk (nm) | — |
| otLs | — | itTk (nm) | — |
| itLs | — | otTk/itTk | — |
| tTk (nm) | 6048 | NL | 1.46 |
| LtTk (nm) | 3552 | NH | 2.33 |
| HtTk (nm) | 2497 | NH - NL | 0.87 |
| LtTk/HtTk | 1.42 | | |

The details of each layer of the near-infrared light filter coating membrane of Example 5 are shown in Table 5B, wherein “H” represents high refractive index layers, and “L” represents low refractive index layers.

TABLE 5B

| Layer Sequence | Material | Thickness (nm) |
|---|---|---|
| 1 | H | 2 |
| 2 | L | 253 |
| 3 | H | 3 |
| 4 | L | 30 |
| 5 | H | 0.5 |
| 6 | L | 214 |
| 7 | H | 17 |
| 8 | L | 38 |
| 9 | H | 83 |
| 10 | L | 86 |
| 11 | H | 38 |
| 12 | L | 194 |
| 13 | H | 118 |
| 14 | L | 193 |
| 15 | H | 119 |
| 16 | L | 193 |
| 17 | H | 119 |
| 18 | L | 196 |
| 19 | H | 120 |
| 20 | L | 193 |
| 21 | H | 118 |
| 22 | L | 194 |
| 23 | H | 117 |
| 24 | L | 186 |
| 25 | H | 106 |
| 26 | L | 165 |
| 27 | H | 100 |
| 28 | L | 167 |
| 29 | H | 92 |
| 30 | L | 156 |
| 31 | H | 93 |
| 32 | L | 150 |
| 33 | H | 96 |
| 34 | L | 108 |
| 35 | H | 4 |
| 36 | L | 35 |
| 37 | H | 91 |
| 38 | L | 158 |
| 39 | H | 92 |
| 40 | L | 153 |
| 41 | H | 99 |
| 42 | L | 32 |
| 43 | H | 19 |
| 44 | L | 36 |
| 45 | H | 107 |
| 46 | L | 36 |
| 47 | H | 17 |
| 48 | L | 41 |
| 49 | H | 108 |
| 50 | L | 34 |
| 51 | H | 17 |
| 52 | L | 35 |
| 53 | H | 110 |
| 54 | L | 28 |
| 55 | H | 19 |
| 56 | L | 24 |
| 57 | H | 110 |
| 58 | L | 35 |
| 59 | H | 20 |
| 60 | L | 28 |
| 61 | H | 109 |
| 62 | L | 37 |
| 63 | H | 22 |
| 64 | L | 26 |
| 65 | H | 103 |
| 66 | L | 39 |
| 67 | H | 21 |
| 68 | L | 30 |
| 69 | H | 88 |
| 70 | L | 78 |

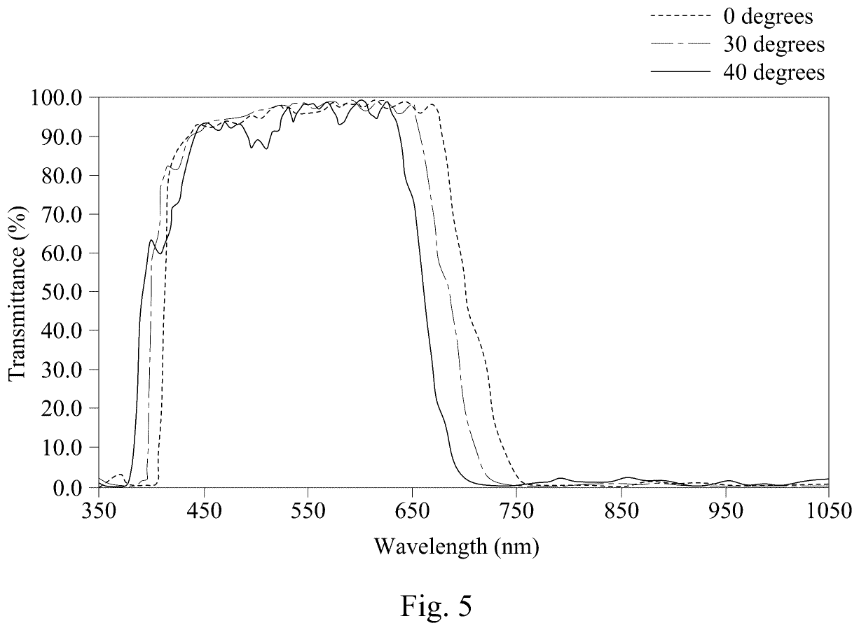

FIG. 5 is a relationship diagram between transmittances and wavelengths of a filter lens element of an optical lens assembly according to Example 5, and Table 5C shows the values of transmittance in a wavelength range of 350 nm-1050 nm of the filter lens element of Example 5, wherein the incidence angles of the light entering the filter lens element of Example 5 are respectively 0 degrees, 30 degrees and 40 degrees.

TABLE 5C

| Wavelength (nm) | 0 degrees | 30 degrees | 40 degrees |
|---|---|---|---|
| 350 | 1.13 | 2.07 | 1.16 |
| 355 | 1.02 | 1.01 | 0.25 |
| 360 | 1.77 | 0.80 | 0.07 |
| 365 | 2.64 | 0.49 | 0.05 |
| 370 | 3.93 | 0.12 | 0.15 |
| 375 | 0.77 | 0.07 | 0.36 |
| 380 | 0.18 | 0.06 | 3.20 |
| 385 | 0.11 | 0.16 | 19.00 |
| 390 | 0.04 | 1.60 | 46.21 |
| 395 | 0.10 | 1.76 | 58.38 |
| 400 | 1.06 | 58.62 | 63.50 |
| 405 | 0.47 | 64.17 | 60.21 |
| 410 | 27.49 | 79.21 | 60.29 |
| 415 | 80.41 | 82.40 | 64.60 |
| 420 | 84.08 | 81.54 | 71.95 |
| 425 | 87.02 | 81.45 | 72.53 |
| 430 | 88.77 | 85.56 | 78.06 |
| 435 | 89.72 | 88.73 | 84.82 |
| 440 | 91.93 | 90.93 | 89.73 |
| 445 | 93.34 | 91.12 | 92.56 |
| 450 | 92.80 | 92.13 | 93.05 |
| 455 | 92.61 | 93.88 | 93.55 |
| 460 | 92.56 | 94.16 | 92.11 |
| 465 | 93.47 | 94.26 | 91.77 |
| 470 | 94.29 | 94.30 | 93.81 |
| 475 | 93.61 | 94.57 | 92.37 |
| 480 | 93.51 | 94.73 | 92.93 |
| 485 | 93.50 | 94.92 | 93.51 |
| 490 | 94.66 | 95.11 | 91.19 |
| 495 | 95.39 | 96.00 | 86.95 |
| 500 | 95.21 | 96.66 | 89.50 |
| 505 | 94.70 | 96.62 | 88.77 |
| 510 | 96.04 | 96.86 | 86.79 |
| 515 | 97.55 | 97.52 | 91.10 |
| 520 | 97.89 | 97.81 | 91.38 |
| 525 | 97.62 | 97.95 | 95.32 |
| 530 | 97.49 | 97.71 | 97.48 |
| 535 | 96.76 | 98.37 | 93.69 |
| 540 | 95.65 | 98.38 | 95.92 |
| 545 | 95.95 | 98.54 | 98.28 |
| 550 | 95.83 | 98.42 | 98.32 |
| 555 | 96.04 | 97.14 | 98.23 |
| 560 | 97.42 | 97.70 | 97.24 |
| 565 | 97.57 | 98.74 | 97.96 |
| 570 | 96.79 | 98.88 | 98.68 |
| 575 | 97.10 | 98.78 | 95.93 |
| 580 | 98.19 | 97.92 | 93.02 |
| 585 | 98.51 | 98.17 | 93.64 |
| 590 | 98.55 | 99.53 | 96.60 |
| 595 | 98.76 | 98.83 | 98.66 |
| 600 | 98.14 | 97.09 | 99.61 |
| 605 | 97.92 | 96.68 | 98.90 |
| 610 | 99.37 | 97.40 | 95.84 |
| 615 | 99.58 | 98.61 | 94.73 |
| 620 | 97.92 | 99.51 | 97.60 |
| 625 | 97.26 | 98.90 | 98.68 |
| 630 | 97.91 | 97.40 | 96.35 |
| 635 | 98.39 | 96.19 | 93.41 |
| 640 | 98.86 | 96.17 | 85.98 |
| 645 | 98.87 | 97.87 | 76.72 |
| 650 | 97.40 | 98.39 | 74.02 |
| 655 | 95.99 | 93.91 | 67.66 |
| 660 | 96.32 | 87.09 | 52.09 |
| 665 | 97.58 | 80.23 | 41.04 |
| 670 | 98.25 | 70.13 | 28.31 |
| 675 | 96.51 | 58.88 | 20.33 |
| 680 | 89.62 | 53.15 | 17.43 |
| 685 | 78.85 | 51.54 | 13.26 |
| 690 | 69.12 | 43.70 | 7.19 |
| 695 | 60.95 | 30.95 | 3.67 |
| 700 | 51.97 | 20.95 | 2.16 |
| 705 | 43.77 | 15.09 | 1.49 |
| 710 | 39.43 | 10.83 | 1.13 |
| 715 | 37.63 | 6.74 | 0.88 |
| 720 | 31.99 | 3.45 | 0.67 |
| 725 | 22.05 | 1.77 | 0.50 |
| 730 | 14.80 | 1.05 | 0.38 |
| 735 | 10.97 | 0.72 | 0.32 |
| 740 | 8.18 | 0.55 | 0.28 |
| 745 | 4.98 | 0.44 | 0.28 |
| 750 | 2.55 | 0.35 | 0.29 |
| 755 | 1.34 | 0.26 | 0.34 |
| 760 | 0.80 | 0.20 | 0.42 |
| 765 | 0.55 | 0.16 | 0.54 |
| 770 | 0.42 | 0.13 | 0.72 |
| 775 | 0.35 | 0.12 | 0.97 |
| 780 | 0.29 | 0.12 | 1.31 |
| 785 | 0.23 | 0.13 | 1.71 |
| 790 | 0.18 | 0.15 | 2.09 |
| 795 | 0.14 | 0.19 | 2.21 |
| 800 | 0.11 | 0.24 | 1.94 |
| 805 | 0.10 | 0.32 | 1.54 |
| 810 | 0.09 | 0.42 | 1.26 |
| 815 | 0.10 | 0.55 | 1.22 |
| 820 | 0.11 | 0.72 | 1.34 |
| 825 | 0.13 | 0.95 | 1.18 |
| 830 | 0.16 | 1.19 | 1.03 |
| 835 | 0.21 | 1.28 | 1.10 |
| 840 | 0.27 | 1.17 | 1.37 |
| 845 | 0.36 | 1.02 | 1.77 |
| 850 | 0.47 | 0.83 | 2.14 |
| 855 | 0.61 | 0.67 | 2.21 |
| 860 | 0.81 | 0.58 | 2.00 |
| 865 | 1.08 | 0.57 | 1.76 |
| 870 | 1.29 | 0.62 | 1.61 |
| 875 | 1.16 | 0.67 | 1.56 |
| 880 | 0.85 | 0.73 | 1.56 |
| 885 | 0.60 | 0.80 | 1.52 |
| 890 | 0.46 | 0.76 | 1.36 |
| 895 | 0.40 | 0.62 | 1.13 |
| 900 | 0.38 | 0.48 | 0.89 |
| 905 | 0.41 | 0.39 | 0.72 |
| 910 | 0.48 | 0.34 | 0.61 |
| 915 | 0.59 | 0.33 | 0.56 |
| 920 | 0.67 | 0.34 | 0.55 |
| 925 | 0.59 | 0.38 | 0.58 |
| 930 | 0.43 | 0.41 | 0.66 |
| 935 | 0.30 | 0.41 | 0.82 |
| 940 | 0.23 | 0.37 | 1.09 |
| 945 | 0.18 | 0.30 | 1.44 |
| 950 | 0.16 | 0.25 | 1.67 |
| 955 | 0.16 | 0.20 | 1.52 |
| 960 | 0.17 | 0.17 | 1.17 |
| 965 | 0.19 | 0.15 | 0.87 |
| 970 | 0.22 | 0.15 | 0.68 |
| 975 | 0.25 | 0.16 | 0.58 |
| 980 | 0.25 | 0.18 | 0.56 |
| 985 | 0.21 | 0.23 | 0.63 |
| 990 | 0.17 | 0.31 | 0.60 |
| 995 | 0.13 | 0.47 | 0.56 |
| 1000 | 0.10 | 0.72 | 0.60 |
| 1005 | 0.09 | 0.93 | 0.68 |
| 1010 | 0.08 | 0.85 | 0.82 |
| 1015 | 0.08 | 0.68 | 1.00 |
| 1020 | 0.08 | 0.64 | 1.24 |
| 1025 | 0.09 | 0.57 | 1.49 |
| 1030 | 0.11 | 0.41 | 1.72 |
| 1035 | 0.14 | 0.32 | 1.87 |
| 1040 | 0.20 | 0.28 | 1.95 |
| 1045 | 0.32 | 0.26 | 2.01 |
| 1050 | 0.55 | 0.27 | 2.11 |

Table 5D shows the values of Wt50v, |dWt50v3|, |dWt50v4|, T3540, T4563, T6065, T70105, T45, T50, T63, T85 and T94 of the filter lens element of the optical lens assembly of Example 5 at the incidence angles of 0 degrees, 30 degrees and 40 degrees.

TABLE 5D

| | 0 degrees | 30 degrees | 40 degrees |
|---|---|---|---|
| Wt50v (nm) | 701.20 | 685.98 | 660.94 |
| \|dWt50v3\| (nm) | 15.22 | | |
| \|dWt50v4\| (nm) | 40.26 | | |
| T3540 (%) | 1.16 | 6.07 | 17.48 |
| T4563 (%) | 96.33 | 97.03 | 94.58 |
| T6065 (%) | 98.33 | 97.66 | 91.98 |
| T70105 (%) | 4.08 | 1.27 | 1.15 |
| T45 (%) | 92.80 | 92.13 | 93.05 |
| T50 (%) | 95.83 | 98.42 | 98.32 |
| T63 (%) | 97.91 | 97.40 | 96.35 |
| T85 (%) | 0.47 | 0.83 | 2.14 |
| T94 (%) | 0.23 | 0.37 | 1.09 |

### Example 6

The optical lens assembly of Example 6 includes at least four optical lens elements, and at least one of the at least four optical lens elements is a filter lens element. The filter lens element includes a near-infrared light filter coating membrane, the near-infrared light filter coating membrane includes at least one low refractive index layer and at least one high refractive index layer, and the near-infrared light filter coating membrane is formed by alternately stacking the at least one high refractive index layer and the at least one low refractive index layer. Further, at least one of the at least four optical lens elements can include a blue glass material, the filter lens element can be made of a glass material, and the filter lens element can have at least one aspheric surface.

Table 6A shows the values of tLs, otLs, itLs, tTk, LtTk, HtTk, LtTk/HtTk, otTk, itTk, otTk/itTk, NL, NH and NH−NL of the near-infrared light filter coating membrane of the filter lens element of Example 6, wherein the near-infrared light filter coating membrane of Example 6 is disposed on the object-side surface and the image-side surface of the filter lens element, a total number of layers of the multi-layer coating membrane of the filter lens element is tLs=72, a total number of layers of the multi-layer coating membrane on the object-side surface of the filter lens element is otLs=36, and a total number of layers of the multi-layer coating membrane on the image-side surface of the filter lens element is itLs=36.

TABLE 6A

| | | | |
|---|---|---|---|
| tLs | 72 | otTk (nm) | 4452 |
| otLs | 36 | itTk (nm) | 3042 |
| itLs | 36 | otTk/itTk | 1.46 |
| tTk (nm) | 7493 | NL | 1.46 |
| LtTk (nm) | 4423 | NH | 2.33 |
| HtTk (nm) | 3071 | NH - NL | 0.87 |
| LtTk/HtTk | 1.44 | | |

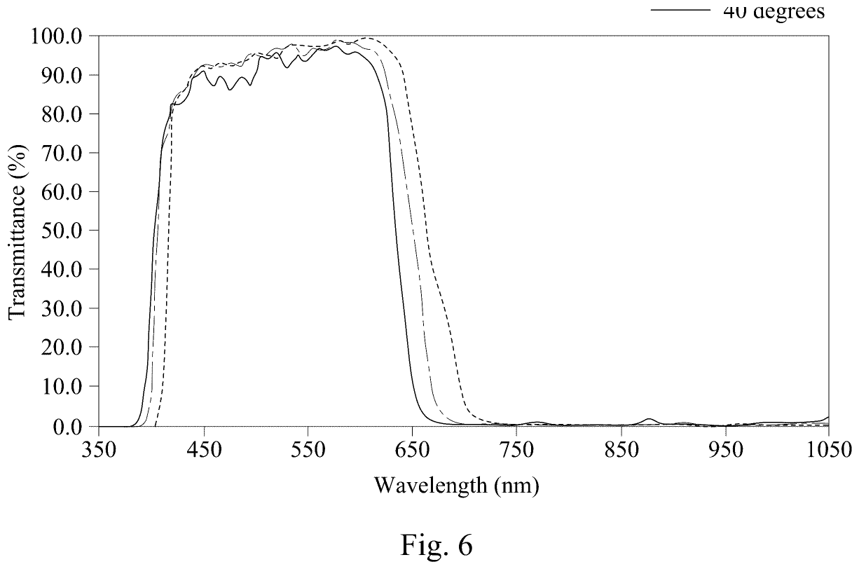

FIG. 6 is a relationship diagram between transmittances and wavelengths of a filter lens element of an optical lens assembly according to Example 6, and Table 6B shows the values of transmittance in a wavelength range of 350 nm-1050 nm of the filter lens element of Example 6, wherein the incidence angles of the light entering the filter lens element of Example 6 are respectively 0 degrees, 30 degrees and 40 degrees.

TABLE 6B

| Wavelength (nm) | 0 degrees | 30 degrees | 40 degrees |
|---|---|---|---|
| 350 | 0.02 | 0.00 | 0.01 |
| 355 | 0.00 | 0.00 | 0.00 |
| 360 | 0.00 | 0.00 | 0.00 |
| 365 | 0.01 | 0.00 | 0.03 |
| 370 | 0.00 | 0.03 | 0.16 |
| 375 | 0.00 | 0.13 | 0.14 |
| 380 | 0.05 | 0.05 | 0.29 |
| 385 | 0.08 | 0.11 | 0.51 |
| 390 | 0.03 | 0.27 | 2.81 |
| 395 | 0.06 | 1.60 | 12.22 |
| 400 | 0.16 | 9.72 | 36.36 |
| 405 | 0.98 | 39.87 | 56.20 |
| 410 | 8.63 | 71.14 | 70.44 |
| 415 | 32.88 | 74.42 | 77.95 |
| 420 | 80.95 | 81.10 | 82.61 |
| 425 | 84.16 | 85.01 | 82.19 |
| 430 | 85.56 | 85.98 | 82.82 |
| 435 | 87.91 | 87.73 | 85.63 |
| 440 | 90.35 | 89.82 | 89.02 |
| 445 | 91.88 | 91.02 | 89.86 |
| 450 | 92.48 | 92.39 | 91.05 |
| 455 | 91.24 | 92.25 | 88.45 |
| 460 | 91.93 | 92.05 | 87.39 |
| 465 | 93.23 | 92.15 | 89.78 |
| 470 | 92.49 | 92.18 | 88.25 |
| 475 | 92.19 | 92.96 | 86.32 |
| 480 | 92.66 | 92.84 | 87.42 |
| 485 | 93.16 | 92.30 | 89.31 |
| 490 | 93.52 | 93.59 | 88.50 |
| 495 | 94.46 | 95.10 | 87.22 |
| 500 | 95.38 | 95.30 | 90.83 |
| 505 | 95.26 | 94.73 | 94.64 |
| 510 | 94.94 | 95.00 | 94.16 |
| 515 | 94.34 | 96.28 | 94.45 |
| 520 | 94.23 | 96.82 | 95.82 |
| 525 | 95.72 | 96.54 | 93.83 |
| 530 | 97.37 | 97.18 | 91.92 |
| 535 | 97.65 | 97.70 | 93.52 |
| 540 | 97.44 | 96.32 | 94.84 |
| 545 | 97.45 | 95.02 | 93.70 |
| 550 | 97.42 | 95.69 | 93.51 |
| 555 | 97.38 | 96.71 | 95.43 |
| 560 | 97.41 | 96.34 | 96.62 |
| 565 | 97.36 | 96.00 | 96.23 |
| 570 | 97.53 | 97.16 | 96.44 |
| 575 | 98.20 | 98.55 | 97.32 |
| 580 | 98.64 | 98.62 | 96.93 |
| 585 | 98.21 | 98.09 | 95.59 |
| 590 | 97.76 | 98.14 | 95.23 |
| 595 | 98.26 | 98.12 | 95.64 |
| 600 | 99.24 | 97.34 | 95.23 |
| 605 | 99.40 | 96.57 | 94.05 |
| 610 | 98.79 | 96.49 | 93.08 |
| 615 | 98.32 | 95.74 | 91.00 |
| 620 | 98.18 | 93.12 | 87.04 |
| 625 | 97.47 | 89.10 | 81.38 |
| 630 | 95.98 | 84.23 | 66.86 |
| 635 | 94.26 | 77.58 | 49.07 |
| 640 | 91.72 | 69.37 | 36.99 |
| 645 | 86.54 | 61.83 | 22.65 |
| 650 | 78.27 | 54.32 | 11.60 |
| 655 | 68.33 | 42.21 | 6.10 |
| 660 | 58.10 | 27.73 | 3.57 |
| 665 | 48.44 | 15.26 | 2.32 |
| 670 | 40.53 | 7.87 | 1.63 |
| 675 | 35.24 | 4.34 | 1.21 |
| 680 | 31.94 | 2.67 | 0.95 |
| 685 | 27.48 | 1.80 | 0.78 |
| 690 | 19.37 | 1.30 | 0.66 |
| 695 | 11.23 | 0.98 | 0.60 |
| 700 | 6.26 | 0.77 | 0.59 |
| 705 | 3.73 | 0.63 | 0.62 |
| 710 | 2.44 | 0.53 | 0.67 |
| 715 | 1.73 | 0.48 | 0.73 |
| 720 | 1.31 | 0.47 | 0.74 |
| 725 | 1.02 | 0.49 | 0.68 |
| 730 | 0.83 | 0.53 | 0.58 |
| 735 | 0.68 | 0.57 | 0.49 |
| 740 | 0.59 | 0.58 | 0.44 |
| 745 | 0.54 | 0.53 | 0.43 |
| 750 | 0.52 | 0.44 | 0.48 |
| 755 | 0.54 | 0.37 | 0.60 |
| 760 | 0.59 | 0.32 | 0.76 |
| 765 | 0.66 | 0.31 | 0.97 |
| 770 | 0.68 | 0.33 | 1.20 |
| 775 | 0.61 | 0.40 | 1.15 |
| 780 | 0.49 | 0.54 | 0.86 |
| 785 | 0.38 | 0.74 | 0.62 |
| 790 | 0.31 | 0.87 | 0.48 |
| 795 | 0.28 | 0.85 | 0.41 |
| 800 | 0.27 | 0.63 | 0.38 |
| 805 | 0.29 | 0.43 | 0.39 |
| 810 | 0.35 | 0.31 | 0.43 |
| 815 | 0.48 | 0.24 | 0.49 |
| 820 | 0.70 | 0.21 | 0.57 |
| 825 | 0.86 | 0.21 | 0.65 |
| 830 | 0.71 | 0.22 | 0.68 |
| 835 | 0.45 | 0.24 | 0.64 |
| 840 | 0.29 | 0.27 | 0.59 |
| 845 | 0.21 | 0.29 | 0.55 |
| 850 | 0.16 | 0.30 | 0.54 |
| 855 | 0.15 | 0.27 | 0.58 |
| 860 | 0.14 | 0.23 | 0.69 |
| 865 | 0.15 | 0.19 | 0.91 |
| 870 | 0.16 | 0.17 | 1.31 |
| 875 | 0.18 | 0.15 | 1.82 |
| 880 | 0.19 | 0.15 | 1.76 |
| 885 | 0.18 | 0.16 | 1.12 |
| 890 | 0.15 | 0.18 | 0.65 |
| 895 | 0.12 | 0.24 | 0.40 |
| 900 | 0.09 | 0.34 | 0.29 |
| 905 | 0.07 | 0.55 | 0.25 |
| 910 | 0.06 | 0.88 | 0.28 |
| 915 | 0.05 | 0.92 | 0.20 |
| 920 | 0.05 | 0.58 | 0.15 |
| 925 | 0.05 | 0.38 | 0.13 |
| 930 | 0.06 | 0.36 | 0.13 |
| 935 | 0.06 | 0.28 | 0.13 |
| 940 | 0.08 | 0.17 | 0.14 |
| 945 | 0.11 | 0.11 | 0.16 |
| 950 | 0.17 | 0.09 | 0.19 |
| 955 | 0.29 | 0.08 | 0.23 |
| 960 | 0.57 | 0.07 | 0.30 |
| 965 | 0.83 | 0.07 | 0.39 |
| 970 | 0.55 | 0.07 | 0.54 |
| 975 | 0.29 | 0.08 | 0.73 |
| 980 | 0.17 | 0.09 | 0.95 |
| 985 | 0.11 | 0.10 | 1.13 |
| 990 | 0.08 | 0.13 | 1.20 |
| 995 | 0.07 | 0.16 | 1.16 |
| 1000 | 0.06 | 0.22 | 1.09 |
| 1005 | 0.05 | 0.30 | 1.05 |
| 1010 | 0.05 | 0.42 | 1.07 |
| 1015 | 0.05 | 0.59 | 1.12 |
| 1020 | 0.05 | 0.79 | 1.13 |
| 1025 | 0.06 | 0.93 | 1.12 |
| 1030 | 0.06 | 0.98 | 1.17 |
| 1035 | 0.07 | 1.00 | 1.28 |
| 1040 | 0.09 | 1.00 | 1.49 |
| 1045 | 0.11 | 0.96 | 1.81 |
| 1050 | 0.15 | 0.87 | 2.32 |

Table 60 shows the values of Wt50v, |dWt50v3|, |dWt50v4|, T3540, T4563, T6065, T70105, T45, T50, T63, T85 and T94 of the filter lens element of the optical lens assembly of Example 6 at the incidence angles of 0 degrees, 30 degrees and 40 degrees.

TABLE 6C

| | 0 degrees | 30 degrees | 40 degrees |
|---|---|---|---|
| Wt50v (nm) | 664.19 | 651.78 | 634.74 |
| \|dWt50v3\| (nm) | 12.41 | | |
| \|dWt50v4\| (nm) | 29.45 | | |
| T3540 (%) | 0.04 | 1.08 | 4.78 |
| T4563 (%) | 96.02 | 94.99 | 91.59 |
| T6065 (%) | 94.38 | 83.24 | 66.27 |
| T70105 (%) | 0.49 | 0.41 | 0.73 |
| T45 (%) | 92.48 | 92.39 | 91.05 |
| T50 (%) | 97.42 | 95.69 | 93.51 |
| T63 (%) | 95.98 | 84.23 | 66.86 |
| T85 (%) | 0.16 | 0.30 | 0.54 |
| T94 (%) | 0.08 | 0.17 | 0.14 |

### Example 7

The optical lens assembly of Example 7 includes at least four optical lens elements, and at least one of the at least four optical lens elements is a filter lens element. The filter lens element includes a near-infrared light filter coating membrane, the near-infrared light filter coating membrane includes at least one low refractive index layer and at least one high refractive index layer, and the near-infrared light filter coating membrane is formed by alternately stacking the at least one high refractive index layer and the at least one low refractive index layer. Further, at least one of the at least four optical lens elements can include a blue glass material, the filter lens element can be made of a glass material, and the filter lens element can have at least one aspheric surface.

Table 7A shows the values of tLs, otLs, itLs, tTk, LtTk, HtTk, LtTk/HtTk, otTk, itTk, otTk/itTk, NL, NH and NH−NL of the near-infrared light filter coating membrane of the filter lens element of Example 7, wherein the near-infrared light filter coating membrane of Example 7 is disposed on the object-side surface and the image-side surface of the filter lens element, a total number of layers of the multi-layer coating membrane of the filter lens element is tLs=78, a total number of layers of the multi-layer coating membrane on the object-side surface of the filter lens element is otLs=38, and a total number of layers of the multi-layer coating membrane on the image-side surface of the filter lens element is itLs=40.

TABLE 7A

| | | | |
|---|---|---|---|
| tLs | 78 | otTk (nm) | 4457 |
| otLs | 38 | itTk (nm) | 3136 |
| itLs | 40 | otTk/itTk | 1.42 |
| tTk (nm) | 7593 | NL | 1.46 |
| LtTk (nm) | 4558 | NH | 2.33 |
| HtTk (nm) | 3034 | NH - NL | 0.87 |
| LtTk/HtTk | 1.50 | | |

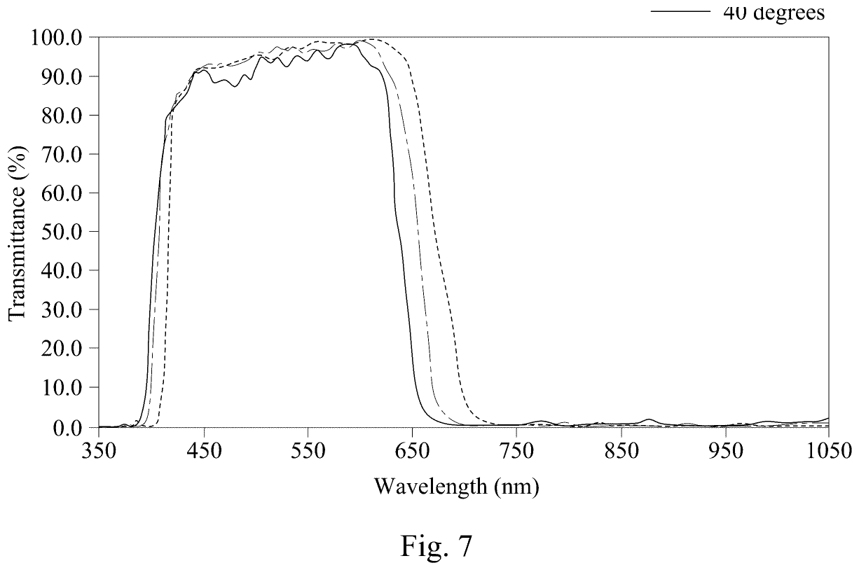

FIG. 7 is a relationship diagram between transmittances and wavelengths of a filter lens element of an optical lens assembly according to Example 7, and Table 7B shows the values of transmittance in a wavelength range of 350 nm-1050 nm of the filter lens element of Example 7, wherein the incidence angles of the light entering the filter lens element of Example 7 are respectively 0 degrees, 30 degrees and 40 degrees.

TABLE 7B

| Wavelength (nm) | 0 degrees | 30 degrees | 40 degrees |
|---|---|---|---|
| 350 | 0.05 | 0.01 | 0.01 |
| 355 | 0.02 | 0.00 | 0.01 |
| 360 | 0.00 | 0.00 | 0.01 |
| 365 | 0.01 | 0.00 | 0.02 |
| 370 | 0.00 | 0.01 | 0.27 |
| 375 | 0.00 | 0.30 | 0.69 |
| 380 | 0.02 | 0.32 | 0.55 |
| 385 | 1.65 | 0.23 | 0.62 |
| 390 | 0.14 | 0.33 | 2.55 |
| 395 | 0.11 | 1.51 | 9.84 |
| 400 | 0.18 | 8.31 | 35.96 |
| 405 | 0.89 | 38.03 | 54.96 |
| 410 | 7.36 | 70.90 | 69.75 |
| 415 | 28.70 | 74.23 | 79.50 |
| 420 | 80.61 | 81.65 | 81.18 |
| 425 | 84.58 | 85.33 | 83.17 |
| 430 | 85.33 | 86.14 | 84.39 |
| 435 | 88.37 | 88.31 | 86.21 |
| 440 | 90.39 | 90.66 | 90.51 |
| 445 | 92.21 | 91.68 | 91.06 |
| 450 | 92.06 | 92.75 | 91.54 |
| 455 | 91.77 | 93.05 | 90.66 |
| 460 | 92.96 | 92.96 | 88.46 |
| 465 | 92.85 | 93.17 | 88.70 |
| 470 | 92.45 | 92.75 | 89.03 |
| 475 | 93.27 | 92.64 | 88.36 |
| 480 | 93.59 | 92.99 | 87.38 |
| 485 | 93.88 | 93.49 | 88.80 |
| 490 | 94.49 | 94.10 | 90.22 |
| 495 | 95.05 | 94.70 | 89.27 |
| 500 | 95.53 | 95.82 | 91.76 |
| 505 | 95.64 | 96.12 | 95.27 |
| 510 | 95.40 | 95.77 | 94.24 |
| 515 | 94.53 | 96.57 | 93.41 |
| 520 | 94.36 | 97.35 | 94.81 |
| 525 | 95.90 | 96.79 | 93.88 |
| 530 | 97.40 | 96.76 | 92.39 |
| 535 | 97.44 | 97.50 | 93.88 |
| 540 | 97.27 | 97.07 | 95.30 |
| 545 | 97.79 | 96.07 | 94.25 |
| 550 | 98.39 | 96.27 | 94.01 |
| 555 | 98.75 | 96.85 | 95.86 |
| 560 | 98.96 | 96.53 | 96.60 |
| 565 | 98.83 | 96.32 | 95.15 |
| 570 | 98.50 | 97.31 | 94.51 |
| 575 | 98.47 | 98.24 | 96.00 |
| 580 | 98.53 | 97.82 | 97.64 |
| 585 | 98.20 | 97.12 | 98.13 |
| 590 | 97.89 | 97.66 | 98.31 |
| 595 | 98.29 | 98.77 | 98.13 |
| 600 | 99.19 | 99.13 | 96.56 |
| 605 | 99.53 | 98.78 | 94.26 |
| 610 | 99.21 | 98.43 | 93.00 |
| 615 | 98.91 | 97.24 | 92.28 |
| 620 | 98.90 | 94.63 | 90.69 |
| 625 | 98.42 | 91.71 | 87.07 |
| 630 | 97.32 | 89.51 | 73.14 |
| 635 | 96.44 | 86.39 | 54.38 |
| 640 | 95.71 | 80.28 | 45.71 |
| 645 | 93.77 | 72.78 | 32.99 |
| 650 | 89.85 | 64.84 | 17.52 |
| 655 | 84.33 | 51.88 | 8.79 |
| 660 | 76.80 | 36.59 | 4.85 |
| 665 | 66.29 | 21.48 | 2.97 |
| 670 | 54.61 | 10.99 | 1.95 |
| 675 | 45.25 | 5.84 | 1.34 |
| 680 | 39.17 | 3.45 | 0.96 |
| 685 | 33.32 | 2.22 | 0.71 |
| 690 | 24.12 | 1.51 | 0.56 |
| 695 | 14.26 | 1.06 | 0.47 |
| 700 | 7.91 | 0.76 | 0.42 |
| 705 | 4.63 | 0.56 | 0.41 |
| 710 | 2.95 | 0.44 | 0.43 |
| 715 | 2.02 | 0.37 | 0.46 |
| 720 | 1.45 | 0.33 | 0.49 |
| 725 | 1.06 | 0.32 | 0.50 |
| 730 | 0.79 | 0.33 | 0.48 |
| 735 | 0.60 | 0.36 | 0.44 |
| 740 | 0.47 | 0.38 | 0.41 |
| 745 | 0.40 | 0.38 | 0.41 |
| 750 | 0.36 | 0.36 | 0.44 |
| 755 | 0.35 | 0.33 | 0.53 |
| 760 | 0.36 | 0.30 | 0.72 |
| 765 | 0.40 | 0.29 | 0.98 |
| 770 | 0.43 | 0.30 | 1.32 |
| 775 | 0.45 | 0.36 | 1.54 |
| 780 | 0.42 | 0.47 | 1.30 |
| 785 | 0.37 | 0.70 | 0.93 |
| 790 | 0.31 | 1.00 | 0.69 |
| 795 | 0.28 | 1.15 | 0.56 |
| 800 | 0.27 | 1.02 | 0.51 |
| 805 | 0.28 | 0.70 | 0.50 |
| 810 | 0.32 | 0.48 | 0.53 |
| 815 | 0.42 | 0.36 | 0.60 |
| 820 | 0.63 | 0.30 | 0.68 |
| 825 | 0.96 | 0.28 | 0.74 |
| 830 | 1.14 | 0.28 | 0.74 |
| 835 | 0.83 | 0.30 | 0.69 |
| 840 | 0.51 | 0.33 | 0.62 |
| 845 | 0.34 | 0.34 | 0.57 |
| 850 | 0.25 | 0.34 | 0.56 |
| 855 | 0.21 | 0.30 | 0.60 |
| 860 | 0.20 | 0.25 | 0.70 |
| 865 | 0.20 | 0.21 | 0.92 |
| 870 | 0.21 | 0.18 | 1.35 |
| 875 | 0.23 | 0.16 | 1.98 |
| 880 | 0.23 | 0.16 | 2.05 |
| 885 | 0.21 | 0.17 | 1.31 |
| 890 | 0.17 | 0.19 | 0.74 |
| 895 | 0.13 | 0.24 | 0.45 |
| 900 | 0.10 | 0.35 | 0.31 |
| 905 | 0.08 | 0.57 | 0.27 |
| 910 | 0.07 | 0.97 | 0.31 |
| 915 | 0.06 | 1.09 | 0.22 |
| 920 | 0.06 | 0.68 | 0.16 |
| 925 | 0.06 | 0.42 | 0.14 |
| 930 | 0.06 | 0.40 | 0.13 |
| 935 | 0.07 | 0.33 | 0.14 |
| 940 | 0.08 | 0.19 | 0.14 |
| 945 | 0.11 | 0.12 | 0.16 |
| 950 | 0.17 | 0.10 | 0.19 |
| 955 | 0.30 | 0.08 | 0.23 |
| 960 | 0.61 | 0.08 | 0.30 |
| 965 | 0.96 | 0.07 | 0.39 |
| 970 | 0.65 | 0.08 | 0.53 |
| 975 | 0.33 | 0.08 | 0.72 |
| 980 | 0.19 | 0.09 | 0.94 |
| 985 | 0.12 | 0.11 | 1.12 |
| 990 | 0.09 | 0.13 | 1.20 |
| 995 | 0.07 | 0.16 | 1.17 |
| 1000 | 0.06 | 0.22 | 1.10 |
| 1005 | 0.05 | 0.30 | 1.06 |
| 1010 | 0.05 | 0.42 | 1.08 |
| 1015 | 0.05 | 0.59 | 1.12 |
| 1020 | 0.05 | 0.78 | 1.12 |
| 1025 | 0.06 | 0.93 | 1.11 |
| 1030 | 0.06 | 0.99 | 1.14 |
| 1035 | 0.07 | 1.01 | 1.24 |
| 1040 | 0.09 | 1.02 | 1.43 |
| 1045 | 0.11 | 0.96 | 1.72 |
| 1050 | 0.15 | 0.87 | 2.17 |

Table 70 shows the values of Wt50v, |dWt50v3|, |dWt50v4|, T3540, T4563, T6065, T70105, T45, T50, T63, T85 and T94 of the filter lens element of the optical lens assembly of Example 7 at the incidence angles of 0 degrees, 30 degrees and 40 degrees.

TABLE 7C

| | 0 degrees | 30 degrees | 40 degrees |
|---|---|---|---|
| Wt50v (nm) | 672.46 | 655.62 | 637.53 |
| \|dWt50v3\| (nm) | 16.85 | | |
| \|dWt50v4\| (nm) | 34.94 | | |
| T3540 (%) | 0.20 | 1.00 | 4.59 |
| T4563 (%) | 96.48 | 95.70 | 92.51 |
| T6065 (%) | 97.02 | 88.52 | 70.69 |
| T70105 (%) | 0.55 | 0.43 | 0.75 |
| T45 (%) | 92.06 | 92.75 | 91.54 |
| T50 (%) | 98.39 | 96.27 | 94.01 |
| T63 (%) | 97.32 | 89.51 | 73.14 |
| T85 (%) | 0.25 | 0.34 | 0.56 |
| T94 (%) | 0.08 | 0.19 | 0.14 |

The optical lens assembly of Example 8 includes at least four optical lens elements, and at least one of the at least four optical lens elements is a filter lens element. The filter lens element includes a near-infrared light filter coating membrane, the near-infrared light filter coating membrane includes at least one low refractive index layer and at least one high refractive index layer, and the near-infrared light filter coating membrane is formed by alternately stacking the at least one high refractive index layer and the at least one low refractive index layer. Further, at least one of the at least four optical lens elements can include a blue glass material, the filter lens element can be made of a glass material, and the filter lens element can have at least one aspheric surface.

Table 8A shows the values of tLs, otLs, itLs, tTk, LtTk, HtTk, LtTk/HtTk, otTk, itTk, otTk/itTk, NL, NH and NH−NL of the near-infrared light filter coating membrane of the filter lens element of Example 8, wherein the near-infrared light filter coating membrane of Example 8 is disposed on the object-side surface and the image-side surface of the filter lens element, a total number of layers of the multi-layer coating membrane of the filter lens element is tLs=76, a total number of layers of the multi-layer coating membrane on the object-side surface of the filter lens element is otLs=36, and a total number of layers of the multi-layer coating membrane on the image-side surface of the filter lens element is itLs=40.

TABLE 8A

| | | | |
|---|---|---|---|
| tLs | 76 | otTk (nm) | 4448 |
| otLs | 36 | itTk (nm) | 3188 |
| itLs | 40 | otTk/itTk | 1.40 |
| tTk (nm) | 7636 | NL | 1.46 |
| LtTk (nm) | 4598 | NH | 2.33 |
| HtTk (nm) | 3038 | NH - NL | 0.87 |
| LtTk/HtTk | 1.51 | | |

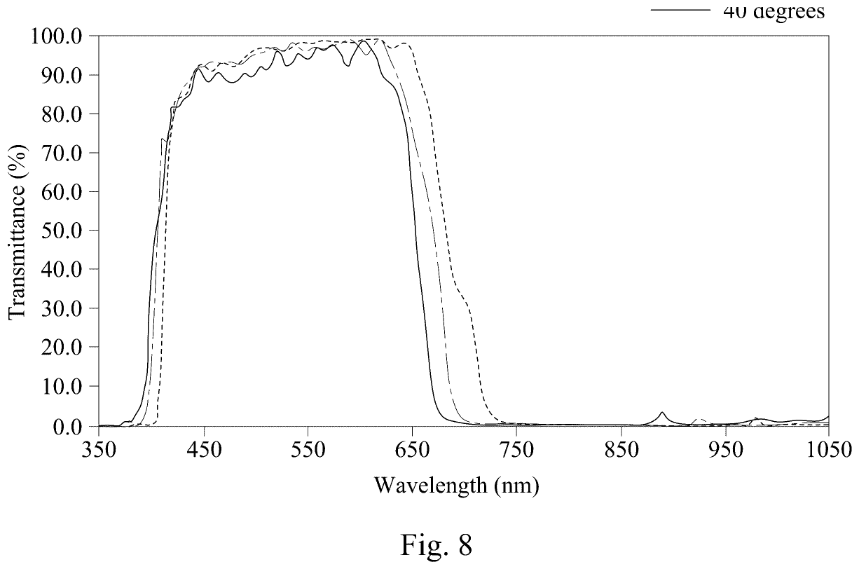

FIG. 8 is a relationship diagram between transmittances and wavelengths of a filter lens element of an optical lens assembly according to Example 8, and Table 8B shows the values of transmittance in a wavelength range of 350 nm-1050 nm of the filter lens element of Example 8, wherein the incidence angles of the light entering the filter lens element of Example 8 are respectively 0 degrees, 30 degrees and 40 degrees.

TABLE 8B

| Wavelength (nm) | 0 degrees | 30 degrees | 40 degrees |
|---|---|---|---|
| 350 | 0.03 | 0.01 | 0.01 |
| 355 | 0.01 | 0.01 | 0.01 |
| 360 | 0.01 | 0.00 | 0.01 |
| 365 | 0.01 | 0.01 | 0.01 |
| 370 | 0.03 | 0.01 | 0.28 |
| 375 | 0.01 | 0.10 | 1.12 |
| 380 | 0.01 | 1.34 | 1.14 |
| 385 | 0.25 | 0.41 | 2.61 |
| 390 | 0.82 | 0.80 | 5.17 |
| 395 | 0.23 | 4.22 | 12.08 |
| 400 | 0.33 | 14.60 | 37.84 |
| 405 | 1.54 | 40.93 | 49.37 |
| 410 | 21.23 | 73.53 | 58.46 |
| 415 | 61.67 | 72.91 | 70.06 |
| 420 | 81.62 | 78.66 | 81.54 |
| 425 | 83.94 | 83.21 | 81.72 |
| 430 | 84.46 | 86.56 | 83.28 |
| 435 | 85.37 | 87.68 | 84.59 |
| 440 | 90.68 | 89.85 | 87.92 |
| 445 | 91.93 | 91.75 | 91.44 |
| 450 | 92.73 | 91.79 | 90.53 |
| 455 | 90.99 | 92.68 | 87.97 |
| 460 | 91.44 | 93.09 | 89.02 |
| 465 | 93.08 | 92.48 | 90.50 |
| 470 | 92.59 | 92.75 | 88.91 |
| 475 | 92.58 | 93.12 | 88.16 |
| 480 | 92.58 | 93.07 | 88.29 |
| 485 | 93.20 | 92.91 | 89.19 |
| 490 | 94.01 | 93.59 | 90.25 |
| 495 | 94.96 | 94.50 | 89.52 |
| 500 | 96.20 | 95.48 | 90.47 |
| 505 | 96.59 | 96.18 | 92.05 |
| 510 | 96.91 | 96.18 | 91.23 |
| 515 | 96.61 | 96.42 | 92.34 |
| 520 | 95.72 | 96.69 | 96.02 |
| 525 | 95.82 | 96.08 | 95.36 |
| 530 | 96.45 | 96.41 | 92.25 |
| 535 | 96.86 | 97.83 | 92.98 |
| 540 | 97.71 | 97.58 | 95.19 |
| 545 | 98.43 | 96.14 | 94.73 |
| 550 | 98.21 | 96.20 | 94.02 |
| 555 | 97.98 | 97.11 | 95.35 |
| 560 | 98.35 | 96.86 | 96.52 |
| 565 | 98.54 | 96.33 | 96.44 |
| 570 | 98.37 | 96.93 | 96.96 |
| 575 | 98.40 | 97.74 | 97.64 |
| 580 | 98.51 | 97.74 | 95.95 |
| 585 | 98.31 | 97.90 | 92.89 |
| 590 | 98.18 | 98.70 | 92.19 |
| 595 | 98.42 | 98.47 | 94.75 |
| 600 | 98.68 | 96.58 | 97.93 |
| 605 | 98.63 | 95.16 | 98.62 |
| 610 | 98.80 | 96.24 | 96.87 |
| 615 | 99.25 | 98.56 | 94.10 |
| 620 | 99.18 | 99.13 | 91.28 |
| 625 | 97.88 | 96.72 | 89.00 |
| 630 | 96.44 | 93.18 | 87.57 |
| 635 | 96.55 | 90.11 | 86.07 |
| 640 | 97.96 | 87.03 | 82.68 |
| 645 | 98.33 | 82.93 | 75.72 |
| 650 | 95.97 | 77.68 | 61.55 |
| 655 | 91.92 | 71.64 | 46.17 |
| 660 | 87.80 | 65.22 | 34.44 |
| 665 | 83.05 | 59.27 | 20.77 |
| 670 | 75.71 | 53.05 | 10.10 |
| 675 | 65.65 | 42.51 | 4.85 |
| 680 | 55.30 | 28.74 | 2.58 |
| 685 | 46.42 | 15.75 | 1.54 |
| 690 | 39.78 | 7.50 | 1.02 |
| 695 | 35.49 | 3.67 | 0.73 |
| 700 | 33.21 | 1.98 | 0.57 |
| 705 | 30.95 | 1.20 | 0.46 |
| 710 | 24.11 | 0.80 | 0.38 |
| 715 | 13.80 | 0.58 | 0.32 |
| 720 | 6.82 | 0.45 | 0.28 |
| 725 | 3.47 | 0.36 | 0.25 |
| 730 | 1.95 | 0.30 | 0.24 |
| 735 | 1.22 | 0.25 | 0.24 |
| 740 | 0.84 | 0.21 | 0.26 |
| 745 | 0.63 | 0.19 | 0.31 |
| 750 | 0.50 | 0.18 | 0.40 |
| 755 | 0.42 | 0.18 | 0.50 |
| 760 | 0.35 | 0.19 | 0.55 |
| 765 | 0.30 | 0.22 | 0.46 |
| 770 | 0.25 | 0.28 | 0.32 |
| 775 | 0.22 | 0.36 | 0.22 |
| 780 | 0.19 | 0.40 | 0.16 |
| 785 | 0.19 | 0.34 | 0.13 |
| 790 | 0.19 | 0.23 | 0.11 |
| 795 | 0.21 | 0.15 | 0.11 |
| 800 | 0.26 | 0.11 | 0.11 |
| 805 | 0.32 | 0.08 | 0.12 |
| 810 | 0.39 | 0.07 | 0.15 |
| 815 | 0.37 | 0.06 | 0.19 |
| 820 | 0.26 | 0.06 | 0.25 |
| 825 | 0.16 | 0.06 | 0.33 |
| 830 | 0.10 | 0.07 | 0.42 |
| 835 | 0.07 | 0.09 | 0.45 |
| 840 | 0.05 | 0.11 | 0.42 |
| 845 | 0.05 | 0.15 | 0.36 |
| 850 | 0.04 | 0.18 | 0.32 |
| 855 | 0.04 | 0.20 | 0.30 |
| 860 | 0.04 | 0.18 | 0.31 |
| 865 | 0.05 | 0.15 | 0.35 |
| 870 | 0.06 | 0.12 | 0.44 |
| 875 | 0.07 | 0.10 | 0.64 |
| 880 | 0.10 | 0.09 | 1.10 |
| 885 | 0.13 | 0.08 | 2.23 |
| 890 | 0.13 | 0.08 | 3.63 |
| 895 | 0.11 | 0.09 | 2.33 |
| 900 | 0.08 | 0.11 | 1.13 |
| 905 | 0.06 | 0.15 | 0.64 |
| 910 | 0.04 | 0.23 | 0.43 |
| 915 | 0.04 | 0.42 | 0.34 |
| 920 | 0.03 | 0.94 | 0.36 |
| 925 | 0.03 | 2.03 | 0.59 |
| 930 | 0.03 | 1.46 | 0.32 |
| 935 | 0.03 | 0.68 | 0.26 |
| 940 | 0.03 | 0.47 | 0.26 |
| 945 | 0.04 | 0.71 | 0.28 |
| 950 | 0.05 | 0.46 | 0.33 |
| 955 | 0.07 | 0.24 | 0.40 |
| 960 | 0.11 | 0.17 | 0.53 |
| 965 | 0.19 | 0.15 | 0.73 |
| 970 | 0.41 | 0.14 | 1.03 |
| 975 | 1.15 | 0.15 | 1.43 |
| 980 | 1.97 | 0.16 | 1.78 |
| 985 | 0.86 | 0.18 | 1.87 |
| 990 | 0.39 | 0.23 | 1.69 |
| 995 | 0.23 | 0.29 | 1.46 |
| 1000 | 0.16 | 0.40 | 1.31 |
| 1005 | 0.13 | 0.59 | 1.30 |
| 1010 | 0.11 | 0.87 | 1.43 |
| 1015 | 0.10 | 1.25 | 1.42 |
| 1020 | 0.10 | 1.53 | 1.26 |
| 1025 | 0.10 | 1.56 | 1.18 |
| 1030 | 0.11 | 1.50 | 1.20 |
| 1035 | 0.13 | 1.52 | 1.31 |
| 1040 | 0.16 | 1.44 | 1.50 |
| 1045 | 0.20 | 1.19 | 1.81 |
| 1050 | 0.27 | 0.97 | 2.27 |

Table 8C shows the values of Wt50v, |dWt50v3|, |dWt50v3|, |dWt50v4|, T3540, T4563, T6065, T70105, T45, T50, T63, T85 and T94 of the filter lens element of the optical lens assembly of Example 8 at the incidence angles of 0 degrees, 30 degrees and 40 degrees.

TABLE 8C

| | 0 degrees | 30 degrees | 40 degrees |
|---|---|---|---|
| Wt50v (nm) | 682.98 | 671.45 | 653.76 |
| \|dWt50v3\| (nm) | 11.53 | | |
| \|dWt50v4\| (nm) | 29.23 | | |
| T3540 (%) | 0.16 | 1.96 | 5.48 |
| T4563 (%) | 96.42 | 95.80 | 92.79 |
| T6065 (%) | 97.97 | 92.12 | 87.40 |
| T70105 (%) | 1.83 | 0.47 | 0.74 |
| T45 (%) | 92.73 | 91.79 | 90.53 |
| T50 (%) | 98.21 | 96.20 | 94.02 |
| T63 (%) | 96.44 | 93.18 | 87.57 |
| T85 (%) | 0.04 | 0.18 | 0.32 |
| T94 (%) | 0.03 | 0.47 | 0.26 |

### Example 9

The optical lens assembly of Example 9 includes at least four optical lens elements, and at least one of the at least four optical lens elements is a filter lens element. The filter lens element includes a near-infrared light filter coating membrane, the near-infrared light filter coating membrane includes at least one low refractive index layer and at least one high refractive index layer, and the near-infrared light filter coating membrane is formed by alternately stacking the at least one high refractive index layer and the at least one low refractive index layer. Further, at least one of the at least four optical lens elements can include a blue glass material, the filter lens element can be made of a glass material, and the filter lens element can have at least one aspheric surface.

Table 9A shows the values of tLs, otLs, itLs, tTk, LtTk, HtTk, LtTk/HtTk, otTk, itTk, otTk/itTk, NL, NH and NH−NL of the near-infrared light filter coating membrane of the filter lens element of Example 9, wherein the near-infrared light filter coating membrane of Example 9 is disposed on the object-side surface and the image-side surface of the filter lens element, a total number of layers of the multi-layer coating membrane of the filter lens element is tLs=76, a total number of layers of the multi-layer coating membrane on the object-side surface of the filter lens element is otLs=36, and a total number of layers of the multi-layer coating membrane on the image-side surface of the filter lens element is itLs=40.

TABLE 9A

| | | | |
|---|---|---|---|
| tLs | 76 | otTk (nm) | 4463 |
| otLs | 36 | itTk (nm) | 3213 |
| itLs | 40 | otTk/itTk | 1.39 |
| tTk (nm) | 7676 | NL | 1.46 |
| LtTk (nm) | 4619 | NH | 2.33 |
| HtTk (nm) | 3056 | NH - NL | 0.87 |
| LtTk/HtTk | 1.51 | | |

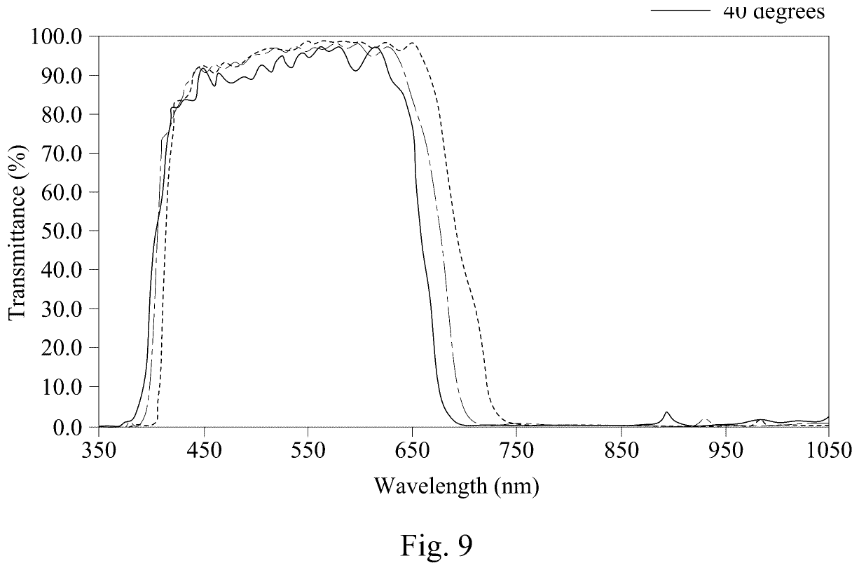

FIG. 9 is a relationship diagram between transmittances and wavelengths of a filter lens element of an optical lens assembly according to Example 9, and Table 9B shows the values of transmittance in a wavelength range of 350 nm-1050 nm of the filter lens element of Example 9, wherein the incidence angles of the light entering the filter lens element of Example 9 are respectively 0 degrees, 30 degrees and 40 degrees.

TABLE 9B

| Wavelength (nm) | 0 degrees | 30 degrees | 40 degrees |
|---|---|---|---|
| 350 | 0.11 | 0.01 | 0.02 |
| 355 | 0.01 | 0.03 | 0.01 |
| 360 | 0.00 | 0.01 | 0.02 |
| 365 | 0.07 | 0.02 | 0.02 |
| 370 | 0.03 | 0.02 | 0.25 |
| 375 | 0.05 | 0.09 | 1.39 |
| 380 | 0.03 | 1.52 | 1.80 |
| 385 | 0.20 | 0.95 | 3.60 |
| 390 | 1.49 | 1.19 | 7.87 |
| 395 | 0.55 | 4.55 | 15.39 |
| 400 | 0.55 | 16.81 | 40.75 |
| 405 | 1.61 | 42.19 | 53.89 |
| 410 | 15.83 | 74.28 | 57.88 |
| 415 | 57.25 | 74.85 | 67.41 |
| 420 | 80.87 | 78.82 | 79.24 |
| 425 | 82.66 | 82.72 | 83.68 |
| 430 | 84.42 | 85.98 | 83.85 |
| 435 | 84.25 | 88.21 | 83.58 |
| 440 | 89.70 | 90.14 | 83.67 |
| 445 | 91.22 | 91.58 | 88.80 |
| 450 | 92.56 | 90.78 | 92.16 |
| 455 | 91.68 | 91.20 | 88.87 |
| 460 | 90.59 | 92.85 | 87.30 |
| 465 | 92.54 | 92.45 | 90.06 |
| 470 | 93.22 | 92.17 | 90.00 |
| 475 | 93.01 | 92.67 | 88.23 |
| 480 | 92.61 | 93.11 | 88.27 |
| 485 | 92.83 | 92.96 | 89.03 |
| 490 | 93.81 | 93.44 | 89.63 |
| 495 | 94.79 | 94.49 | 89.02 |
| 500 | 96.04 | 95.25 | 90.14 |
| 505 | 96.55 | 95.76 | 92.63 |
| 510 | 96.85 | 96.10 | 92.06 |
| 515 | 96.93 | 96.53 | 91.28 |
| 520 | 96.25 | 96.94 | 94.25 |
| 525 | 96.03 | 96.36 | 95.34 |
| 530 | 96.55 | 96.06 | 92.57 |
| 535 | 96.84 | 97.12 | 92.38 |
| 540 | 97.33 | 97.41 | 95.17 |
| 545 | 98.28 | 96.24 | 95.78 |
| 550 | 98.58 | 96.10 | 94.65 |
| 555 | 98.23 | 97.36 | 95.52 |
| 560 | 98.28 | 97.71 | 97.35 |
| 565 | 98.63 | 97.00 | 97.16 |
| 570 | 98.71 | 97.22 | 96.26 |
| 575 | 98.72 | 98.22 | 96.97 |
| 580 | 98.87 | 98.08 | 97.63 |
| 585 | 98.80 | 97.06 | 95.74 |
| 590 | 98.62 | 97.16 | 92.71 |
| 595 | 98.69 | 98.23 | 91.43 |
| 600 | 98.78 | 98.17 | 92.48 |
| 605 | 98.15 | 96.30 | 94.47 |
| 610 | 97.27 | 94.80 | 96.44 |
| 615 | 97.27 | 95.16 | 97.61 |
| 620 | 98.34 | 96.72 | 96.68 |
| 625 | 98.84 | 97.60 | 93.07 |
| 630 | 97.72 | 97.16 | 89.18 |
| 635 | 96.36 | 95.80 | 87.17 |
| 640 | 96.48 | 93.25 | 86.24 |
| 645 | 97.85 | 89.27 | 83.78 |
| 650 | 98.50 | 84.84 | 76.49 |
| 655 | 97.22 | 80.85 | 60.33 |
| 660 | 94.79 | 76.39 | 46.51 |
| 665 | 92.03 | 70.23 | 37.84 |
| 670 | 88.20 | 63.22 | 24.43 |
| 675 | 82.12 | 55.53 | 11.98 |
| 680 | 74.15 | 44.30 | 5.77 |
| 685 | 65.12 | 31.21 | 3.08 |
| 690 | 55.73 | 17.86 | 1.86 |
| 695 | 46.97 | 8.63 | 1.24 |
| 700 | 40.18 | 4.26 | 0.89 |
| 705 | 35.94 | 2.35 | 0.67 |
| 710 | 32.38 | 1.46 | 0.52 |
| 715 | 24.99 | 0.99 | 0.41 |
| 720 | 14.69 | 0.72 | 0.33 |
| 725 | 7.48 | 0.55 | 0.28 |
| 730 | 3.93 | 0.42 | 0.25 |
| 735 | 2.28 | 0.33 | 0.23 |
| 740 | 1.47 | 0.27 | 0.24 |
| 745 | 1.04 | 0.22 | 0.26 |
| 750 | 0.79 | 0.19 | 0.31 |
| 755 | 0.62 | 0.17 | 0.39 |
| 760 | 0.50 | 0.17 | 0.46 |
| 765 | 0.39 | 0.19 | 0.44 |
| 770 | 0.31 | 0.23 | 0.34 |
| 775 | 0.25 | 0.28 | 0.24 |
| 780 | 0.21 | 0.33 | 0.17 |
| 785 | 0.19 | 0.33 | 0.13 |
| 790 | 0.18 | 0.25 | 0.11 |
| 795 | 0.19 | 0.17 | 0.10 |
| 800 | 0.22 | 0.11 | 0.10 |
| 805 | 0.26 | 0.08 | 0.10 |
| 810 | 0.32 | 0.07 | 0.12 |
| 815 | 0.34 | 0.06 | 0.14 |
| 820 | 0.28 | 0.05 | 0.18 |
| 825 | 0.18 | 0.05 | 0.23 |
| 830 | 0.11 | 0.06 | 0.30 |
| 835 | 0.08 | 0.07 | 0.36 |
| 840 | 0.06 | 0.08 | 0.37 |
| 845 | 0.04 | 0.11 | 0.34 |
| 850 | 0.04 | 0.13 | 0.30 |
| 855 | 0.04 | 0.16 | 0.27 |
| 860 | 0.04 | 0.16 | 0.26 |
| 865 | 0.04 | 0.15 | 0.28 |
| 870 | 0.04 | 0.12 | 0.33 |
| 875 | 0.05 | 0.10 | 0.42 |
| 880 | 0.07 | 0.08 | 0.62 |
| 885 | 0.09 | 0.08 | 1.10 |
| 890 | 0.11 | 0.07 | 2.30 |
| 895 | 0.10 | 0.08 | 3.83 |
| 900 | 0.08 | 0.09 | 2.40 |
| 905 | 0.06 | 0.11 | 1.15 |
| 910 | 0.05 | 0.15 | 0.65 |
| 915 | 0.04 | 0.22 | 0.44 |
| 920 | 0.03 | 0.41 | 0.35 |
| 925 | 0.03 | 0.92 | 0.37 |
| 930 | 0.03 | 2.12 | 0.63 |
| 935 | 0.03 | 1.58 | 0.35 |
| 940 | 0.03 | 0.72 | 0.28 |
| 945 | 0.03 | 0.48 | 0.28 |
| 950 | 0.04 | 0.71 | 0.31 |
| 955 | 0.05 | 0.52 | 0.36 |
| 960 | 0.07 | 0.26 | 0.45 |
| 965 | 0.10 | 0.19 | 0.59 |
| 970 | 0.18 | 0.16 | 0.81 |
| 975 | 0.38 | 0.16 | 1.13 |
| 980 | 1.07 | 0.16 | 1.50 |
| 985 | 2.17 | 0.18 | 1.76 |
| 990 | 1.00 | 0.20 | 1.76 |
| 995 | 0.44 | 0.25 | 1.59 |
| 1000 | 0.26 | 0.33 | 1.40 |
| 1005 | 0.18 | 0.45 | 1.30 |
| 1010 | 0.14 | 0.65 | 1.33 |
| 1015 | 0.12 | 0.95 | 1.46 |
| 1020 | 0.11 | 1.28 | 1.41 |
| 1025 | 0.11 | 1.49 | 1.28 |
| 1030 | 0.11 | 1.49 | 1.23 |
| 1035 | 0.13 | 1.47 | 1.29 |
| 1040 | 0.15 | 1.50 | 1.43 |
| 1045 | 0.18 | 1.39 | 1.68 |
| 1050 | 0.23 | 1.15 | 2.06 |

Table 9C shows the values of Wt50v, |dWt50v3|, |dWt50v4|, T3540, T4563, T6065, T70105, T45, T50, T63, T85 and T94 of the filter lens element of the optical lens assembly of Example 9 at the incidence angles of 0 degrees, 30 degrees and 40 degrees.

TABLE 9C

| | 0 degrees | 30 degrees | 40 degrees |
|---|---|---|---|
| Wt50v (nm) | 693.27 | 677.46 | 658.74 |
| \|dWt50v3\| (nm) | 15.81 | | |
| \|dWt50v4 (nm) | 34.54 | | |
| T3540 (%) | 0.28 | 2.29 | 6.47 |
| T4563 (%) | 96.43 | 95.67 | 92.96 |
| T6065 (%) | 97.78 | 94.46 | 90.33 |
| T70105 (%) | 2.51 | 0.53 | 0.73 |
| T45 (%) | 92.56 | 90.78 | 92.16 |
| T50 (%) | 98.58 | 96.10 | 94.65 |
| T63 (%) | 97.72 | 97.16 | 89.18 |
| T85 (%) | 0.04 | 0.13 | 0.30 |
| T94 (%) | 0.03 | 0.72 | 0.28 |

The optical lens assembly of Example 10 includes at least four optical lens elements, and at least one of the at least four optical lens elements is a filter lens element. The filter lens element includes a near-infrared light filter coating membrane, the near-infrared light filter coating membrane includes at least one low refractive index layer and at least one high refractive index layer, and the near-infrared light filter coating membrane is formed by alternately stacking the at least one high refractive index layer and the at least one low refractive index layer. Further, at least one of the at least four optical lens elements can include a blue glass material, the filter lens element can be made of a glass material, and the filter lens element can have at least one aspheric surface.

Table 10A shows the values of tLs, otLs, itLs, tTk, LtTk, HtTk, LtTk/HtTk, otTk, itTk, otTk/itTk, NL, NH and NH−NL of the near-infrared light filter coating membrane of the filter lens element of Example 10, wherein the near-infrared light filter coating membrane of Example 10 is disposed on the object-side surface and the image-side surface of the filter lens element, a total number of layers of the multi-layer coating membrane of the filter lens element is tLs=76, a total number of layers of the multi-layer coating membrane on the object-side surface of the filter lens element is otLs=36, and a total number of layers of the multi-layer coating membrane on the image-side surface of the filter lens element is itLs=40.

TABLE 10A

| | | | |
|---|---|---|---|
| tLs | 76 | otTk (nm) | 4510 |
| otLs | 36 | itTk (nm) | 3247 |
| itLs | 40 | otTk/itTk | 1.39 |
| tTk (nm) | 7757 | NL | 1.46 |
| LtTk (nm) | 4677 | NH | 2.33 |
| HtTk (nm) | 3080 | NH - NL | 0.87 |
| LtTk/HtTk | 1.52 | | |

Table shows the details the each layer of the near-infrared light filter coating membrane on the object-side surface of the filter lens element of Example 10, and Table 10C shows the details of each layer of the near-infrared light filter coating membrane on the image-side surface of the filter lens element of Example 10, wherein in Table 10B and Table 10C, “H” represents high refractive index layers, and “L” represents low refractive index layers.

TABLE 10B

| Layer Sequence | Material | Thickness (nm) |
|---|---|---|
| 1 | H | 13 |
| 2 | L | 37 |
| 3 | H | 119 |
| 4 | L | 185 |
| 5 | H | 119 |
| 6 | L | 192 |
| 7 | H | 121 |
| 8 | L | 191 |
| 9 | H | 121 |
| 10 | L | 188 |
| 11 | H | 114 |
| 12 | L | 170 |
| 13 | H | 103 |
| 14 | L | 179 |
| 15 | H | 115 |
| 16 | L | 183 |
| 17 | H | 106 |
| 18 | L | 161 |
| 19 | H | 93 |
| 20 | L | 152 |
| 21 | H | 90 |
| 22 | L | 151 |
| 23 | H | 89 |
| 24 | L | 149 |
| 25 | H | 88 |
| 26 | L | 150 |
| 27 | H | 88 |
| 28 | L | 149 |
| 29 | H | 89 |
| 30 | L | 148 |
| 31 | H | 90 |
| 32 | L | 150 |
| 33 | H | 92 |
| 34 | L | 158 |
| 35 | H | 88 |
| 36 | L | 76 |

TABLE 10C

| Layer Sequence | Material | Thickness (nm) |
|---|---|---|
| 1 | H | 5 |
| 2 | L | 143 |
| 3 | H | 6 |
| 4 | L | 38 |
| 5 | H | 99 |
| 6 | L | 166 |
| 7 | H | 106 |
| 8 | L | 209 |
| 9 | H | 12 |
| 10 | L | 244 |
| 11 | H | 12 |
| 12 | L | 235 |
| 13 | H | 17 |
| 14 | L | 200 |
| 15 | H | 86 |
| 16 | L | 30 |
| 17 | H | 9 |
| 18 | L | 105 |
| 19 | H | 121 |
| 20 | L | 32 |
| 21 | H | 136 |
| 22 | L | 32 |
| 23 | H | 126 |
| 24 | L | 69 |
| 25 | H | 16 |
| 26 | L | 32 |
| 27 | H | 87 |
| 28 | L | 89 |
| 29 | H | 6 |
| 30 | L | 60 |
| 31 | H | 124 |
| 32 | L | 6 |
| 33 | H | 126 |
| 34 | L | 12 |
| 35 | H | 134 |
| 36 | L | 60 |
| 37 | H | 12 |
| 38 | L | 70 |
| 39 | H | 102 |
| 40 | L | 73 |

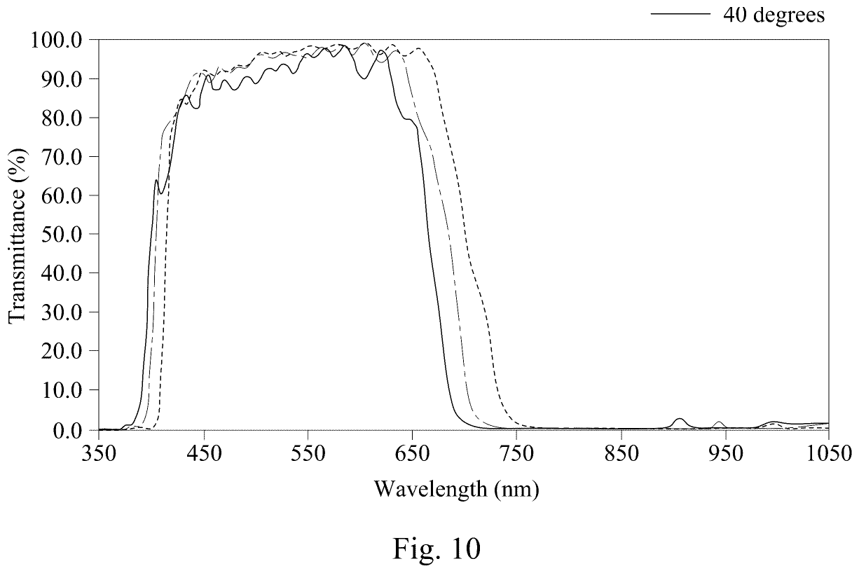

FIG. 10 is a relationship diagram between transmittances and wavelengths of a filter lens element of an optical lens assembly according to Example 10, and Table 1 OD shows the values of transmittance in a wavelength range of 350 nm-1050 nm of the filter lens element of Example 10, wherein the incidence angles of the light entering the filter lens element of Example 10 are respectively 0 degrees, 30 degrees and 40 degrees.

TABLE 10D

| Wavelength (nm) | 0 degrees | 30 degrees | 40 degrees |
|---|---|---|---|
| 350 | 0.09 | 0.00 | 0.03 |
| 355 | 0.02 | 0.01 | 0.01 |
| 360 | 0.00 | 0.01 | 0.01 |
| 365 | 0.03 | 0.01 | 0.02 |
| 370 | 0.02 | 0.02 | 0.16 |
| 375 | 0.04 | 0.06 | 1.01 |
| 380 | 0.04 | 0.90 | 1.32 |
| 385 | 0.11 | 0.77 | 2.77 |
| 390 | 0.75 | 1.11 | 7.72 |
| 395 | 0.55 | 3.58 | 21.68 |
| 400 | 0.48 | 16.99 | 48.01 |
| 405 | 1.62 | 47.51 | 63.93 |
| 410 | 10.62 | 75.31 | 60.26 |
| 415 | 58.73 | 78.16 | 64.10 |
| 420 | 80.04 | 80.29 | 70.79 |
| 425 | 81.88 | 82.34 | 82.09 |
| 430 | 84.89 | 84.11 | 84.07 |
| 435 | 83.16 | 87.81 | 85.98 |
| 440 | 87.22 | 89.79 | 82.59 |
| 445 | 89.40 | 91.48 | 82.35 |
| 450 | 92.30 | 91.16 | 88.70 |
| 455 | 92.16 | 89.01 | 91.37 |
| 460 | 90.43 | 90.73 | 87.33 |
| 465 | 91.46 | 92.99 | 87.37 |
| 470 | 92.86 | 92.00 | 90.05 |
| 475 | 92.63 | 91.63 | 88.70 |
| 480 | 93.37 | 92.80 | 87.27 |
| 485 | 93.62 | 93.13 | 88.54 |
| 490 | 92.92 | 92.82 | 90.39 |
| 495 | 93.92 | 93.71 | 90.39 |
| 500 | 95.89 | 95.42 | 88.77 |
| 505 | 96.63 | 96.20 | 89.80 |
| 510 | 96.40 | 96.00 | 92.63 |
| 515 | 96.33 | 95.49 | 92.55 |
| 520 | 96.42 | 95.86 | 92.04 |
| 525 | 96.22 | 96.69 | 93.88 |
| 530 | 96.30 | 96.52 | 93.74 |
| 535 | 96.61 | 95.96 | 91.47 |
| 540 | 96.79 | 96.11 | 92.36 |
| 545 | 97.56 | 96.04 | 95.73 |
| 550 | 98.65 | 95.52 | 96.62 |
| 555 | 98.43 | 96.06 | 95.41 |
| 560 | 97.21 | 97.53 | 96.03 |
| 565 | 96.96 | 97.92 | 97.65 |
| 570 | 97.95 | 97.27 | 97.13 |
| 575 | 98.74 | 97.52 | 95.78 |
| 580 | 98.69 | 98.57 | 96.63 |
| 585 | 98.30 | 98.36 | 98.57 |
| 590 | 98.03 | 96.86 | 97.84 |
| 595 | 98.05 | 96.43 | 94.07 |
| 600 | 98.64 | 97.94 | 90.83 |
| 605 | 99.21 | 99.15 | 90.30 |
| 610 | 98.63 | 97.87 | 92.15 |
| 615 | 97.02 | 95.24 | 94.85 |
| 620 | 96.29 | 94.09 | 97.08 |
| 625 | 97.30 | 95.07 | 96.31 |
| 630 | 98.69 | 96.78 | 91.26 |
| 635 | 98.46 | 97.51 | 84.97 |
| 640 | 96.83 | 96.31 | 80.89 |
| 645 | 95.85 | 92.66 | 79.62 |
| 650 | 96.62 | 87.04 | 79.37 |
| 655 | 98.04 | 81.30 | 77.35 |
| 660 | 98.03 | 77.12 | 68.72 |
| 665 | 95.83 | 74.18 | 52.64 |
| 670 | 92.05 | 70.47 | 41.59 |
| 675 | 87.27 | 64.94 | 32.40 |
| 680 | 81.71 | 58.78 | 19.95 |
| 685 | 75.60 | 50.90 | 10.31 |
| 690 | 69.22 | 39.51 | 5.42 |
| 695 | 62.10 | 27.20 | 3.14 |
| 700 | 53.84 | 15.55 | 2.00 |
| 705 | 45.62 | 8.02 | 1.37 |
| 710 | 39.26 | 4.33 | 0.99 |
| 715 | 35.07 | 2.57 | 0.74 |
| 720 | 30.95 | 1.69 | 0.57 |
| 725 | 23.31 | 1.18 | 0.45 |
| 730 | 14.04 | 0.86 | 0.37 |
| 735 | 7.67 | 0.64 | 0.32 |
| 740 | 4.35 | 0.49 | 0.29 |
| 745 | 2.69 | 0.38 | 0.29 |
| 750 | 1.82 | 0.30 | 0.31 |
| 755 | 1.32 | 0.25 | 0.35 |
| 760 | 0.99 | 0.23 | 0.41 |
| 765 | 0.76 | 0.22 | 0.46 |
| 770 | 0.59 | 0.24 | 0.43 |
| 775 | 0.45 | 0.27 | 0.33 |
| 780 | 0.36 | 0.31 | 0.23 |
| 785 | 0.29 | 0.35 | 0.16 |
| 790 | 0.25 | 0.32 | 0.13 |
| 795 | 0.24 | 0.25 | 0.10 |
| 800 | 0.24 | 0.17 | 0.09 |
| 805 | 0.26 | 0.11 | 0.09 |
| 810 | 0.30 | 0.08 | 0.09 |
| 815 | 0.34 | 0.07 | 0.10 |
| 820 | 0.35 | 0.06 | 0.12 |
| 825 | 0.27 | 0.05 | 0.14 |
| 830 | 0.18 | 0.05 | 0.18 |
| 835 | 0.12 | 0.05 | 0.21 |
| 840 | 0.08 | 0.06 | 0.23 |
| 845 | 0.06 | 0.07 | 0.23 |
| 850 | 0.05 | 0.08 | 0.20 |
| 855 | 0.04 | 0.10 | 0.18 |
| 860 | 0.04 | 0.11 | 0.16 |
| 865 | 0.03 | 0.10 | 0.15 |
| 870 | 0.04 | 0.09 | 0.16 |
| 875 | 0.04 | 0.08 | 0.17 |
| 880 | 0.05 | 0.06 | 0.20 |
| 885 | 0.06 | 0.05 | 0.26 |
| 890 | 0.07 | 0.05 | 0.39 |
| 895 | 0.07 | 0.05 | 0.66 |
| 900 | 0.07 | 0.05 | 1.34 |
| 905 | 0.05 | 0.05 | 2.87 |
| 910 | 0.04 | 0.06 | 2.80 |
| 915 | 0.03 | 0.07 | 1.37 |
| 920 | 0.03 | 0.09 | 0.73 |
| 925 | 0.02 | 0.14 | 0.47 |
| 930 | 0.02 | 0.23 | 0.35 |
| 935 | 0.02 | 0.48 | 0.31 |
| 940 | 0.02 | 1.21 | 0.44 |
| 945 | 0.02 | 1.93 | 0.48 |
| 950 | 0.02 | 0.97 | 0.30 |
| 955 | 0.02 | 0.51 | 0.28 |
| 960 | 0.02 | 0.45 | 0.30 |
| 965 | 0.03 | 0.74 | 0.34 |
| 970 | 0.04 | 0.37 | 0.42 |
| 975 | 0.06 | 0.22 | 0.54 |
| 980 | 0.10 | 0.17 | 0.73 |
| 985 | 0.19 | 0.16 | 1.02 |
| 990 | 0.44 | 0.16 | 1.40 |
| 995 | 1.30 | 0.17 | 1.77 |
| 1000 | 1.74 | 0.19 | 1.95 |
| 1005 | 0.72 | 0.23 | 1.87 |
| 1010 | 0.35 | 0.29 | 1.67 |
| 1015 | 0.22 | 0.39 | 1.51 |
| 1020 | 0.16 | 0.55 | 1.47 |
| 1025 | 0.13 | 0.81 | 1.59 |
| 1030 | 0.12 | 1.16 | 1.74 |
| 1035 | 0.11 | 1.50 | 1.65 |
| 1040 | 0.11 | 1.66 | 1.55 |
| 1045 | 0.12 | 1.64 | 1.57 |
| 1050 | 0.14 | 1.66 | 1.72 |

Table 10E shows the values of Wt50v, |dWt50v3|, |dWt50v4|, T3540, T4563, T6065, T70105, T45, T50, T63, T85 and T94 of the filter lens element of the optical lens assembly of Example 10 at the incidence angles of 0 degrees, 30 degrees and 40 degrees.

TABLE 10E

| | 0 degrees | 30 degrees | 40 degrees |
|---|---|---|---|
| Wt50v (nm) | 702.34 | 685.40 | 666.19 |
| \|dWt50v3\| (nm) | 16.94 | | |
| \|dWt50v4\| (nm) | 36.14 | | |
| T3540 (%) | 0.19 | 2.13 | 7.52 |
| T4563 (%) | 96.15 | 95.36 | 92.75 |
| T6065 (%) | 97.60 | 95.42 | 88.87 |
| T70105 (%) | 3.85 | 0.82 | 0.72 |
| T45 (%) | 92.30 | 91.16 | 88.70 |
| T50 (%) | 98.65 | 95.52 | 96.62 |
| T63 (%) | 98.69 | 96.78 | 91.26 |
| T85 (%) | 0.05 | 0.08 | 0.20 |
| T94 (%) | 0.02 | 1.21 | 0.44 |

### Example 11

The optical lens assembly of Example 11 includes at least four optical lens elements, and the at least four optical lens elements are, in order from an object side of the optical lens assembly to an image side thereof, a first optical lens element, a second optical lens element, a third optical lens element and a fourth optical lens element. At least one of the at least four optical lens elements is a filter lens element. The filter lens element includes a near-infrared light filter coating membrane, the near-infrared light filter coating membrane includes at least one low refractive index layer and at least one high refractive index layer, and the near-infrared light filter coating membrane is formed by alternately stacking the at least one high refractive index layer and the at least one low refractive index layer. Further, at least one of the at least four optical lens elements can include a blue glass material, the filter lens element can be made of a glass material, and the filter lens element can have at least one aspheric surface.

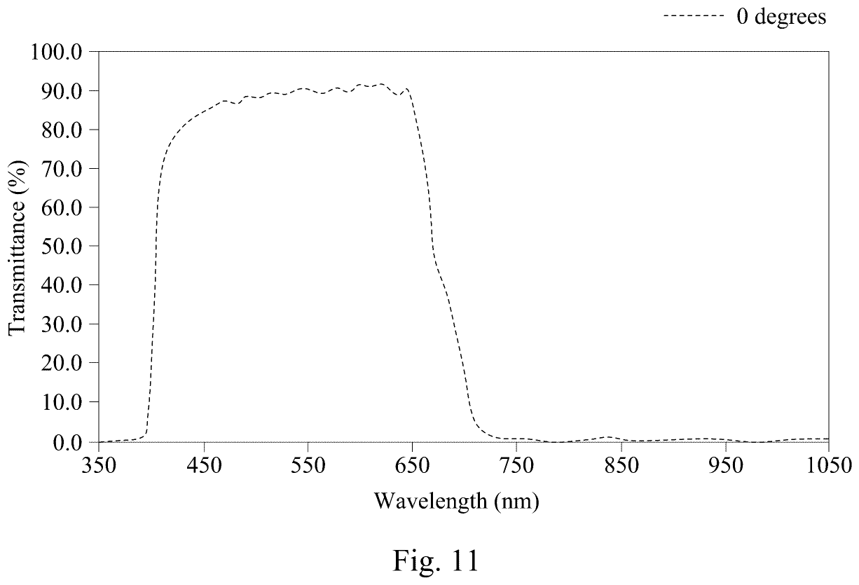

FIG. 11 is a relationship diagram between transmittances and wavelengths of an optical lens assembly according to Example 11, and Table 11A shows the values of transmittance in a wavelength range of 350 nm-1050 nm of the optical lens assembly of Example 11, wherein the incidence angle of the light entering the filter lens element of Example 11 is 0 degrees.

TABLE 11A

| Wavelength (nm) | 0 degrees |
|---|---|
| 350 | 0.00 |
| 355 | 0.01 |
| 360 | 0.07 |
| 365 | 0.23 |
| 370 | 0.26 |
| 375 | 0.31 |
| 380 | 0.24 |
| 385 | 0.29 |
| 390 | 0.96 |
| 395 | 1.61 |
| 400 | 13.96 |
| 405 | 54.82 |
| 410 | 70.09 |
| 415 | 73.64 |
| 420 | 77.23 |
| 425 | 79.41 |
| 430 | 80.61 |
| 435 | 81.90 |
| 440 | 83.34 |
| 445 | 84.02 |
| 450 | 84.59 |
| 455 | 85.56 |
| 460 | 86.18 |
| 465 | 86.57 |
| 470 | 87.44 |
| 475 | 87.28 |
| 480 | 86.65 |
| 485 | 86.98 |
| 490 | 88.56 |
| 495 | 88.62 |
| 500 | 88.16 |
| 505 | 88.32 |
| 510 | 89.11 |
| 515 | 89.20 |
| 520 | 89.11 |
| 525 | 89.17 |
| 530 | 89.12 |
| 535 | 90.20 |
| 540 | 90.17 |
| 545 | 90.41 |
| 550 | 90.38 |
| 555 | 90.11 |
| 560 | 89.66 |
| 565 | 89.42 |
| 570 | 89.74 |
| 575 | 90.58 |
| 580 | 90.68 |
| 585 | 90.10 |
| 590 | 89.41 |
| 595 | 90.63 |
| 600 | 91.97 |
| 605 | 91.09 |
| 610 | 91.12 |
| 615 | 91.38 |
| 620 | 91.70 |
| 625 | 91.24 |
| 630 | 89.61 |
| 635 | 88.45 |
| 640 | 89.44 |
| 645 | 90.63 |
| 650 | 87.81 |
| 655 | 81.32 |
| 660 | 73.67 |
| 665 | 62.92 |
| 670 | 51.75 |
| 675 | 44.44 |
| 680 | 40.85 |
| 685 | 37.32 |
| 690 | 31.70 |
| 695 | 25.13 |
| 700 | 17.42 |
| 705 | 9.91 |
| 710 | 5.31 |
| 715 | 3.09 |
| 720 | 2.06 |
| 725 | 1.50 |
| 730 | 1.13 |
| 735 | 0.88 |
| 740 | 0.73 |
| 745 | 0.66 |
| 750 | 0.71 |
| 755 | 0.88 |
| 760 | 1.11 |
| 765 | 1.06 |
| 770 | 0.74 |
| 775 | 0.47 |
| 780 | 0.35 |
| 785 | 0.30 |
| 790 | 0.30 |
| 795 | 0.31 |
| 800 | 0.36 |
| 805 | 0.44 |
| 810 | 0.50 |
| 815 | 0.59 |
| 820 | 0.70 |
| 825 | 0.89 |
| 830 | 1.29 |
| 835 | 1.44 |
| 840 | 1.21 |
| 845 | 0.86 |
| 850 | 0.67 |
| 855 | 0.58 |
| 860 | 0.51 |
| 865 | 0.46 |
| 870 | 0.48 |
| 875 | 0.49 |
| 880 | 0.55 |
| 885 | 0.54 |
| 890 | 0.58 |
| 895 | 0.64 |
| 900 | 0.70 |
| 905 | 0.71 |
| 910 | 0.77 |
| 915 | 0.81 |
| 920 | 0.85 |
| 925 | 0.86 |
| 930 | 0.86 |
| 935 | 0.86 |
| 940 | 0.77 |
| 945 | 0.70 |
| 950 | 0.62 |
| 955 | 0.52 |
| 960 | 0.42 |
| 965 | 0.36 |
| 970 | 0.30 |
| 975 | 0.27 |
| 980 | 0.27 |
| 985 | 0.29 |
| 990 | 0.35 |
| 995 | 0.42 |
| 1000 | 0.52 |
| 1005 | 0.62 |
| 1010 | 0.71 |
| 1015 | 0.80 |
| 1020 | 0.85 |
| 1025 | 0.84 |
| 1030 | 0.82 |
| 1035 | 0.76 |
| 1040 | 0.71 |
| 1045 | 0.68 |
| 1050 | 0.67 |

Table 11B shows the values of Wt50v, |dWt50v3|, |dWt50v4|, T3540, T4563, T6065, T70105, T45, T50, T63, T85 and T94 of the optical lens assembly of Example 11 at the incidence angle of 0 degrees.

TABLE 11B

| | 0 degrees |
|---|---|
| Wt50v (nm) | 670.50 |
| \|dWt50v3\| (nm) | — |
| \|dWt50v4\| (nm) | — |
| T3540 (%) | 1.63 |
| T4563 (%) | 89.20 |
| T6065 (%) | 90.40 |
| T70105 (%) | 1.16 |
| T45 (%) | 84.59 |
| T50 (%) | 90.38 |
| T63 (%) | 89.61 |
| T85 (%) | 0.67 |
| T94 (%) | 0.77 |

### Example 12

The optical lens assembly of Example 12 includes at least four optical lens elements, and the at least four optical lens elements are, in order from an object side of the optical lens assembly to an image side thereof, a first optical lens element, a second optical lens element, a third optical lens element and a fourth optical lens element. At least one of the at least four optical lens elements is a filter lens element. The filter lens element includes a near-infrared light filter coating membrane, the near-infrared light filter coating membrane includes at least one low refractive index layer and at least one high refractive index layer, and the near-infrared light filter coating membrane is formed by alternately stacking the at least one high refractive index layer and the at least one low refractive index layer. Further, at least one of the at least four optical lens elements can include a blue glass material, the filter lens element can be made of a glass material, and the filter lens element can have at least one aspheric surface.

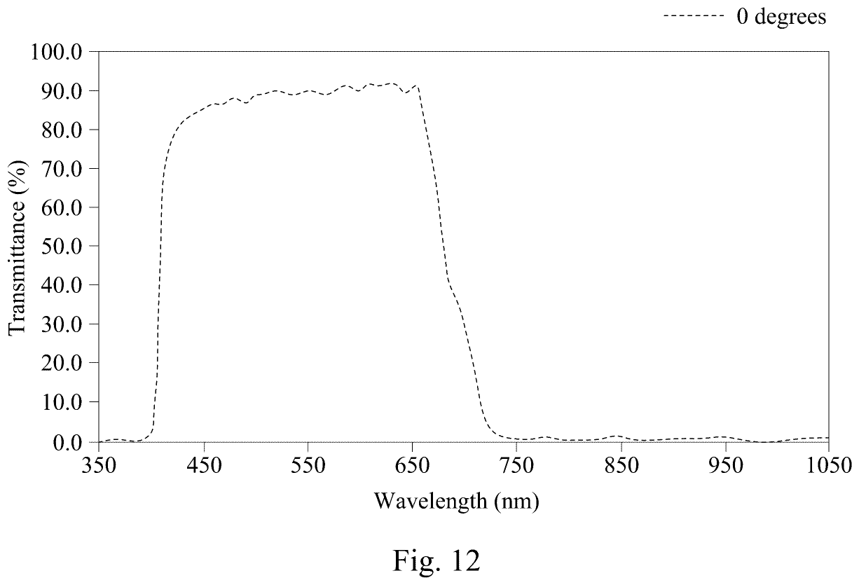

FIG. 12 is a relationship diagram between transmittances and wavelengths of an optical lens assembly according to Example 12, and Table 12A shows the values of transmittance in a wavelength range of 350 nm-1050 nm of the optical lens assembly of Example 12, wherein the incidence angles of the light entering the filter lens element of Example 12 is 0 degrees.

TABLE 12A

| Wavelength (nm) | 0 degrees |
|---|---|
| 350 | 0.00 |
| 355 | 0.01 |
| 360 | 0.02 |
| 365 | 0.48 |
| 370 | 0.96 |
| 375 | 0.52 |
| 380 | 0.57 |
| 385 | 0.30 |
| 390 | 0.27 |
| 395 | 0.96 |
| 400 | 1.97 |
| 405 | 14.08 |
| 410 | 64.14 |
| 415 | 73.00 |
| 420 | 75.81 |
| 425 | 79.94 |
| 430 | 81.55 |
| 435 | 82.60 |
| 440 | 83.32 |
| 445 | 84.47 |
| 450 | 85.49 |
| 455 | 85.51 |
| 460 | 86.65 |
| 465 | 86.93 |
| 470 | 85.98 |
| 475 | 87.55 |
| 480 | 88.28 |
| 485 | 87.65 |
| 490 | 86.59 |
| 495 | 87.92 |
| 500 | 89.02 |
| 505 | 88.86 |
| 510 | 88.82 |
| 515 | 89.72 |
| 520 | 89.90 |
| 525 | 89.70 |
| 530 | 89.15 |
| 535 | 88.96 |
| 540 | 89.22 |
| 545 | 89.77 |
| 550 | 90.04 |
| 555 | 89.62 |
| 560 | 89.43 |
| 565 | 89.27 |
| 570 | 89.01 |
| 575 | 89.71 |
| 580 | 90.27 |
| 585 | 90.73 |
| 590 | 91.20 |
| 595 | 90.29 |
| 600 | 89.80 |
| 605 | 91.00 |
| 610 | 91.80 |
| 615 | 91.34 |
| 620 | 91.05 |
| 625 | 91.84 |
| 630 | 91.75 |
| 635 | 91.67 |
| 640 | 89.99 |
| 645 | 89.00 |
| 650 | 90.79 |
| 655 | 90.95 |
| 660 | 85.27 |
| 665 | 77.30 |
| 670 | 70.94 |
| 675 | 62.14 |
| 680 | 49.93 |
| 685 | 41.21 |
| 690 | 37.10 |
| 695 | 35.01 |
| 700 | 30.92 |
| 705 | 24.88 |
| 710 | 17.47 |
| 715 | 10.76 |
| 720 | 5.92 |
| 725 | 3.34 |
| 730 | 2.17 |
| 735 | 1.56 |
| 740 | 1.17 |
| 745 | 0.91 |
| 750 | 0.74 |
| 755 | 0.67 |
| 760 | 0.67 |
| 765 | 0.77 |
| 770 | 1.01 |
| 775 | 1.21 |
| 780 | 1.04 |
| 785 | 0.72 |
| 790 | 0.49 |
| 795 | 0.37 |
| 800 | 0.34 |
| 805 | 0.34 |
| 810 | 0.40 |
| 815 | 0.49 |
| 820 | 0.58 |
| 825 | 0.68 |
| 830 | 0.80 |
| 835 | 1.05 |
| 840 | 1.31 |
| 845 | 1.65 |
| 850 | 1.20 |
| 855 | 0.86 |
| 860 | 0.72 |
| 865 | 0.66 |
| 870 | 0.59 |
| 875 | 0.47 |
| 880 | 0.52 |
| 885 | 0.51 |
| 890 | 0.55 |
| 895 | 0.59 |
| 900 | 0.65 |
| 905 | 0.69 |
| 910 | 0.74 |
| 915 | 0.81 |
| 920 | 0.85 |
| 925 | 0.92 |
| 930 | 0.98 |
| 935 | 1.01 |
| 940 | 1.06 |
| 945 | 1.00 |
| 950 | 1.00 |
| 955 | 0.91 |
| 960 | 0.78 |
| 965 | 0.66 |
| 970 | 0.57 |
| 975 | 0.45 |
| 980 | 0.37 |
| 985 | 0.31 |
| 990 | 0.28 |
| 995 | 0.29 |
| 1000 | 0.33 |
| 1005 | 0.37 |
| 1010 | 0.44 |
| 1015 | 0.54 |
| 1020 | 0.65 |
| 1025 | 0.73 |
| 1030 | 0.82 |
| 1035 | 0.88 |
| 1040 | 0.88 |
| 1045 | 0.85 |
| 1050 | 0.83 |

Table 12B shows the values of Wt50v, |dWt50v3|, |dWt50v4|, T3540, T4563, T6065, T70105, T45, T50, T63, T85 and T94 of the optical lens assembly of Example 12 at the incidence angle of 0 degrees.

TABLE 12B

| | 0 degrees |
|---|---|
| Wt50v (nm) | 679.50 |
| \|dWt50v3\| (nm) | — |
| \|dWt50v4\| (nm) | — |
| T3540 (%) | 0.55 |
| T4563 (%) | 89.18 |
| T6065 (%) | 90.91 |
| T70105 (%) | 2.01 |
| T45 (%) | 85.49 |
| T50 (%) | 90.04 |
| T63 (%) | 91.75 |
| T85 (%) | 1.20 |
| T94 (%) | 1.06 |

### Example 13

The optical lens assembly of Example 13 includes seven optical lens elements, and the seven optical lens elements are, in order from an object side of the optical lens assembly to an image side thereof, a first optical lens element, a second optical lens element, a third optical lens element, a fourth optical lens element, a fifth optical lens element, a sixth optical lens element and a seventh optical lens element. At least one of the first optical lens element to the seventh optical lens element is a filter lens element. The filter lens element includes a near-infrared light filter coating membrane, the filter lens element of the optical lens assembly of Example 13 can be any one of the filter lens elements of Example 1 to Example 12, and the near-infrared light filter coating membrane thereof also can be any one of the near-infrared light filter coating membrane of Example 1 to Example 12 and can be disposed on a relatively flat surface of the optical lens element. Further, at least one of the seven optical lens elements can include a blue glass material, the filter lens element can be made of a glass material, and the filter lens element can have at least one aspheric surface.

Table 13 shows the values of the surface configurations of the optical lens element of the optical lens assembly of Example 13.

TABLE 13

| | | L1 | | | | | | |
|---|---|---|---|---|---|---|---|---|
| | | (Glass) | L2 | L3 | L4 | L5 | L6 | L7 |
| R1 | SAG (mm) | 0.96 | 0.25 | −0.33 | −0.05 | −0.81 | −0.92 | −1.34 |
| | CT (mm) | 1.34 | 0.34 | 0.34 | 0.74 | 0.58 | 0.65 | 0.60 |
| | \|SAG/CT\| | 0.72 | 0.74 | 0.96 | 0.07 | 1.40 | 1.42 | 2.23 |
| | Rc (mm) | 3.54 | 13.04 | −100.00 | 29.37 | 10.39 | 4.46 | 7.44 |
| | \|SAG/Rc\| | 0.273 | 0.019 | 0.003 | 0.002 | 0.078 | 0.207 | 0.180 |
| | Coating evaluation | | | | * | | | |
| | of the optical lens | | | | | | | |
| | element | | | | | | | |
| R2 | SAG (mm) | 0.19 | 0.25 | −0.24 | −0.47 | −0.82 | −1.08 | −1.24 |
| | CT (mm) | 1.34 | 0.34 | 0.34 | 0.74 | 0.58 | 0.65 | 0.60 |
| | \|SAG/CT\| | 0.14 | 0.75 | 0.69 | 0.63 | 1.43 | 1.66 | 2.07 |
| | Rc (mm) | 10.33 | 10.56 | 34.97 | −74.10 | 7.32 | −58.23 | 2.34 |
| | \|SAG/Rc\| | 0.018 | 0.024 | 0.007 | 0.006 | 0.112 | 0.018 | 0.530 |
| | Coating evaluation | * | | * | * | | | |
| | of the optical lens | | | | | | | |
| | element | | | | | | | |

In Table 13, L1 to L7 respectively refer to the first optical lens element, the second optical lens element, the third optical lens element, the fourth optical lens element, the fifth optical lens element, the sixth optical lens element and the seventh optical lens element in sequence, R1 refers to the object-side surface of each of the optical lens elements, R2 refers to the image-side surface of each of the optical lens elements, and “*” means the best coating surface shape is satisfied.

As shown in Table 13, the first optical lens element is made of a glass material, and the near-infrared light filter coating membrane of Example 13 can be disposed on the image-side surface of the first optical lens element, the image-side surface of the third optical lens element, the object-side surface of the fourth optical lens element, and the image-side surface of the fourth optical lens element.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical lens assembly, comprising:
at least four optical lens elements being, in order from an object side of the optical lens assembly to an image side thereof, a first optical lens element, a second optical lens element, a third optical lens element and a fourth optical lens element;
wherein at least one of the at least four optical lens elements is a filter lens element, the filter lens element comprises a near-infrared light filter coating membrane, the filter lens element is made of a glass material, and the filter lens element has at least one aspheric surface;
wherein the near-infrared light filter coating membrane comprises at least one low refractive index layer and at least one high refractive index layer, and the near-infrared light filter coating membrane is formed by alternately stacking the at least one high refractive index layer and the at least one low refractive index layer;
wherein a wavelength of the filter lens element at 50% transmittance of long-wavelength visible light is Wt50v, a wavelength difference between an incidence at 0 degrees and an incidence at 30 degrees of the filter lens element at 50% transmittance of long-wavelength visible light is dWt50v3, an average transmittance in a wavelength range of 600 nm-650 nm of the filter lens element is T6065, an average transmittance in a wavelength range of 700 nm-1050 nm of the filter lens element is T70105, and the following conditions are satisfied:
650 nm≤Wt50v;

|dWt50v3|≤20 nm;
90%≤T6065; and
T70105≤5%.

2. The optical lens assembly of claim 1, wherein a total number of layers of the near-infrared light filter coating membrane is tLs, and the following condition is satisfied:
40≤tLs≤200.

3. The optical lens assembly of claim 2, wherein a total thickness of the near-infrared light filter coating membrane is tTk, and the following condition is satisfied:
4000 nm≤tTk≤10000 nm.

4. The optical lens assembly of claim 3, wherein a total thickness of the low refractive index layer is LtTk, a total thickness of the high refractive index layer is HtTk, and the following condition is satisfied:
1.0≤LtTk/HtTk≤2.0.

5. The optical lens assembly of claim 1, wherein the near-infrared light filter coating membrane is disposed on an object-side surface and an image-side surface of the filter lens element, a total number of layers of the near-infrared light filter coating membrane on the object-side surface of the filter lens element is otLs, a total number of layers of the near-infrared light filter coating membrane on the image-side surface of the filter lens element is itLs, and the following conditions are satisfied:
otLs≤40; and
itLs≤40.

6. The optical lens assembly of claim 5, wherein a total thickness of the near-infrared light filter coating membrane on the object-side surface of the filter lens element is otTk, a total thickness of the near-infrared light filter coating membrane on the image-side surface of the filter lens element is itTk, and the following condition is satisfied:
$$0.1 \leq o tTk / itTk \leq 10.$$

7. The optical lens assembly of claim 1, wherein a refractive index of the high refractive index layer is NH, a refractive index of the low refractive index layer is NL, and the following condition is satisfied:
$$0.5 \leq N H - N L .$$

8. The optical lens assembly of claim 1, wherein a wavelength difference between the incidence at 0 degrees and an incidence at 40 degrees of the filter lens element at 50% transmittance of long-wavelength visible light is dWt50v4, and the following condition is satisfied:

|dWt50v4|≤40 nm.

9. The optical lens assembly of claim 1, wherein an average transmittance in a wavelength range of 350 nm-400 nm of the filter lens element is T3540, and the following condition is satisfied:
T3540≤3%.

10. The optical lens assembly of claim 1, wherein a transmittance at a wavelength of 850 nm of the filter lens element is T85, and the following condition is satisfied:
T85≤3%.

11. The optical lens assembly of claim 10, wherein a transmittance at a wavelength of 940 nm of the filter lens element is T94, and the following condition is satisfied:
T94≤3%.

12. The optical lens assembly of claim 1, wherein the near-infrared light filter coating membrane is disposed on an image-side surface of the filter lens element.

13. The optical lens assembly of claim 12, wherein the filter lens element is the first optical lens element.

14. The optical lens assembly of claim 1, wherein a horizontal displacement of the filter lens element at a position of a maximum effective diameter is SAG, a central thickness of the filter lens element is CT, and the following condition is satisfied:
$$\vert SAG / CT \vert \leq 0.7 .$$

15. The optical lens assembly of claim 14, wherein the horizontal displacement of the filter lens element at the position of the maximum effective diameter is SAG, a radius of curvature at a center of the filter lens element is Rc, and the following condition is satisfied:
$$\vert SAG / Rc \vert \leq 0.1 .$$

16. An imaging apparatus, comprising:
the optical lens assembly of claim 1; and
an image sensor disposed on an image surface of the optical lens assembly.

17. An electronic device, comprising:
the imaging apparatus of claim 16.

18. An optical lens assembly, comprising:
at least four optical lens elements being, in order from an object side of the optical lens assembly to an image side thereof, a first optical lens element, a second optical lens element, a third optical lens element and a fourth optical lens element;
wherein at least one of the at least four optical lens elements is a filter lens element, the filter lens element comprises a near-infrared light filter coating membrane, and at least one of the at least four optical lens elements comprises a blue glass material;
wherein the near-infrared light filter coating membrane comprises at least one low refractive index layer and at least one high refractive index layer, and the near-infrared light filter coating membrane is formed by alternately stacking the at least one high refractive index layer and the at least one low refractive index layer;
wherein a wavelength of the filter lens element at 50% transmittance of long-wavelength visible light is Wt50v, a wavelength difference between an incidence at 0 degrees and an incidence at 30 degrees of the filter lens element at 50% transmittance of long-wavelength visible light is dWt50v3, an average transmittance in a wavelength range of 450 nm-630 nm of the filter lens element is T4563, an average transmittance in a wavelength range of 700 nm-1050 nm of the filter lens element is T70105, and the following conditions are satisfied:
650 nm≤Wt50v;

|dWt50v3|≤20 nm;
85%≤T4563; and
T70105≤3%.

19. The optical lens assembly of claim 18, wherein a total thickness of the low refractive index layer is LtTk, a total thickness of the high refractive index layer is HtTk, and the following condition is satisfied:
1.4≤LtTk/HtTk.

20. The optical lens assembly of claim 19, wherein a total number of layers of the near-infrared light filter coating membrane is tLs, and the following condition is satisfied:
65≤tLs.

21. The optical lens assembly of claim 20, wherein a total thickness of the near-infrared light filter coating membrane is tTk, and the following condition is satisfied:
tTk≤6500 nm.

22. The optical lens assembly of claim 21, wherein a wavelength difference between the incidence at 0 degrees and an incidence at 40 degrees of the filter lens element at 50% transmittance of long-wavelength visible light is dWt50v4, and the following condition is satisfied:

|dWt50v4|≤40 nm.

23. The optical lens assembly of claim 18, wherein an average transmittance in a wavelength range of 450 nm-630 nm of the filter lens element is T4563, and the following condition is satisfied:
70%≤T4563.

24. The optical lens assembly of claim 23, wherein a transmittance at a wavelength of 450 nm of the filter lens element is T45, and the following condition is satisfied:
80%≤T45.

25. The optical lens assembly of claim 24, wherein a transmittance at a wavelength of 500 nm of the filter lens element is T50, and the following condition is satisfied:
80%≤T50.

26. The optical lens assembly of claim 25, wherein a transmittance at a wavelength of 630 nm of the filter lens element is T63, and the following condition is satisfied:
80%≤T63.

27. The optical lens assembly of claim 26, wherein the near-infrared light filter coating membrane is disposed on an image-side surface of the filter lens element, and the filter lens element includes the blue glass material.

28. The optical lens assembly of claim 18, wherein a total number of layers of the near-infrared light filter coating membrane is tLs, a total thickness of the near-infrared light filter coating membrane is tTk, a total thickness of the low refractive index layer is LtTk, a total thickness of the high refractive index layer is HtTk, the wavelength of the filter lens element at 50% transmittance of long-wavelength visible light is Wt50v, the wavelength difference between the incidence at 0 degrees and the incidence at 30 degrees of the filter lens element at 50% transmittance of long-wavelength visible light is dWt50v3, a wavelength difference between the incidence at 0 degrees and an incidence at 40 degrees of the filter lens element at 50% transmittance of long-wavelength visible light is dWt50v4, the average transmittance in the wavelength range of 450 nm-630 nm of the filter lens element is T4563, an average transmittance in a wavelength range of 600 nm-650 nm of the filter lens element is T6065, the average transmittance in the wavelength range of 700 nm-1050 nm of the filter lens element is T70105, a horizontal displacement of the filter lens element at a position of a maximum effective diameter is SAG, a central thickness of the filter lens element is CT, a radius of curvature at a center of the filter lens element is Rc, and the following conditions are satisfied:
$$65 \leq t L s \leq 100 ;$$
$$6000 nm \leq tTk \leq 6200 nm ;$$
$$1.4 \leq LtTk / HtTk \leq 1.6 ;$$
$$670 nm \leq Wt 50 v \leq 690 nm ;$$
$$0 \leq \vert dWt 50 v 3 \vert \leq 15 nm ;$$
$$0 \leq \vert dWt 50 v 4 \vert \leq 35 nm ;$$
$$95 \% \leq T 4563 \leq 100 \% ;$$
$$95 \% \leq T 6065 \leq 100 \% ;$$
$$0 \% \leq T 70105 \leq 1 \% ;$$
$$\vert SAG / CT \vert \leq 0.2 ;$$
$$and \vert SAG / Rc \vert \leq 0.02 .$$

29. An imaging apparatus, comprising:
the optical lens assembly of claim 18; and
an image sensor disposed on an image surface of the optical lens assembly.

30. An electronic device, comprising:
the imaging apparatus of claim 29.
